(19) United States
(12) Patent Application Publication
(10) Pub. No.: US 2025/0210781 A1
(43) Pub. Date: Jun. 26, 2025

(54) AN IMPROVED BATTERY PACK

(71) Applicant: XEROTECH LIMITED, Claregalway (IE)

(72) Inventors: Barry FLANNERY, Claregalway (IE); Sean MCFADDEN, Claregalway (IE); Eoin MURPHY, Claregalway (IE); Neil QUINN, Claregalway (IE); Meaghan COLLINS, Claregalway (IE)

(21) Appl. No.: 18/845,479

(22) PCT Filed: Mar. 10, 2023
(86) PCT No.: PCT/EP2023/056157

§ 371 Date: Sep. 10, 2024

(30) Foreign Application Priority Data
Mar. 10, 2022 (GB) 2203327.8

(51) Int. Cl. H01M 50/258; H01M 10/48; H01M 10/613; H01M 10/653; H01M 10/6557; H01M 50/213; H01M 50/249; H01M 50/267; H01M 50/289; H01M 50/296; H01M 50/507

(52) U.S. Cl. CPC H01M 50/258; H01M 10/486; H01M 10/613; H01M 10/653; H01M 10/6557; H01M 50/249; H01M 50/267; H01M 50/289; H01M 50/296; H01M 50/507; H01M 50/213

(57) ABSTRACT

A battery pack comprising: one or more battery modules and a battery module sub assembly; a battery pack management arrangement for monitoring and/or controlling the operation of the battery pack; a battery pack fluid connection assembly for connecting one or more ducts of the battery pack to a source of thermal management fluid; and a battery pack electrical connection arrangement for electrically connecting the battery pack to an external load, the battery pack being modular so as to be adaptable to suit multiple design requirements by adjusting the size, number, location and/or orientation of one or more battery modules within the battery pack.

The present invention relates to an improved battery pack, particularly an improved battery pack for use in mobile applications such as electric vehicles, industrial vehicles and/or plant machinery.

Helping to reduce the amount of greenhouse gasses emitted into the atmosphere each year is now a priority for many industries. For example, the automotive industry is undergoing rapid changes due to the gradual phase out of petroleum-based power sources in favour of electric power sources. The speed of change in the consumer car industry is particularly rapid and has led to an explosion of new battery technologies based on thermally managed lithium-ion cells. It is becoming clear that in order to meet climate change reduction targets it will be necessary to replicate these changes much more widely-industrial vehicles and plant machinery will also need to ‘go electric’ if targets are to be met.

Developing green power solutions for industrial and mobile applications is an expensive and time-consuming technical task. When seeking to replace e.g. a diesel engine in an industrial vehicle with a battery pack it is rare to find an off-the-shelf battery solution able to provide the necessary power profile and to fit perfectly into the required volume. Such conversion usually requires a significant re-design of the structure of the machine or vehicle so that it can accommodate an off-the-shelf battery solution. However, off-the-shelf battery solutions often lack the mechanical strength and reliability typically required, especially for industrial vehicles and plant machinery.

While the development of custom-engineered battery packs and/or accommodating structures can be cost effective in high-volume manufacturing of consumer vehicles, this level of cost is often prohibitive in lower-volume manufacturing settings. Low-volume manufacturers of cranes, plant machinery and mining equipment do not enjoy the economies of scale which would justify the costs of an all-electric conversion. There exists a need for an electrical power solution that can be incorporated into a wide variety of machinery and can be easily adapted to satisfy a range of power, thermal management, strength, reliability and volume requirements.

It is an object of the invention to obviate or mitigate the problems outlined above. In particular, it is an object of the invention to provide an electrical power solution that can be incorporated into a wide variety of machinery.

It is a further object of the invention to provide an electrical power solution which can provide the mechanical strength and reliability required for industrial vehicles and plant machinery.

It is a further object of the invention to provide an electrical power solution that can be easily adapted to satisfy a range of design, power and volume requirements.

It is a further object of the invention to provide an electrical power solution that can be easily adapted to satisfy a range of safety and thermal management requirements.

It is a further object of the invention to provide an electrical power solution that can be adapted for incorporation into an existing vehicle design.

It is a further object of the invention to provide an electrical power solution that can be retrofitted in an existing vehicle or machine.

It is a further object of the invention to provide a battery pack that is more adjustable than prior art battery packs.

It is a further object of the invention to provide a battery pack that is more reliable and mechanically stronger than prior art battery packs.

According to an aspect of the invention there is provided a battery pack comprising: one or more battery modules; a battery pack management means for monitoring and/or controlling the operation of the battery pack; a battery pack fluid connection means for connecting the battery pack to a source of thermal management fluid; and a battery pack electrical connection means for electrically connecting the battery pack to an external load. Advantageously, the battery pack can be adapted to suit a particular set of design requirements by adjusting the size, number, locations and/or orientations of battery modules within the battery pack.

Ideally, the battery pack comprises a battery pack housing.

Preferably, the battery pack housing comprises a lower case member.

Preferably, the battery pack housing comprises a cover member.

Preferably, the lower case member comprises one or more apertures.

Preferably, the lower case member comprises a cavity.

Preferably, the lower case member comprises a cavity for receiving one or more battery modules.

Preferably, the lower case member comprises a cavity for receiving a plurality of battery modules.

Preferably, the lower case member comprises a cavity for receiving a battery module sub assembly.

Preferably, the cover member is adapted to cover an aperture in the lower case member.

Ideally, the battery pack housing comprises two side walls

Preferably the battery pack comprises two end walls.

Preferably the battery pack comprises a base wall.

Preferably the battery pack comprises a top wall.

Preferably, the battery pack is locatable within a predetermined volume.

Preferably, the battery pack is locatable within a predetermined volume within an apparatus such as a mobile apparatus or an industrial apparatus.

Preferably, the battery pack is locatable within a predetermined volume in a road-going vehicle such as a car, truck, lorry, road sweeper, tractor or digger.

Preferably, the battery pack is locatable within a predetermined volume in an industrial apparatus such as a plant.

Preferably, the battery pack is adapted to fit within a predetermined volume originally designed to accommodate an alternative power source such as a diesel engine.

Ideally, the battery pack comprises a battery pack management means.

Ideally, the battery pack comprises a battery pack management means for monitoring and/or controlling the operation of the battery pack.

Preferably, the battery pack comprises a battery pack fluid connection means.

Preferably, the battery pack fluid connection means comprises a battery pack fluid inlet and a battery pack fluid outlet.

Preferably, the thermal management means of the or each battery module in the battery pack are in fluid communication with the battery pack fluid connection means.

Preferably, the battery pack comprises a battery pack fluid connection means for connecting the battery pack to a source of thermal management fluid.

Preferably, the inlet-side fluid delivery means of each battery module is in fluid communication with the inlet-side fluid delivery means of at least one other battery module.

Preferably, the outlet-side fluid delivery means of each battery module is in fluid communication with the outlet-side fluid delivery means of at least one other battery module.

Preferably, the battery pack comprises a battery pack fluid connection means for connecting the battery pack to an external source of thermal management fluid.

Preferably, the thermal management fluid is water and/or a water-glycol mixture.

Preferably, the battery pack fluid connection means is adapted to allow the battery pack to be operably connected to a thermal management system.

Preferably, the thermal management system comprises a source of thermal management fluid.

Preferably, the thermal management system comprises a reservoir for containing the thermal management fluid.

Ideally, the thermal management system comprises a heat exchanger and a pump.

Preferably, the thermal management system comprises a coolant loop.

Preferably, the thermal management system comprises a pressure sensor.

Ideally, the pressure sensor is adapted to monitor the pressure in the thermal management system, particularly the coolant loop.

Preferably, the battery pack fluid connection means comprises a battery pack fluid inlet.

Preferably, the battery pack fluid inlet provides a fluid intake means i.e. a path for fluid to enter the battery pack.

Preferably, the battery pack fluid inlet comprises an inlet adapter.

Preferably, the battery pack fluid inlet comprises an inlet conduit.

Preferably, fluid is able to enter the battery pack via the inlet adapter and inlet conduit.

Preferably, fluid is able to enter the battery pack through an aperture in an end wall of the battery pack housing.

Preferably, the battery pack fluid connection means comprises a battery pack fluid outlet.

Preferably, the battery pack fluid outlet provides a fluid exhaust means i.e. a path for fluid to exit the battery pack.

Ideally, the battery pack fluid outlet comprises an outlet adapter.

Preferably, the battery pack fluid outlet comprises an outlet conduit.

Preferably, fluid is able to exit the battery pack via the outlet adapter and outlet conduit.

Preferably, fluid is able to exit the battery pack through an aperture in the end wall of the battery pack housing.

Preferably, the battery pack fluid inlet and the battery pack fluid outlet are in fluid communication with one another.

Ideally, the battery pack fluid inlet and the battery pack fluid outlet are in fluid communication with one another via the or each battery module.

Ideally, the battery pack fluid inlet and the battery pack fluid outlet are in fluid communication with one another via the battery module sub assembly.

Ideally, the inlet conduit and/or outlet conduit is curved.

Preferably, the inlet conduit comprises a first end and a second end.

Preferably, the outlet conduit comprises a first end and a second end.

Preferably, the first end of the inlet conduit and/or the first end of the outlet conduit is connectable to one or more battery modules.

Preferably, the second end of the inlet conduit and/or the second end of the outlet conduit is substantially flat.

Preferably, the second end of the inlet conduit and/or the second end of the outlet conduit comprises a generally square locating member.

Preferably, the locating member is locatable in a retaining means.

Preferably, the retaining means is located on the inside of the battery pack housing. Advantageously the locating means can be reliably and accurately located during manufacture of the battery pack.

Preferably, the retaining means is located inside the cavity of the lower case member.

Preferably the retaining means is attachable to an end wall or a side wall of the lower case member.

Ideally, the inlet conduit is operably connected to a main fluid inlet of one or more battery modules.

Preferably, the outlet conduit is operably connected to a main fluid outlet of one or more battery modules.

Preferably, the battery pack comprises an electrical connection means.

Preferably, the battery pack comprises an electrical connection means for electrically connecting the battery pack to an external load.

Preferably, the battery pack electrical connection means is adapted to allow the battery pack to be electrically connected to an external load such as a motor or other electrical component of a vehicle, machine or piece of industrial apparatus.

Preferably, the electrical connection means comprises positive and negative battery pack terminals.

Preferably, the electrical connection means comprises electrical adapters.

Preferably, the positive and negative terminals are provided by electrical adapters.

Preferably the battery pack comprises an end enclosure.

Preferably, the end enclosure is attachable to an end wall of the battery pack.

Preferably, the adapters are located in the end enclosure.

Preferably, the adapters pass through the wall of the end enclosure.

Preferably, the end enclosure comprises a housing member and a lid member.

Preferably, the end enclosure comprises a status indication means.

Preferably, the status indication means is an indicator light.

Preferably, the indicator light is visible through apertures in the lid member.

Preferably, the indicator means is adapted to display encoded signals, for example flashing and/or coloured light signals, indicative of an operating state of the battery.

Preferably, the end enclosure further comprises one or more electrical adapters.

Preferably, the electrical adapters provide the electrical terminals of the battery.

Preferably, the end enclosure further comprises one or more communication ports.

Preferably, the communication port allows e.g. an external computer to be connected to the battery for e.g. monitoring and/or diagnostic purposes.

Preferably, the end enclosure further comprises one or more internal electrical connectors.

Preferably, the internal electrical connectors are adapted to pass through the battery pack housing and connect the end enclosure, particularly the circuitry held within the end enclosure, to the terminals of the battery module sub assembly/battery modules.

Preferably, the battery pack comprises a busbar.

Preferably, the battery pack comprises a plurality of busbars.

According to a further aspect of the invention there is provided a battery module sub assembly comprising one or more battery modules. Advantageously, the battery module sub assembly allows a plurality of battery modules to be incorporated into a battery pack and held as a single replaceable unit in a battery pack.

According to a further aspect of the invention there is provided a battery pack comprising a battery module sub assembly.

Ideally, the battery pack comprises a battery module sub assembly.

Ideally, the battery module sub assembly comprises one or more battery modules.

Preferably, the battery module sub assembly comprises a plurality of battery modules.

Preferably, the battery module sub assembly comprises one or more identical battery modules.

Preferably, the battery module sub assembly comprises six identical battery modules.

Preferably, two or more of the battery modules in the battery module sub assembly are fluidly interconnected.

Preferably, fluid connections are provided between the battery modules in the battery module sub assembly.

Preferably, a coolant fluid is able to flow through the battery module sub assembly.

Preferably, the battery module sub assembly comprises a main fluid inlet.

Preferably, the battery module sub assembly comprises a main fluid outlet.

Preferably, the battery module sub assembly comprises one or more multiport fluid connectors.

Preferably, the battery module sub assembly comprises two multiport fluid connectors.

Preferably, the battery module sub assembly comprises an inlet-side multiport fluid connector.

Preferably, the battery module sub assembly comprises an outlet-side multiport fluid connector.

Preferably, a coolant fluid is able to flow through the battery module sub assembly via the main fluid inlet, the battery modules and the main fluid outlet.

Preferably, a coolant fluid is able to flow through the battery module sub assembly via the inlet-side multiport fluid connector, the battery modules and the outlet-side multiport fluid connector.

Preferably, at least some or all of the fluid connections between battery modules are parallel fluid connections.

Preferably, fluid is able to flow through each of the battery modules in parallel.

Optionally, at least some or all of the fluid connections are series fluid connections.

Preferably, fluid is able to flow through two or more battery modules successively.

Preferably, two or more of the battery modules in the battery module sub assembly are electrically interconnected.

Preferably, two or more of the battery modules in the battery module sub assembly are electrically connected in parallel.

Preferably, two or more of the battery modules in the battery module sub assembly are electrically connected in series.

Preferably, electrical connections are provided between the battery modules in the battery module sub assembly.

Ideally, electrical current is able to flow through the battery module sub assembly.

Preferably, electrical current is able to flow through the battery module sub assembly via the negative terminal busbar, the battery modules and the positive terminal busbar.

Preferably, the battery modules are connected in series.

Preferably, in use, the battery modules are discharged in series.

Optionally, the battery modules are connected in parallel.

Optionally, in use, the battery modules are discharged in parallel.

Preferably, the positive side of at least one battery module is connectable to a negative side of a neighboring battery module.

Preferably, the battery module sub assembly comprises one or more intermodule busbars.

Preferably, two or more battery modules are connected via intermodule busbars.

Ideally, the positive side of at least one battery module is connectable to a negative side of a neighboring battery module via one or more intermodule busbars.

Preferably, the or each intermodule busbar is a planar electrically-conductive member.

Preferably, the or each intermodule busbar is adapted to provide an electrical connection between two neighbouring or adjacent battery modules.

Preferably, the battery module sub assembly comprises one or more peripheral battery modules.

Ideally, the battery pack comprises two peripheral battery modules.

Ideally, each peripheral battery module is located at an outer peripheral edge of the battery module sub assembly.

Preferably, the battery module sub assembly comprises terminal busbars.

Preferably, the battery module sub assembly comprises positive and negative terminal busbars.

Preferably, the peripheral battery modules are connectable to the positive and negative battery pack terminals.

Preferably, the peripheral battery modules are connectable to the positive and negative battery pack terminals via positive and negative terminal busbars.

Preferably, the positive terminal of the battery pack is electrically connected to a first peripheral battery module a via a positive terminal busbar.

Preferably, the positive terminal busbar is electrically connected to the positive side of a first peripheral battery module.

Preferably, the negative terminal of the battery pack is electrically connected to a peripheral battery module via a negative terminal busbar.

Preferably, the negative terminal busbar is electrically connected to the negative side of a second peripheral battery module.

Preferably, the battery pack comprises a manual disconnection means.

Ideally, the manual disconnection means is a manual service disconnect.

Ideally, the manual disconnection means comprises a switch.

Preferably, the switch is located within the end enclosure.

Preferably, the switch is operably connected to the central battery modules.

Preferably, the manual disconnection means is configured to electrically disconnect two groups of battery modules within the battery pack.

Preferably, the groups of battery modules comprise the same, or alternative, numbers of battery modules.

Preferably, the manual disconnection means is configured to disable the terminals of the battery pack.

Preferably, activating the manual disconnection means causes electrical disconnection of the first and second groups of battery modules.

Preferably, opening the switch disconnects the first and second groups of battery modules.

Preferably, the manual disconnection means is operably connected to one or more central battery modules.

Preferably, the manual disconnection means is operably connected to one or more central battery modules via disconnection busbars.

Ideally, the battery module sub assembly comprises at least one central battery module.

Preferably, the battery module sub assembly comprises two central battery modules.

Preferably, the central battery modules are connected to the manual disconnection means via disconnection busbars.

Preferably, the battery pack comprises a support means.

Preferably, the battery module sub assembly comprises a support means.

Preferably, the battery module sub assembly comprises a support means for supporting and/or mechanically coupling one or more battery modules.

Preferably, two or more of the battery modules in the battery module sub assembly are mechanically connected to one another.

Ideally, the battery modules in the battery module sub assembly are mechanically coupled to each other via the support means.

Preferably, the support means comprises one or more end face support members.

Preferably, the support means comprises two end face support members located at the peripheral ends of the battery module sub assembly.

Ideally, the support means comprises elongate corner support members.

Ideally, the support means comprises four elongate corner support members.

Preferably, the or each corner support member is an L-shaped section.

Preferably, the or each corner support member is adapted to receive the corners of a plurality of battery modules.

Preferably, the or each elongate corner support member is attachable to the or each battery module.

Preferably, the or each end face support member is connected to the or each corner support member.

Preferably, the support means comprises one or more holding means.

Preferably, the support means comprises one or more holding means for attaching and securing the multiport fluid connectors to the battery module sub-assembly.

Preferably, the support means comprises one or more holding means for attaching and securing the multiport fluid connectors. Advantageously, the holding means can be used to retain and hold the multiport fluid connector in a battery module sub assembly such that the branch ports are in fluid communication with the first and second fluid connection conduits of a peripheral fluid delivery arrangement.

Preferably, the holding means comprises a main planar portion.

Preferably, the main planar portion is adapted to engage with and press against the multiport fluid connector, in particular the first body member, in use.

Preferably, the main planar portion comprises a port aperture.

Preferably, the primary port passes through the port aperture in the main planar portion.

Preferably, the holding means comprises one or more attachment portions.

Preferably, the holding means comprises three attachment portions.

Preferably, the or each attachment portion extends from the main planar portion.

Preferably, the or each attachment portion comprises a plurality of apertures for receiving a fixing arrangement such as a screw or bolt for fixing the holding plate to another component such as a fluid delivery arrangement.

According to a further aspect of the invention there is provided a battery pack comprising a housing, a battery module sub-assembly and at least one mounting means for the battery module sub assembly. Advantageously, the mounting means are adapted to support the weight of the battery module sub assembly.

According to a further aspect of the invention there is provided a battery pack comprising a housing and a battery module sub-assembly, wherein the battery module sub assembly is at least partly located inside the housing and wherein the battery module sub assembly is mechanically connected to at least one mounting means. Advantageously, the mounting means are able to transfer the weight of the battery module sub assembly to a further component such as an external chassis or supporting structure.

Preferably, the battery module sub assembly is mechanically connected to the at least one mounting means

Preferably, the or each mounting means is accessible through the battery pack housing.

Preferably, the or each mounting means and provide mechanical connection points on the exterior of the battery pack.

Preferably, the mounting means is accessible from the exterior of the battery pack housing.

Preferably, the mounting means is adapted to transfer the weight of the battery module sub assembly to a component outside the housing. Advantageously, the mounting means allow the weight of the battery module sub assembly to be transferred directly to a supporting structure, such as an external chassis, rather than being transferred to the supporting structure via e.g. connection to the battery pack housing and one or more external brackets.

Preferably, the battery pack comprises a plurality of mounting means. Advantageously, the mounting means allow the battery pack to be mounted to another structure such as a vehicle chassis.

Preferably, the battery pack comprises eight mounting means.

Preferably, the mounting means provide a plurality of positions on the battery pack housing where the battery pack can be securely mounted to e.g. a vehicle chassis or other structure.

Preferably, in use the battery pack is mounted on a supporting structure such as a chassis.

Preferably, in use the battery pack is mounted on a supporting structure such as a chassis via the mounting means

Preferably, mounting means are accessible through apertures in the cover member of the battery pack housing.

Preferably, the mounting means are accessible through the cover member are upper mounting arrangements.

Preferably, the upper mounting arrangements comprise mounting members which are directly accessible through the battery pack housing.

Preferably, further mounting means are located on the base wall of the battery back housing.

Preferably, the mounting means located on the base wall of the battery back housing are lower mounting arrangements.

Preferably, the lower mounting arrangements are covered by feet covering members.

Preferably, the or each mounting means comprises a mounting member.

Preferably, the mounting member is a mounting block having a body.

Preferably, the mounting member comprises a first interface portion.

Preferably, the first interface portion is adjacent to the battery pack housing.

Preferably, the mounting member comprises a second interface portion

Preferably, the second interface portion is adjacent to the battery module sub-assembly.

Preferably, the second interface portion is similar to the first interface portion.

Preferably, the first interface portion comprises an annular recess for receiving a seal, such as an o-ring. Advantageously, a seal can be used to seal the interface between the mounting member and an adjacent component such as the cover of the battery pack housing.

Preferably, the or each interface portion comprises receiving means.

Preferably, the receiving means comprises a tubular member having a threaded hole.

Preferably, the receiving means is adapted for receiving fixing means such as screws and/or bolts which can be used to attach the mounting member to an external support or chassis etc.

Preferably, the or each interface portion comprises further receiving means.

Preferably, the or each interface portion comprises two further receiving means.

Preferably, the further receiving means comprise threaded holes.

Preferably, the further receiving means are adapted for receiving fixing means such as screws and/or bolts which can be used to attach the mounting member to the battery pack housing.

Preferably, each mounting member is attached to the battery module sub-assembly and the battery pack housing via the further receiving arrangements.

Preferably, the mounting members are spacers which define a gap between the battery module sub-assembly and the battery pack housing.

Preferably, the mounting members are adapted to transfer the weight of the battery module sub assembly to the outside of the battery pack housing, e.g. to a supporting structure or chassis.

Preferably, the mounting members are directly accessible on the outside of the battery pack housing, for example via apertures.

According to a further aspect of the invention there is provided a battery module comprising one or more cells and a thermal management means for thermally managing the one or more cells, wherein the thermal management means comprises at least one thermal management duct, an intake-side fluid delivery means and an outlet-side fluid delivery means, wherein the inlet-side fluid delivery means is in fluid communication with the outlet-side fluid delivery means via the at least one thermal management duct. Advantageously, an adjustable number of such battery modules can be incorporated into a battery pack so that any particular volumetric and/or electrical requirements can be met.

According to a further aspect of the invention there is provided a battery module comprising: a battery module housing; one or more cells located within the battery module housing; a thermal management means for thermally managing the one or more cells; and a battery module electrical connection means for providing electrical connections between the battery module and a further battery module and/or an external load. Advantageously, one or more battery modules can be incorporated into a battery pack in a variety of orientations and locations so that any particular volumetric and/or electrical requirements can be met.

According to another aspect of the invention there is provided a battery pack comprising one or more battery modules.

Preferably, the battery module is locatable within a battery pack.

Preferably, the battery pack comprises at least one battery module.

Preferably, the battery pack comprises a plurality of battery modules.

Preferably, the battery pack comprises at least three battery modules.

Preferably, the battery module is connectable to one or more further identical battery modules.

Ideally, the battery module comprises a battery module housing.

Ideally, the battery module housing comprises an upper housing member.

Preferably, the battery module housing comprises a lower housing member.

Preferably, the upper housing member and lower housing member are substantially identical.

Preferably, each of the upper and lower housing members comprise a substantially planar base.

Preferably, each of the upper and lower housing members comprise two side walls.

Preferably, each of the upper and lower housing members comprise two end walls.

Preferably, the respective side walls and end walls extend in a direction which is substantially perpendicular to each base.

Preferably, the side walls of the upper and lower housing members comprise one or more recesses.

Preferably, the end walls of the upper and lower housing members comprise one or more recesses.

Preferably, the battery module housing comprises two opposing side walls.

Ideally, the side wall recesses form apertures in the side walls of the battery module housing.

Ideally, the electrical connections can be made to the battery module terminals through the side wall recesses/apertures.

Preferably, the end wall recesses form apertures in the end walls of the battery module housing.

Preferably, electrical and/or fluid connections can be made to the battery module through the end wall recesses/apertures.

Preferably, the battery module comprises an upper surface and a lower surface. Preferably, the battery module comprises one or more side surfaces.

Preferably, the battery module comprises one or more end surfaces.

Preferably, the upper surface is formed by the base of the upper housing member.

Preferably, the lower surface is formed by the base of the lower housing member.

Preferably, the side surfaces are formed by the side walls of the upper and lower housing members and terminal busbars of the battery module.

Ideally, the end surfaces are formed by the end walls of the upper and lower housing members, the busbars of the battery module, and the fluid delivery means.

Preferably, the battery module comprises at least one cell.

Preferably, the battery module comprises one or more cells.

Preferably, the battery module comprises a plurality of cells.

Preferably, the or each cell is electrically connected to a busbar.

Preferably, the battery module comprises one or more cylindrical cells.

Preferably, the battery module comprises an array of cylindrical cells.

Preferably, the battery module comprises a predetermined number of cells arranged in a regular array.

Preferably, the battery module comprises a multiple of six or twelve cells.

Preferably, the cells are in a close-packed hexagonal array.

Preferably, the battery module comprises a close-packed hexagonal array of cylindrical cells.

Preferably, the or each battery module comprises at least one cell arrangement means.

Preferably, the cell arrangement means is a plate.

Ideally, the cell arrangement means is for supporting and locating a plurality of cells.

Preferably, the cell arrangement means is for supporting and locating a plurality of cells in an array.

Preferably, the cell arrangement means comprises a substantially planar body.

Ideally, the cell arrangement means comprises one or more receiving formations.

Preferably, the cell arrangement means comprises a plurality of receiving formations.

Ideally, the or each receiving formation is formed in the body.

Preferably, the or each receiving formation is adapted for receiving and locating an end of a cell.

Preferably, the receiving formations are arranged in a close-packed hexagonal or honeycomb pattern.

Preferably, the minimum separation between the cells is 2 mm.

Preferably, the battery module comprises one or more cells located within the battery module housing.

Preferably, the battery module comprises one or more sensing means.

Preferably, the sensing means are used to measure the temperature of the cells.

Preferably, the sensing means are located on a flexible carrier.

Preferably, the flexible carrier is a flexible PCB.

Preferably, the flexible carrier is attachable to a duct.

Preferably, the sensing means are located between a thermal management duct and one or more cells.

Preferably, the sensing means comprises one or more sensors.

Preferably, the sensors comprise pressure sensors, temperature sensors, voltage sensors and/or liquid/moisture sensors.

Preferably, the sensors are mounted in arrays.

Preferably, the sensors are mounted in arrays on the flexible carrier. Advantageously, the sensors being mounted in arrays allows the performance and physical characteristics of the battery pack to be mapped, as well as determining the differentials of quantities throughout the pack. For example, fluid flow rates and temperature change rates can be inferred/predicted.

Preferably, the sensors are mounted in linear arrays.

Optionally, the sensors are mounted in polar arrays.

Preferably, the carrier comprises conductive traces. Advantageously the use of conductive traces allows the sensors on the carrier to be operably connected to e.g. the slave board of the battery module allowing the temperature of the cells to be transmitted to and analysed by e.g. the battery pack management means.

Preferably, the battery module comprises a battery module electrical connection means.

Preferably, the battery module comprises a battery module electrical connection means for providing electrical connections between the battery module and a component such as a further battery module, a busbar, an interconnect and/or an external load.

Preferably, the battery module electrical connection means comprises one or more busbars.

Preferably, the battery module electrical connection means comprises positive and negative terminals.

Preferably, the positive and negative terminals are located on the opposing side walls of the housing.

According to a further aspect of the invention there is provided a busbar for a battery module and/or a battery pack, the busbar comprising an electrical connection portion and at least one structural support means. Advantageously, the busbar is dual-purpose in that it provides a means by which electrical connections can be made within a battery module and/or a battery pack, as well as providing additional structural support and mechanical strength to the battery module and/or a battery pack.

According to a further aspect of the invention there is provided a busbar for a battery module and/or a battery pack, the busbar comprising a cell connection portion and an external connection portion, wherein the cell connection portion is disposed at an angle to the external connection portion. Advantageously, the construction of the busbar allows electrical contact to be made between one or more cells within a battery pack or module and an external component.

According to a further aspect of the invention there is provided a battery module comprising at least one busbar.

Preferably, the busbar is used to electrically interconnect one or more cells.

Ideally, the busbar may be employed in a battery module and/or battery pack to provide electrical connections to the cells within a battery pack and/or battery module.

Preferably, the busbar is a terminal of a battery module.

Preferably, the busbar is a positive or negative terminal of a battery module.

Ideally, the busbar is adapted to receive the edge of an array of cells.

Preferably, the busbar comprises an electrical connection portion.

Preferably, the electrical connection portion is adapted for electrically interconnecting one or more cells and one or more further components such as a further busbar, a terminal, an interconnect and/or an external load.

Preferably, the electrical connection portion comprises an external connection portion.

Preferably, the electrical connection portion is at least partially formed from an electrically conductive material.

Preferably, the electrical connection portion is at least partially formed from aluminium or steel.

Preferably, the electrical connection portion is generally non-planar.

Preferably, the electrical connection portion comprises a plurality of portions.

Preferably, the electrical connection portion comprises a cell connection portion.

Preferably, the electrical connection portion comprises a cell connection portion adapted for electrical connection to the terminals of one or more cells, for example via wire bonding.

Preferably, the cell connection portion is substantially perpendicular to the primary external connection portion.

Preferably, the cell connection portion is adapted to be connectable to the terminals and/or casings of one or more cells.

Preferably, the cell connection portion is generally planar.

Ideally, the cell connection portion comprises one or more cell connection apertures.

Ideally, the cell connection portion comprises a plurality of cell connection apertures.

Preferably, the cell connection portion comprises at least two rows of cell connection apertures.

Preferably, the or each connection aperture is generally rectangular.

Preferably, the or each connection aperture is adapted to allow a wire bond to pass fully therethrough.

Preferably, the or each connection aperture is arranged in a close-packed hexagonal or honeycomb pattern.

Preferably, the electrical connection portion comprises at least one external connection portion.

Preferably, the external connection portion is a terminal portion adapted for connection to an external load.

Preferably, the external connection portion is adapted for providing electrical connection to a further component such as a further busbar, a terminal, an interconnect or an external load.

Preferably, the cell connection portion is substantially perpendicular to the external connection portion.

Preferably, the external connection portion comprises a main plane portion.

Preferably, the main plane portion is generally planar.

Preferably, the external connection portion comprises one or more raised portions.

Ideally, the external connection portion comprises a plurality of raised portions.

Ideally, the external connection portion comprises four raised portions.

Preferably, the generally planar portion comprises one or more raised portions.

Preferably, the or each raised portion is adapted for providing electrical connection to a further component such as a further busbar, a terminal, an interconnect or an external load.

Preferably, the or each raised portion is generally planar.

Preferably, the or each raised portion is raised above the main plane of the primary external connection portion.

Preferably, the or each raised portion is adapted to be accessible through the housing of a battery module.

Preferably, the or each raised portion is adapted to pass through an aperture in the housing of a battery module.

Preferably, the or each raised portion is integrally formed in the external connection portion.

Preferably, the or each raised portion is formed via pressing.

Ideally, the or each raised portion comprises a planar portion surrounded by a curved peripheral portion.

Preferably, the or each raised portion comprises a retaining means.

Preferably, the or each retaining means comprises a threaded hole.

Preferably, the or each retaining means is adapted to retain a fixing means such as a bolt. Advantageously, the presence of a retaining means allows e.g. an intermodule busbar to be rigidly attached to the connection surface of the busbar.

Preferably, the or each electrical connection portion is accessible from the exterior of the battery module. Advantageously the accessibility of primary and secondary electrical connection portions allows the battery module to be electrically connected to other components in a plurality of locations and/or orientations.

Preferably, the or each cell in the battery module is electrically connected to at least one busbar.

Preferably, the or each cell in the battery module is electrically connected to at least one busbar via one or more wire bonds.

Preferably, the or each cell in the battery module is electrically connected to at least one busbar via wire bonds which are fusible and/or frangible electrical connections.

Preferably, the or each wire bond electrical connection to a busbar is made using ultrasonic bonding, laser welding, ultrasonic welding or resistance welding.

Preferably, the or each wire bond is an aluminium wire bond.

Preferably, the busbar comprises at least one structural support means.

Preferably, the busbar comprises two structural support means.

Preferably, the or each structural support means is adapted for retaining the electrical connection portion in position within a battery module, and/or for providing structural support to the battery module. Advantageously, structural support means allow multiple battery modules to be aligned and stacked.

Preferably, the or each structural support means is locatable at a peripheral end of an electrical connection portion.

Preferably, the or each structural support means comprises a body portion.

Preferably, the body portion is preferably made from a non-conductive material such as plastic.

Preferably, the or each structural support means is rigidly attached to the electrical connection portion

Preferably, the or each structural support means is overmolded on the electrical connection portion.

Preferably, the or each structural support means comprises an end portion.

Preferably, the or each structural support means comprises an upper portion.

Preferably, the or each structural support means comprises a lower portion.

Preferably, the or each structural support means comprises a side portion.

Preferably, the outer surfaces of the upper portion and lower portion are substantially parallel.

Preferably, the outer surfaces of the end portion and side portion are substantially perpendicular to one another. By ‘outer surface’ it is meant the surface which is outermost in use, and which is opposite the inner surface.

Preferably, the outer surfaces of the end portion and side portion are substantially perpendicular to the outer surfaces of the upper portion and the lower portion.

Preferably, the or each structural support means is attached to the electrical connection portion via fixing members which pass through apertures at the peripheral end of the external connection portion.

Preferably, the side portion of the or each structural support means is attached to the external connection portion.

Preferably, the peripheral end of the external connection portion of the busbar is received in the or each structural support means.

Preferably, the or each structural support means comprises first and second receiving arrangements for receiving fixing means such as screws and/or bolts.

Preferably, the first and second receiving arrangements comprise threaded apertures.

Preferably, the first receiving arrangement is located in the end portion.

Preferably, the second receiving arrangement is located in the side portion.

Preferably, the receiving arrangements are adapted to allow the elongate corner support members of the support arrangement to be attached to the busbar via fixing means such as screws and/or bolts.

Preferably, at least one aperture is located in the external connection portion.

According to a further aspect of the invention there is provided a thermal management means for thermally managing one or more cells within a battery pack, battery module sub assembly or battery module.

According to a further aspect of the invention there is provided a battery pack, battery module sub assembly or battery module comprising a thermal management means.

Preferably, the or each battery module comprises a thermal management means.

Preferably, the or each battery module comprises a thermal management means for thermally managing the one or more cells.

Preferably, the thermal management means is configured to allow fluid connections to be made to the battery module in a plurality of locations and/or orientations.

Ideally, the or each thermal management means is adapted to thermally manage the cell(s).

Ideally, the or each thermal management means is adapted to heat and/or cool the cell(s).

Preferably, the thermal management means comprises an inlet-side fluid delivery means

Preferably, the thermal management means comprises an outlet-side fluid delivery means.

Preferably, the inlet-side fluid delivery means and the outlet-side fluid delivery means are substantially identical.

Preferably, the thermal management means comprises one or more thermal management ducts.

Preferably, the thermal management means comprises a plurality of thermal management ducts.

Preferably, the thermal management means comprises one or more substantially parallel thermal management ducts.

Preferably, the thermal management means comprises one or more manifold ducts.

Preferably, the thermal management means comprises one or more serpentine ducts.

Preferably, the or each thermal management duct is a flexible duct.

Preferably, the or each thermal management duct is flexible and/or inflatable.

Preferably, the or each thermal management duct is made from an inflatable plastics material. An inflatable plastics material is advantageous as the material is intrinsically electrically insulating, lightweight and does not corrode or chemically interact with a coolant such as a glycol water mix.

Ideally, the or each thermal management duct is made from polyethylene (PE).

Preferably the or each thermal management duct is made from low-density polyethylene (LDPE), linear low-density polyethylene (LLDPE) or high-density polyethylene (HDPE).

Preferably the or each thermal management duct comprises one or more thermally conductive additives. Thermally conductive additives provide the advantage that they can improve the thermal conductivity of the duct material.

Preferably the thermally conductive additives may comprise a thermally conductive filler material.

Preferably the thermally conductive additives may comprise particles of a thermally conductive filler material.

Preferably the particles have a diameter of 1-10 nm.

Preferably the particles have a diameter of <5 μm.

Preferably the thermally conductive filler material is incorporated into the inflatable plastics material.

Ideally the or each thermal management duct comprises a matrix material and a thermally conductive filler material.

Preferably the matrix material comprises the inflatable plastics material such as polyethylene (PE), low-density polyethylene (LDPE), linear low-density polyethylene (LLDPE) or high-density polyethylene (HDPE).

Preferably the thermally conductive filler comprises a carbon-based filler material.

Preferably the thermally conductive filler comprises carbon, carbon black, graphite, graphene, multi-walled carbon nanotubes or single-wall carbon nanotubes.

Optionally the thermally conductive filler comprises an inorganic filler material.

Optionally the thermally conductive filler comprises a ceramic filler material.

Optionally the thermally conductive filler comprises aluminium oxide, silicon carbide, boron nitride, silicon nitrate, alumina, aluminium nitride or zinc oxide.

Preferably the thermally conductive filler comprises a mixture of different types of particles.

Preferably the thermally conductive filler comprises a mixture of at least two different types of particles.

Ideally the or each duct comprises polyethylene, a carbon-based filler material and a ceramic-based filler material.

Preferably the or each duct comprises polyethylene, graphite particles and boron nitride particles.

Preferably the or each duct comprises up to 30% additives.

Preferably the ratio of carbon-based filler material to ceramic-based filler material is between 1:0 and 0:1.

Ideally the thermal conductivity of the or each thermal management duct is >≈0.8 W/m.K.

Ideally the thermal conductivity of the or each thermal management duct is approximately 1 W/m.K.

Preferably, the walls of the or each flexible duct are between 50 μm and 150 μm thick. Advantageously, the thickness if the walls allow for good thermal transfer properties between the or each duct and the cells.

Preferably, the or each thermal management duct is a single-lumen duct.

Preferably, the or each thermal management duct is a multi-lumen duct.

Optionally the or each thermal management duct is a rigid duct made from e.g. aluminium or copper.

Preferably, the or each thermal management duct is positioned adjacent to and/or between cells in a battery module.

Preferably, the or each thermal management duct is in a substantially inflated state.

Preferably, the or each thermal management duct is inflated.

Preferably, the or each thermal management duct expands into contact with the side walls of one or more cells.

Preferably, the or each thermal management duct is in an expanded state such that said thermal management duct has a shape which conforms to the surface shape of one or more cells.

Preferably, the or each thermal management duct is in direct contact with one or more cells.

Preferably, the or each thermal management duct is in indirect contact with one or more cells.

Optionally, the or each thermal management duct is in indirect contact with one or more cells via an interface region or interface material.

Optionally, the or each thermal management duct is in indirect contact with one or more cells via an interface region or interface material such as a casing sheath surrounding the cells.

Preferably, the or each thermal management duct is in indirect contact with one or more cells via a thermally conductive filler material such as a conductive paste or adhesive.

Preferably, the or each battery module comprises a potting means.

Preferably, the potting means is poured into the battery module in a liquid state and sets, cures or hardens.

Preferably, in its set, cured or hardened state, the potting means is substantially rigid such that it secures the cells and the thermal management ducts in position within the battery module.

Preferably, the potting means is adhesively attached to the or each duct.

Preferably, the potting means provides total external support to the or each duct.

Preferably, the potting means prevents excessive expansion and/or bursting of the or each duct.

Preferably, the potting means maintains each duct in an open configuration such that coolant is able to flow easily through the or each duct.

Ideally, the potting means is an expandable potting means.

Preferably, the potting means comprises a thermally insulating potting material such as intumescent polyurethane foam. Advantageously polyurethane foam is lighter than other potting materials and therefore provides a battery module having a low overall weight.

Preferably, the potting means, when in the expanded state, substantially fills gaps within the or each module.

Optionally, the potting means comprises a thermosetting plastic, silicone rubber gel or epoxy resin.

According to a further aspect of the invention there is provided a duct clamping means, wherein the duct clamping means is adapted to clamp a duct to a further component such as a nozzle. Advantageously, the duct clamping means is adapted to prevent leaks from developing at or around the further component.

According to a further aspect of the invention there is provided a duct assembly comprising a duct, at least one nozzle and at least one duct clamping means, wherein the nozzle is attached to the duct and wherein the duct clamping means is adapted to clamp the duct to the nozzle. Advantageously, the duct assembly can be provided in a battery module to enable the thermal management of one or more cells.

Preferably, the or each battery module comprises at least one duct assembly.

Preferably, the or each battery module comprises at least one nozzle.

Preferably, the or each battery module comprises at least one duct clamping means.

Preferably, the or each duct forms part of such a duct assembly.

Preferably, the duct assembly comprises a duct having two open ends.

Preferably, the duct assembly comprises an inlet-side nozzle.

Preferably, the duct assembly comprises an inlet-side duct clamping assembly.

Preferably, the duct assembly comprises an outlet-side nozzle.

Preferably, the duct assembly comprises an outlet-side duct clamping assembly.

Preferably, the or each duct clamping assembly is used to clamp an open end of the duct to a respective nozzle.

Preferably, the or each duct clamping assembly ensures that there is a fluid-tight connection between the duct and a respective nozzle.

Preferably, the or each duct clamping assembly prevents leaks from developing at the respective nozzle-duct interface.

Preferably, the end of the duct assembly can be used at either end of the duct assembly.

Preferably, the inlet-side nozzle and the outlet-side nozzle are substantially identical.

Preferably, the inlet-side duct clamping assembly and the outlet-side duct clamping assembly are substantially identical.

Preferably, the nozzle comprises a nozzle body

Preferably an aperture passes through the nozzle body.

Preferably, fluid is able to pass through the nozzle body via the aperture.

Preferably, the nozzle body comprises a flange portion.

Preferably, the nozzle body comprises an attachment portion.

Preferably, the attachment portion is located within the open end of the duct.

Preferably, the duct is heat welded at the open end thereof to the attachment portion of the nozzle.

Preferably, the flange portion comprises a raised portion.

Preferably, the flange portion, particularly the raised portion, provides a surface which can be attached to another component, for example a fluid delivery arrangement.

Preferably, the nozzle is attached to a fluid delivery arrangement via e.g. plastic welding.

Preferably, the duct clamping assembly comprises a bearing member

Preferably, the duct clamping assembly comprises at least one securement member.

Preferably, the duct clamping assembly comprises first and second securement members.

Preferably, the duct clamping assembly comprises a biasing member.

Preferably, the or each securement member and the bearing member are made from an insulating plastics material, or a metal such as aluminium.

Preferably, the biasing member is preferably formed from a resilient material, such as steel wire.

Preferably in use the duct clamping assembly bears and pushes against the open end of the duct and the nozzle.

Preferably, the duct is joined to the attachment portion of the nozzle at the open end of the duct, for example via ultrasonic welding.

Preferably, the duct clamping assembly reinforces the join between the open end of the duct and the attachment portion of the nozzle.

Preferably, the duct clamping assembly acts to prevent leaks developing at the interfaces between the duct and the nozzle.

Preferably, the bearing member comprises a first elongate portion.

Preferably, the bearing member comprises a second elongate portion.

Preferably, the bearing member comprises a joining portion.

Preferably, the joining portion joins the first elongate portion to the second elongate portion.

Preferably, a gap is located between the elongate portions. Advantageously, the gap allows the nozzle and attachment portion to pass therethrough, and to move to a position between the elongate portions such that the nozzle and attachment portion can be received by the bearing member

Preferably, a gap is located between the ends of the elongate portions opposite the joining portion.

Preferably, the bearing member is a U-shaped member

Preferably, the bearing member is adapted for bearing against the duct and nozzle.

Preferably, the inner surface of the bearing member is adapted for bearing against the duct at a position where the duct is attached to the nozzle.

Preferably, the inner surface of the bearing member is generally smooth.

Preferably, the bearing member further comprises positioning elements in the form of protrusions which extend from the first and second elongate portions.

Preferably, the two positioning elements extend from the first elongate portion.

Preferably, two positioning elements extend from the second elongate portion.

Preferably, the positioning elements can be received in corresponding receiving portions of the first and second securement members.

Preferably, the biasing member comprises a body.

Preferably, the biasing member comprises first and second arm portions.

Preferably, the biasing member comprises a bridge portion.

Preferably, the first and second arm portions are substantially straight and parallel.

Preferably, the first and second arm portions are each connected to the bridge portion at a respective end thereof.

Preferably, each arm portion comprises a respective retainable portion.

Preferably, the or each retainable portion is a curved end portion.

Preferably, the biasing member is a spring.

Preferably, the biasing member is adapted to provide a force to push the first and second securement members towards each other, and towards the bearing member, attachment portion of the nozzle and/or the open end of the duct.

Preferably, in use, the biasing member bears against the first and second securement members.

Preferably, the force provided by the biasing member is transferred to the join between the duct and nozzle by the first and second securement members and the bearing member.

Preferably, the duct clamping assembly reinforces the join between the duct and nozzle.

Preferably, the duct clamping assembly ensures a leak-tight connection between the duct and nozzle at the ends of the duct.

Preferably, the securement member comprises an elongate portion.

Preferably, the securement member comprises two curved end portions.

Preferably, the securement member comprises two curved end portions at either end of the elongate portion.

Preferably, the securement member comprises an inner surface.

Preferably, the inner surface is adapted for engagement with an outer surface of the bearing member.

Preferably, the inner surface of the securement member comprises receiving portions.

Preferably, the receiving portions are adapted to receive positioning elements of the bearing member.

Preferably, the receiving portions are adapted to receive and accommodate the positioning elements when the securement member abuts and is pressed against one side of the bearing member. Advantageously, the receiving portions allow the first securement member to be accurately placed against the side of the bearing member at the correct position. Further advantageously, mating of the positioning elements and receiving portions prevents displacement of the first securement member with respect to the bearing member.

Preferably, the distance between the receiving portions is equal to the distance between the positioning elements.

Preferably, the securement member comprises an outer surface.

Preferably, the outer surface of the securement member comprises a channel.

Preferably, the channel is an elongate slot.

Preferably, the channel is adapted to accommodate at least a part of the biasing member.

Preferably, the channel is adapted to receive an arm of the biasing member.

Preferably, the channel is formed between first and second walls.

Preferably, the first and/or second wall is continuous.

Optionally, the first and/or second wall is discontinuous.

Optionally, the first and/or second wall comprises one or more discontinuities.

Preferably, the first and/or second wall extends along the securement member

Preferably, the first and/or second wall extends along the entire length of the securement member.

Preferably, the first and/or second wall extends along the entire length of the elongate portion and the curved portions.

Preferably, the securement member comprises a receiving means.

Preferably, the outer surface of the securement member comprises a receiving means.

Preferably, the receiving means is a recess.

Preferably, the receiving means is a recess in the body of the securement member.

Preferably, the receiving means is adapted to receive a part of the biasing member.

Preferably, the receiving means is adapted to receive one of the retainable portions.

Preferably, the receiving means is adapted for engagement with a portion of the biasing member.

Preferably, the receiving means is adapted for engagement with one of the retainable portions of the biasing member. Advantageously, the receiving means allows the biasing member to be accurately placed in the channel of the securement member at the correct position. Further advantageously, mating of a retainable portion of the biasing member and the receiving arrangement prevents displacement of the biasing member with respect to the securement member, in use.

According to a further aspect of the invention there is provided a fluid delivery means for delivering a thermal management fluid to one or more thermal management ducts locatable within a battery module and/or a battery pack, the fluid delivery means comprising: a first connection conduit adapted to provide a path for fluid into and/or out of the fluid delivery means; a second connection conduit adapted to provide a path for fluid into and/or out of the fluid delivery means; and one or more distribution means adapted to provide a path for fluid into and/or out of the fluid delivery means; wherein each distribution means is in fluid communication with the first connection conduit and the second connection conduit. Advantageously, the fluid delivery means provides a means by which fluid can be distributed within a battery pack to thermally manage multiple cells.

According to a further aspect of the invention there is provided a fluid delivery means for delivering a thermal management fluid to one or more thermal management ducts locatable within a battery module and/or a battery pack, wherein the fluid delivery means comprises a plurality of paths for fluid to pass into and/or out of the fluid delivery means. Advantageously, the fluid delivery means provides a means by which fluid can be distributed within a battery pack to thermally manage multiple cells.

According to a further aspect of the invention there is provided a battery module and/or a battery pack comprising a fluid delivery means.

Preferably, the battery pack comprises at least one fluid delivery means.

Preferably, the battery pack comprises two fluid delivery means.

Preferably, the battery module comprises at least one fluid delivery means.

Preferably, the battery module comprises two fluid delivery means.

Preferably, the thermal management means comprises at least one fluid delivery means.

Preferably, the thermal management means comprises two fluid delivery means.

Preferably, the or each duct is operably connected to at least one fluid delivery means.

Ideally, the or each duct is operably connected to two fluid delivery means.

Preferably, the or each duct is sealably connected to at least one fluid delivery means.

Preferably, the or each duct is welded to at least one nozzle or fluid delivery means.

Preferably, the or each fluid delivery means is adapted for delivering a thermal management fluid to one or more thermal management ducts locatable within a battery module and/or battery pack.

Preferably, the fluid delivery means comprises a first connection conduit.

Preferably, the fluid delivery means comprises at least one first connection conduit.

Preferably, the fluid delivery means comprises at least one first connection conduit adapted to provide a path for fluid into and/or out of the fluid delivery means.

Preferably, the fluid delivery means comprises a second connection conduit.

Preferably, the fluid delivery means comprises at least one second connection conduit.

Preferably, the fluid delivery means comprises at least one second connection conduit adapted to provide a path for fluid into and/or out of the fluid delivery means.

Preferably, the fluid delivery means comprises a body.

Preferably, the fluid delivery means comprises a body which is formed of front and rear members.

Preferably, the first connection conduit and/or second connection conduit forms part of the front member.

Preferably, the or each fluid delivery means comprises a main chamber.

Preferably, the front member partially encloses the main chamber.

Preferably, the rear member partially encloses the main chamber.

Preferably, the rear member of the body comprises one or more distribution means.

Preferably, the main chamber is located within the body.

Preferably, the main chamber is fully enclosed by the front and rear members.

Preferably, the front and rear members are sealably attached to one another.

Ideally, the or each fluid delivery means is a header tank.

Preferably, the or each fluid delivery means is operably connected to at least one duct and/or duct assembly.

Preferably, the or each fluid delivery means is operably connected to at least one thermal management duct and/or duct assembly.

Preferably, the or each fluid delivery means is operably connected to a plurality of ducts and/or duct assemblies.

Preferably, the or each fluid delivery means is operably connected to a plurality of ducts and/or duct assemblies.

Preferably, the or each fluid delivery means, in use, is operably connected to one or more further fluid delivery means.

Preferably, the first and/or second connection conduit provides a fluid path into and/or out of the fluid delivery means.

Preferably, the or each first and/or second connection conduit provides a fluid path into and/or out of a main chamber.

Preferably, the first and/or second connection conduit is in fluid communication with the main chamber.

Preferably, the first and/or second connection conduit is in fluid communication with the main chamber via one or more fluid connection apertures.

Preferably, the first and/or second connection conduit is in fluid communication with the main chamber via two fluid connection apertures.

Preferably, the main chamber comprises a main chamber peripheral wall.

Preferably, the main chamber is located within a space defined by a main chamber peripheral wall.

Preferably, the main chamber peripheral wall is an annular wall

Preferably, the main chamber peripheral wall encloses the fluid connection apertures.

Preferably, the or each first and/or second connection conduit comprises a first fluid connection means.

Preferably, the or each first fluid connection means is a fluid inlet.

Preferably, the or each first and/or second connection conduit comprises a second fluid connection means.

Preferably, the or each second fluid connection means is a fluid outlet.

Preferably, the first fluid connection means of the first and/or second connection conduit provides a fluid path into the fluid delivery means.

Preferably, the first fluid connection means of the first and/or second connection conduit is connectable to a source of thermal management fluid.

Preferably, the second fluid connection means of the first and/or second connection conduit provides a fluid path out of the fluid delivery means.

Preferably, a first fluid connection means is provided at a first end of the first and/or second connection conduit.

Preferably, a second fluid connection means is provided at a second end of the first and/or second connection conduit.

Preferably, the first end of the first and/or second connection conduit is opposite the second end of the first and/or second connection conduit.

Ideally, the first and/or second connection conduit comprises a first and/or second connection conduit wall.

Preferably, the first and/or second connection conduit wall has a regular cross section.

Preferably, the first and/or second connection conduit extends along an axis.

Preferably, the first and/or second connection conduit has a main or major axis.

Preferably, the main or major axis of the first and/or second connection conduit extends along the length of the first and/or second connection conduit.

Preferably, the main or major axis of the first and/or second connection conduit is substantially parallel to the direction of fluid flow through the first and/or second connection conduit from the first fluid connection means to the second fluid connection means thereof.

Preferably, the main or major axis of the first and/or second connection conduit is substantially parallel to the main or major axis of the first and/or second connection conduit of a neighbouring fluid delivery means.

Preferably, the first fluid connection means of the first and/or second connection conduit is connectable to a first and/or second fluid connection means of a further fluid delivery means.

Preferably, the second fluid connection means of the first and/or second connection conduit is connectable to a first and/or second fluid connection means of a further fluid delivery means.

Preferably, the first fluid connection means and/or the second fluid connection means comprises attachment means.

Preferably, the or each attachment means comprises a flange.

Preferably, the or each attachment means comprises a channel for a receiving a seal.

Preferably, each flange comprises two sloped surfaces.

Preferably, the or each flange comprises a channel.

Ideally, the sloped surfaces are substantially opposite the surface of each flange in which the channel is formed.

Preferably, the or each channel is adapted to receive and retain part of a sealing means.

Preferably, the or each channel has a predetermined depth.

Preferably, the or each channel has a predetermined depth suitable for receiving at least a part of a sealing means.

Preferably, the fluid delivery means comprises a plurality of distribution means.

Preferably, each distribution means comprises a distribution aperture formed within a nozzle attachment portion.

Preferably, each nozzle attachment portion comprises a recess portion.

Preferably, each recess portion is an annular recess which extends around a distribution aperture.

Preferably, each recess portion is adapted to receive part of a nozzle, in particular the raised portion on the flange portion of a nozzle.

Preferably, the recess portion allows the nozzle to be accurately located with respect to the distribution aperture, and attached to the distribution means at the correct location.

Preferably, the rear member of the fluid delivery means comprises a plurality of distribution apertures through which fluid can flow between the main chamber and the distribution means.

Preferably, the rear member comprises eight distribution apertures and eight distribution means.

Preferably, each distribution means is adapted to allow fluid to pass through said distribution means and into and or out of a respective duct/duct assembly.

Preferably, in use, coolant is able to flow from the main chamber, through each distribution aperture and into a duct/duct assembly/nozzle.

Preferably, the distribution apertures of the fluid delivery means are aligned.

Preferably, each distribution aperture is of equal length.

Preferably, each distribution aperture extends the full height of the aperture portion.

Preferably, each distribution aperture is in fluid communication with both the first connection conduit and the second connection conduit such that fluid passing into the fluid distribution means via either conduit can be distributed to any distribution aperture.

Preferably, fluid passing through the main chamber is distributed to each fluid distribution means evenly.

Preferably, the fluid delivery means comprises a storage compartment.

Preferably, the storage compartment is an integral storage compartment.

Preferably, the storage compartment is integrally formed in the front member.

Preferably, the storage compartment is located between the first connection conduit and the second connection conduit.

Preferably, the storage compartment is a sealable chamber. Advantageously, the storage compartment can store e.g. a slave board of the battery management computer. Further advantageously, the storage compartment is sealable to prevent e.g. fluids entering the storage compartment.

Preferably, the storage compartment comprises a peripheral wall.

Preferably, the storage compartment comprises one or more pillars.

Preferably, the or each pillar is adapted to receive fixing means such as screws.

Preferably, the fluid delivery means comprises a cover member.

Preferably, the cover member is attachable to the fluid delivery means.

Preferably, the cover member is adapted to seal the storage compartment.

Preferably, the or each distribution means is attached to a duct assembly.

Preferably, the or each distribution means is attached to a nozzle of a duct assembly.

Preferably, the or each duct assembly is connected two fluid delivery means

Preferably, the or each nozzle being attached in a fluid-tight manner to a distribution means.

Preferably, the or each nozzle can be welded to the rear member of the fluid distribution means.

Preferably, the raised portion on the flange portion of a nozzle is located within a recess portion and the flange of the nozzle is welded to the nozzle attachment portion. Advantageously, attachment in this way provides a fluid-tight connection between the nozzle and rear member of the fluid distribution means.

Preferably, a clamping assembly is located over the join between the duct and nozzle to reinforce the join and to prevent leaks.

Preferably, in use, the first connection conduit and second connection conduit are used to transport fluid to and/or from the main chamber.

Preferably, each fluid connection means is open so that fluid can pass into and out of the main chamber via the first connection conduit and second connection conduit.

Preferably, each distribution means has an identical aperture which is in fluid communication with the main chamber.

Optionally, the fluid delivery means comprises a dividing wall.

Optionally, the dividing wall is located within the main chamber.

Optionally, the dividing wall splits the main chamber into a plurality of sub-chambers.

Optionally, the dividing wall follows a non-straight path.

Optionally, the dividing wall is crenellated.

Optionally, the dividing wall comprises a plurality of crenellations.

Optionally, the main chamber peripheral wall encloses the dividing wall.

Optionally, the main chamber comprises a first sub-chamber and a second sub-chamber.

Optionally, the dividing wall splits the main chamber into the first sub-chamber and the second sub-chamber.

Optionally, the first sub-chamber is located between the main chamber peripheral wall and a first side of the dividing wall.

Optionally, the second sub-chamber is located is located between the main chamber peripheral wall and a second side of the dividing wall.

Optionally, the second side of the dividing wall is opposite the first side of the dividing wall.

Optionally, the first and second connection conduits and/or each distribution means of the fluid delivery means are in fluid communication with only a part of the main chamber.

Optionally, the first connection conduit is in fluid communication with the first sub-chamber via two fluid connection apertures.

Optionally, the second connection conduit is in fluid communication with the second sub-chamber via two fluid connection apertures.

Optionally, the first connection conduit is not in fluid communication with the second sub-chamber.

Optionally, the second connection conduit is not in fluid communication with the first sub-chamber.

Optionally, the fluid delivery means comprises a plurality of first distribution means, and a plurality of second distribution means.

Optionally, the distribution apertures of the plurality of first distribution means are aligned.

Optionally, the distribution apertures of the plurality of second distribution means are also aligned.

Optionally, the distribution apertures of the plurality of first distribution means are not in alignment with the distribution apertures of the plurality of second distribution means.

Optionally, the distribution apertures of the plurality of first distribution means are offset with respect to the distribution apertures of the plurality of second distribution means.

Optionally, the distribution aperture in each first and/or second distribution means does not extend the full height of the respective aperture portion.

Optionally, the or each distribution aperture in each first and/or second distribution means extends along a part of the height of the respective aperture portion.

Optionally, the aperture portion of each first and/or second distribution means comprises a blanking portion adjacent to the aperture portion.

Optionally, the or each first distribution aperture is in fluid communication with the first connection conduit via the first sub-chamber.

Optionally, fluid passing into the fluid distribution means via the first connection conduit is distributed to the first distribution apertures evenly.

Optionally, the or each second distribution aperture is in fluid communication with the second connection conduit via the second sub-chamber.

Optionally, the blanking portions of each first distribution means are on the opposite side of the rear member to the blanking portions of each second distribution means.

Optionally, the distribution aperture of each first distribution means is located on one side of the dividing wall.

Optionally, the distribution aperture of each second distribution means is located on the opposite side of the dividing wall.

Optionally, the or each blanking portion coincides with the position of the dividing wall and forms a seal with the dividing wall.

Optionally, the distance between neighbouring distribution means may correspond to the width of a cell.

Optionally, the ducts may be provided on both sides of the cell. Advantageously, this can provide redundancy i.e. if the duct on one side of the cell bursts or fails then the duct on the other side of the cell can be used to thermally manage the cell.

Optionally, fluid passing into the fluid distribution means via the first connection conduit is distributed to the first distribution apertures evenly.

Optionally, fluid passing into the fluid distribution means via the second connection conduit is distributed to the second distribution apertures evenly.

According to a further aspect of the invention there is provided a multiport fluid connector comprising a primary port and two branch ports, wherein the multiport fluid connector is a low-profile multiport fluid connector. Advantageously, the low-profile multiport fluid connector is able to fit within a limited volume such as a predetermined volume within a battery pack.

According to a further aspect of the invention there is provided a multiport fluid connector for connecting a fluid distribution arrangement to a source of thermal management fluid.

According to a further aspect of the invention there is provided a multiport fluid connector for a battery pack.

Preferably, the multiport fluid connector is a fluid connector.

Preferably, the multiport fluid connector is adapted to fit within a predetermined volume.

Preferably, the multiport fluid connector is a low-profile fluid connector.

Preferably, the multiport fluid connector has a limited height.

Preferably, the multiport fluid connector is adapted to split/combine the flow of fluid therethrough.

Preferably, the multiport fluid connector is adapted to minimise the creation of swirl components and pressure drop over a limited distance.

Preferably, the multiport fluid connector comprises a body.

Preferably, the multiport fluid connector comprises a primary port.

Preferably, the multiport fluid connector comprises at least one branch port.

Preferably, the multiport fluid connector comprises two branch ports.

Preferably, the multiport fluid connector further comprises an internal chamber.

Preferably, the primary port is in fluid communication with the or each branch port via the internal chamber.

Preferably, the body is a two-part body.

Preferably, the body comprises a first body member and a second body member.

Preferably, the first body member and/or the second body member are preferably made from a plastic material and may be formed via injection moulding techniques.

Preferably, the first body member and second body member may be joined using plastic welding or other suitable techniques.

Preferably, the first body member comprises the primary port and part of the wall of the internal chamber.

Preferably, the primary port comprises a tubular member.

Preferably, the primary port is fluidly connected to the internal chamber.

Preferably, the primary port is fluidly connected to the internal chamber at or near the centre of the internal chamber.

Preferably, the first body member comprises a neck portion.

Preferably, the neck portion is located at the end of the primary port

Preferably, the neck portion is located adjacent to the internal chamber.

Preferably, multiport fluid connector comprises one or more raised portions. Advantageously, the shaping of the walls, particularly the raised portions are adapted to guide the flow of fluid through the internal chamber.

Preferably, the first body member and/or second body member comprises one or more raised portions. Advantageously, the or each raised portion is adapted to reduce the pressure drop and swirl components in the internal chamber.

Preferably, the first body member comprises a principal raised portion

Preferably, the first body member comprises two secondary raised portions.

Preferably, the or each raised portion is a protrusion.

Preferably, the or each raised portion extends into the internal chamber.

Preferably, the principal raised portion is adjacent to the primary port.

Preferably, the principal raised portion is located between the branch ports.

Preferably, the secondary raised portions are located on either side of the primary port.

Preferably, the principal raised portion is located on the opposite side of the internal chamber to the two secondary raised portions.

Preferably, the second body member comprises the two branch ports.

Preferably, the or each branch port comprises a tubular member which is fluidly connected to the internal chamber.

Preferably, the or each branch port comprises a tubular member which is fluidly connected to the internal chamber at or near an edge of the internal chamber.

Preferably, the second body member comprises a further raised portion. Advantageously, the further raised portion is adapted to reduce the pressure drop and swirl components in the internal chamber.

Preferably, the further raised portion is a protrusion which extends into the internal chamber.

Preferably, the further raised portion is located between the branch ports and opposite the tubular primary port.

Preferably, the or each branch port comprises a flange.

Preferably, the or each flange is a retaining arrangement for a seal.

Preferably, the or each flange is a seal-receiving body comprising a channel.

Preferably, the or each channel is adapted to receive and retain part of a sealing arrangement i.e. an o-ring.

Preferably, the or each channel has a predetermined depth suitable for receiving at least a retainable portion of the o-ring.

Preferably, the distance between the branch ports corresponds to the distance between the first connection conduit and second connection conduit of the fluid delivery arrangement.

Preferably, the branch ports are symmetrically located on either side of the primary port.

Preferably, the branch ports are equidistant from the primary port.

Preferably, the internal chamber comprises a main conduit portion.

Preferably, the internal chamber comprises two branch conduit portions.

Preferably, the internal chamber further comprises a flow partition portion and two corner connection portions.

Preferably, the flow partition portion provides a fluid communication path between the main conduit portion and the or each corner connection portion.

Preferably, the or each cornering portion provides a fluid communication path between the flow partition portion and a branch conduit portion.

Preferably, the main conduit portion comprises a narrowed portion.

Preferably, the position of the flow partition portion corresponds to the position of the raised portion of the second body member and the principal raised portion of the first body member.

Preferably, in use, the multiport fluid connector is adapted to connect the fluid distribution arrangement to a source of thermal management fluid.

Advantageously, fluid can flow in either direction through the multiport fluid connector.

Optionally, in use, fluid may flow into the multiport fluid connector via the primary port, into the main conduit portion, through the flow partition portion, each corner connection portion and each branch conduit portion, and out of the multiport fluid connector via the branch ports.

Optionally, in use, fluid may flow into the multiport fluid connector via one or both branch ports, through each branch conduit portion, through each corner connection portion and the flow partition portion and the main conduit portion, and out of the multiport fluid connector via the primary port.

According to a further aspect of the invention there is provided a sealing means for providing a fluid-tight seal in a battery pack, the sealing means comprising a deformable annular body comprising first and second elongate side portions, wherein the sealing means is locatable between two retaining means in a battery pack. Advantageously, the sealing means is able to seal joins between neighbouring first and/or second connection conduits/header tanks within the battery pack.

According to a further aspect of the invention there is provided a sealing means for providing a seal between fluid conduits in a battery pack or battery module, the sealing means comprising a deformable body, the deformable body comprising a central portion located between two retainable portions, wherein in use the retainable portions are locatable in retainment channels and wherein in the deformed state the central portion has an increased width. Advantageously, the sealing means is able to accommodate position tolerances between the respective ends of the conduits of first and/or second connection conduits/header tanks within the battery pack.

According to a further aspect of the invention there is provided a battery pack comprising a sealing means.

Preferably, the sealing means is for providing a seal between fluid conduits in a battery pack.

Preferably, the sealing means is an o-ring.

Preferably, the sealing means comprises a deformable body.

Preferably, the sealing means comprises soft silicone or other suitable resilient material.

Preferably, the sealing means comprises rubber.

Preferably, the sealing means has a unitary body.

Preferably, the sealing means has a shore A hardness of less than 50.

Preferably, the sealing means has a shore A hardness greater than 15.

Preferably, the sealing means has a shore A hardness of between 30 and 40.

Preferably, the sealing means has a shore A hardness of between 33 and 37.

Preferably, the sealing means has a shore A hardness of 35.

Ideally, the sealing means is annular.

Preferably, the body comprises a central portion.

Preferably, the cross-sectional shape of the body comprises a central portion located between first and second retainable portions.

Preferably, the body comprises two retainable portions.

Preferably, the cross-sectional shape of the body comprises a central portion located between first and second retainable portions.

Preferably, the retainable portions protrude from the central portion.

Preferably, the retainable portions protrude from opposing sides of the central portion.

Preferably, the body comprises two elongate retainable portions.

Preferably, the cross-sectional shape of each retainable portion comprises first and second substantially straight edge portions.

Preferably, the first and second substantially straight edge portions are joined by a curved edge portion.

Preferably, the first and second substantially straight edge portions are joined by a semicircular edge portion.

Preferably, the central portion is located between two retainable portions.

Preferably, the central portion is wider than the retainable portions.

Preferably, the cross-sectional width of the central portion is greater than the cross-sectional width of each retainable portion.

Preferably, the central portion comprises first and second curved edge portions.

Preferably, the central portion comprises first and second semicircular edge portions.

Preferably, the maximum distance between the first and second substantially straight edge portions of each retainable portion is less than the maximum distance between the first and second curved edge portions of the central portion.

Preferably, the retainable portions are adapted to be located and retained within a retaining means.

Preferably, the retainable portions are adapted to be located and retained within the channels in the flanges of the fluid delivery means.

Preferably, the sealing means is substantially rectangular.

Preferably, the sealing means comprises a deformable annular body.

Preferably, the sealing means comprises first and second elongate side portions.

Preferably, the first and second elongate side portions are substantially straight.

Preferably, the first and second elongate side portions are substantially parallel.

Preferably, the first and second elongate side portions are of equal length.

Preferably, the body comprises first and second shortened side portions.

Preferably, the first and second shortened side portions are substantially straight.

Preferably, the first and second shortened side portions are substantially parallel.

Preferably, the first and second shortened side portions are of equal length.

Preferably, the seal means comprises one or more curved portions.

Preferably, the ends of neighbouring side portions are joined by at least one curved portion.

Preferably, the first and second elongate side portions are longer than the first and second shortened side portions.

Preferably, the sealing means comprises four substantially straight side portions.

Preferably, each side portion is joined to a neighbouring side portion by a corner section.

Preferably, the sealing means comprises two elongate side portions and two shortened side portions.

Preferably, the sealing means has an undeformed state.

Preferably, in the undeformed state the cross-sectional width of the central portion is less than 10 mm.

Preferably, in the undeformed state the cross-sectional width of the central portion is 2.8 mm.

Preferably, in the undeformed state the cross-sectional width of each retainable portion is less than 10 mm.

Preferably, in the undeformed state the cross-sectional width of each retainable portion is 1.8 mm.

Preferably, in the undeformed state the cross-sectional height of the sealing means is 18 mm.

Preferably, the sealing means has a deformed state.

Ideally, the sealing means enters the deformed state when it is located within and squeezed between two channels of neighboring fluid delivery means.

Preferably, in the deformed state the cross-sectional width of the central portion is greater than 2.8 mm.

Preferably, in the deformed state the cross-sectional width of the central portion is 4.4 mm.

Preferably, in the deformed state the cross-sectional width of each retainable portion is 1.8 mm.

Preferably, in the deformed state the cross-sectional height of the sealing means is less than 18 mm.

Preferably, in the deformed state the cross-sectional height of the sealing means is 14.4 mm.

Preferably, in the deformed state the central portion has an increased cross-sectional width. Advantageously, the increased width of the central portion in the deformed state allows the sealing member to accommodate any slight differences in size/dimensions of the respective channels/flanges of the fluid delivery means between which the sealing member is retained.

Preferably, the width of the central portion in the deformed state is greater than the width of the central portion in the undeformed state.

Preferably, the width of the retainable portions in the deformed stated is substantially the same as the width of the retainable portions in the undeformed state.

According to a further aspect of the invention there is provided a method of manufacturing a battery pack, the method comprising forming one or more the battery modules, forming a battery module sub-assembly, installing the battery module sub-assembly in a battery pack housing and sealing the battery pack housing. Advantageously, the battery pack may be used to provide power in an industrial apparatus.

According to a further aspect of the invention there is provided a method of manufacturing a battery pack, the method comprising locating one or more battery modules in a battery pack housing. Advantageously, the housing provides added protection, and a suitable containment means for the battery modules which form the battery pack.

Preferably the method comprises forming one or more the battery modules.

Preferably the method comprises choosing an appropriate number of cells

Preferably the method comprises forming an array of cells.

Preferably the method comprises providing a thermal management means and/or an electrical connection means.

Preferably the method comprises forming a battery module sub-assembly.

Preferably the step of forming the battery module sub-assembly comprises interconnecting two or more battery modules.

Preferably the method comprises providing mechanical, electrical and/or fluid connections between two or more battery modules.

Preferably the method comprises locating the battery module sub-assembly within the battery pack housing.

Preferably the method comprises sealing the battery pack housing.

Preferably the method comprises mounting the battery pack.

Preferably the method comprises mounting the battery pack to a chassis or other support structure.

Preferably the method comprises attaching the battery pack to a support structure via mounting arrangements.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which shows by way of example only embodiments of an apparatus in accordance with the invention.

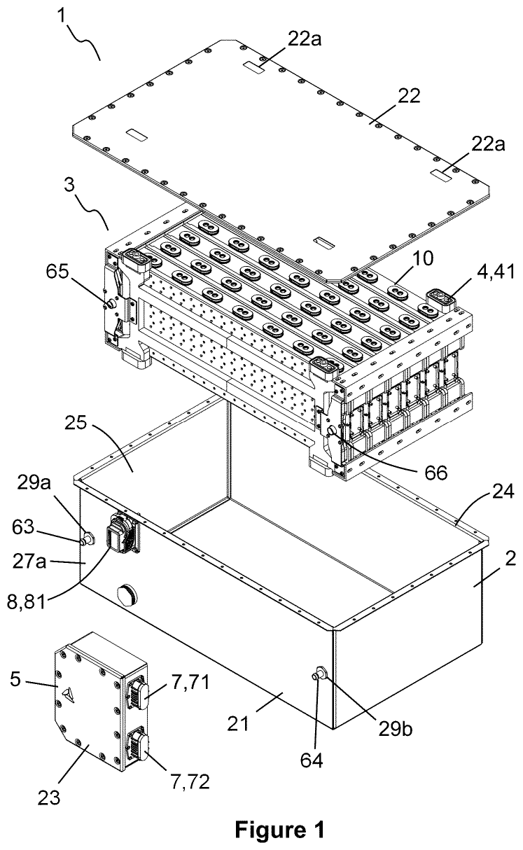

FIG. 1 is an exploded perspective view of a battery pack according to an aspect of the invention.

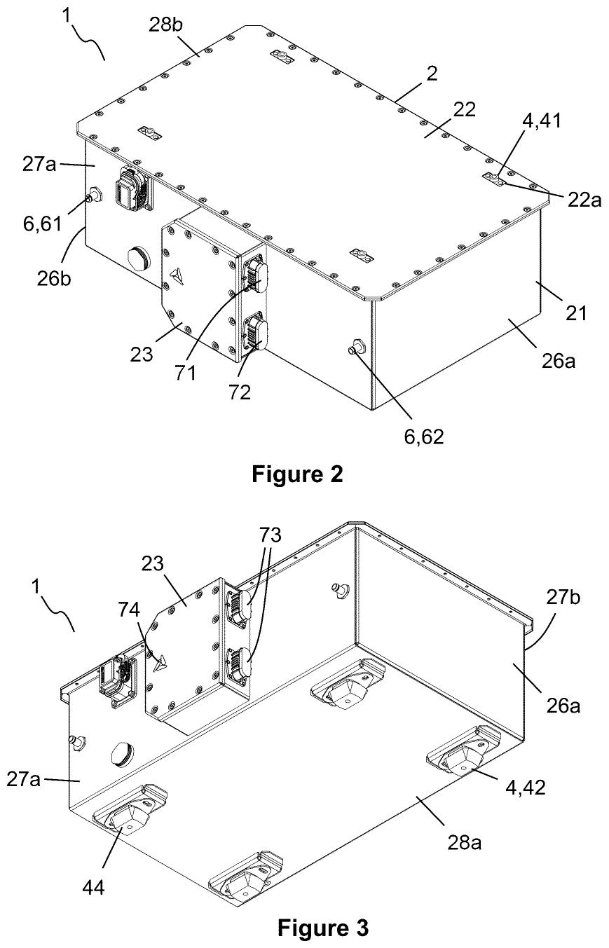

FIG. 2 is a perspective view of a battery pack according to an aspect of the invention.

FIG. 3 is a perspective view of a battery pack according to an aspect of the invention.

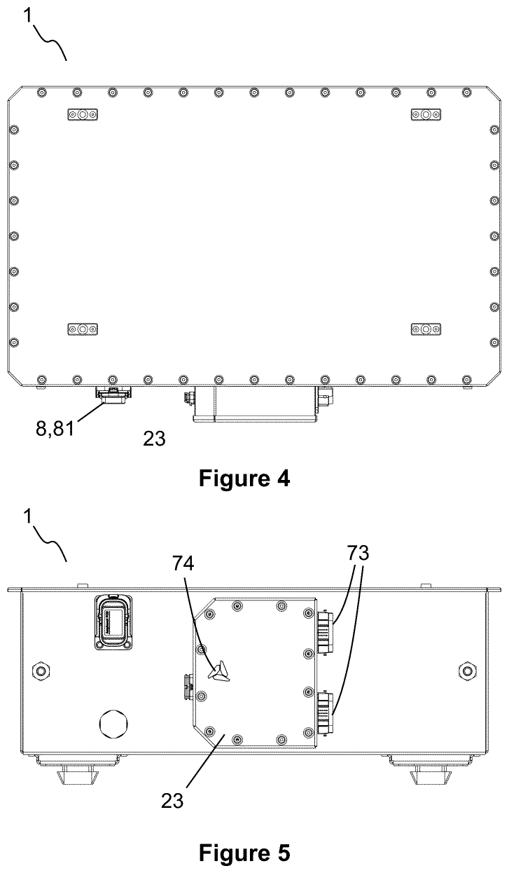

FIG. 4 is a top view of a battery pack according to an aspect of the invention.

FIG. 5 is an end view of a battery pack according to an aspect of the invention.

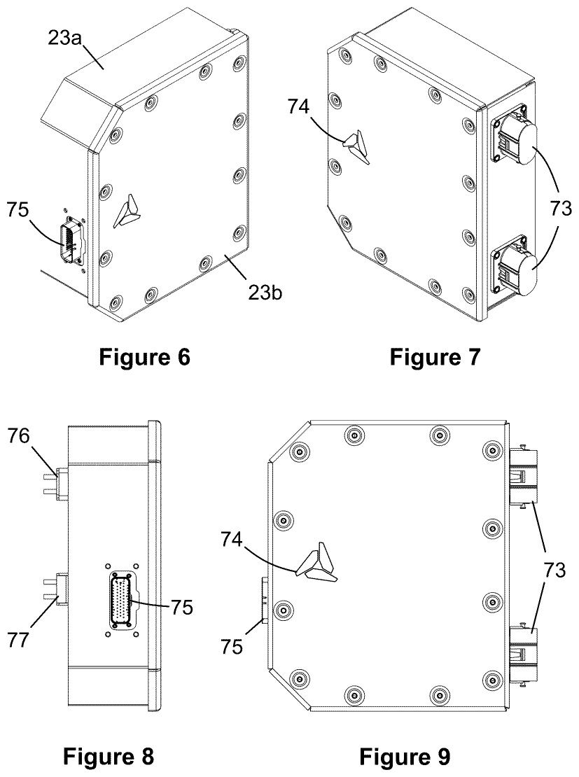

FIG. 6 is a perspective view of an end enclosure.

FIG. 7 is a perspective view of an end enclosure.

FIG. 8 is a side view of an end enclosure.

FIG. 9 is a top view of an end enclosure.

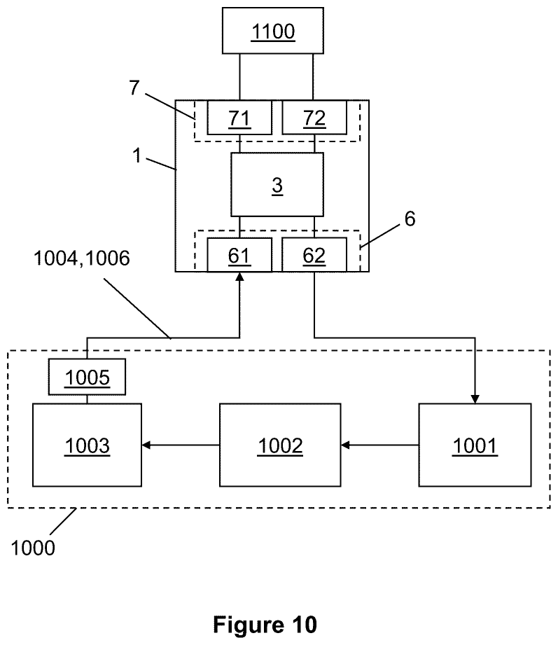

FIG. 10 is a schematic view of a battery pack according to an aspect of the invention, a load and a thermal management system.

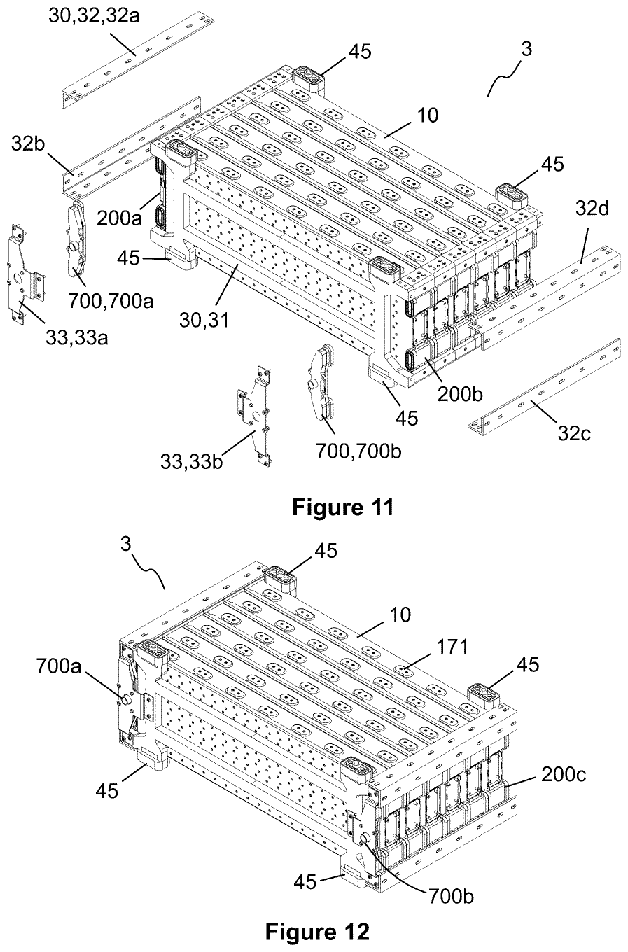

FIG. 11 is an exploded perspective view of a battery module sub assembly according to an aspect of the invention.

FIG. 12 is a perspective view of a battery module sub assembly according to an aspect of the invention.

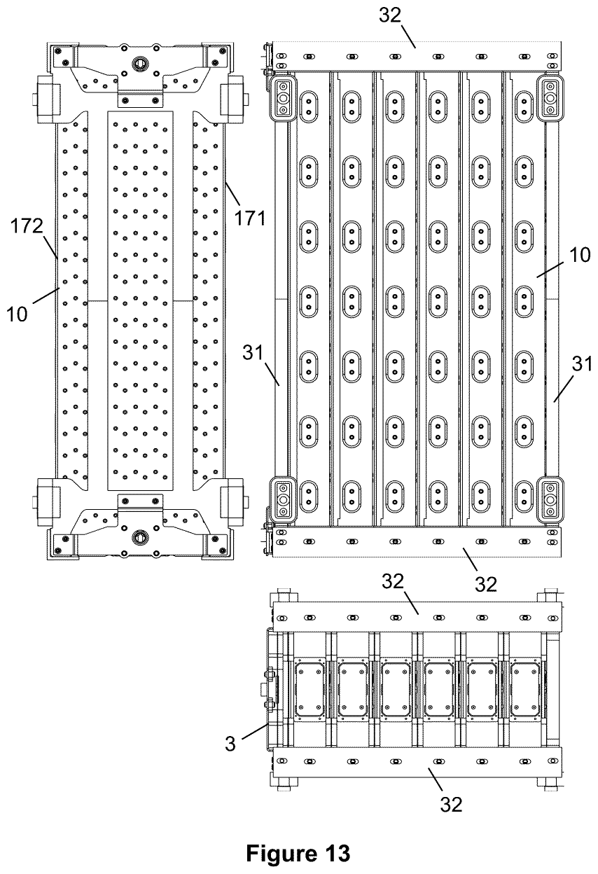

FIG. 13 shows top, side and end views of a battery module sub assembly according to an aspect of the invention.

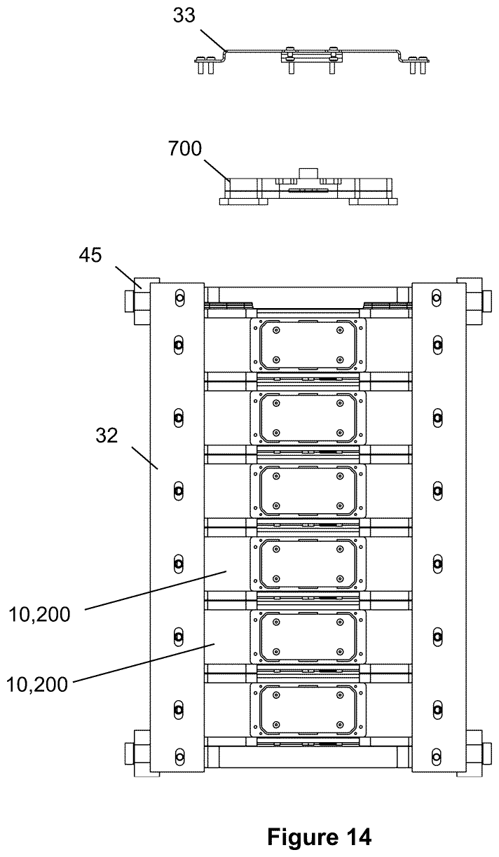

FIG. 14 is an end exploded view of a battery module sub assembly according to an aspect of the invention.

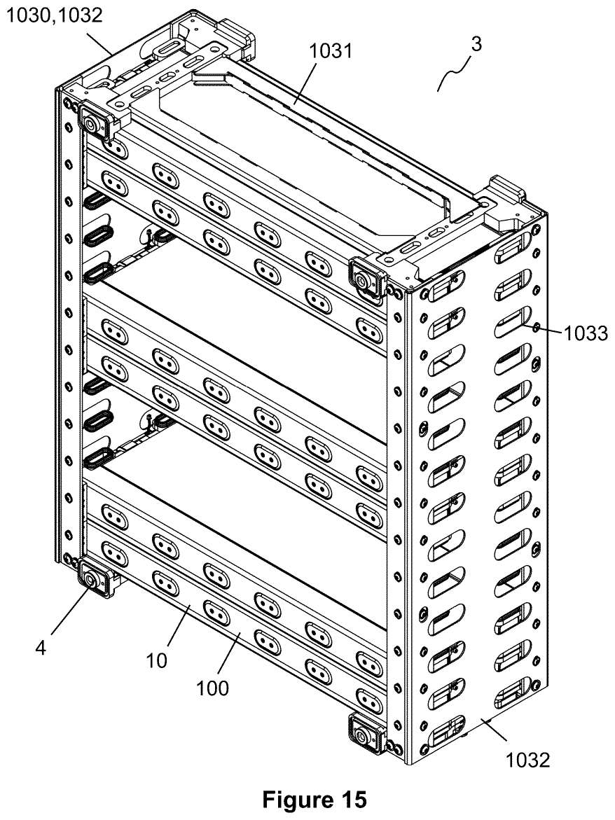

FIG. 15 is a perspective view of a battery module sub assembly according to an aspect of the invention.

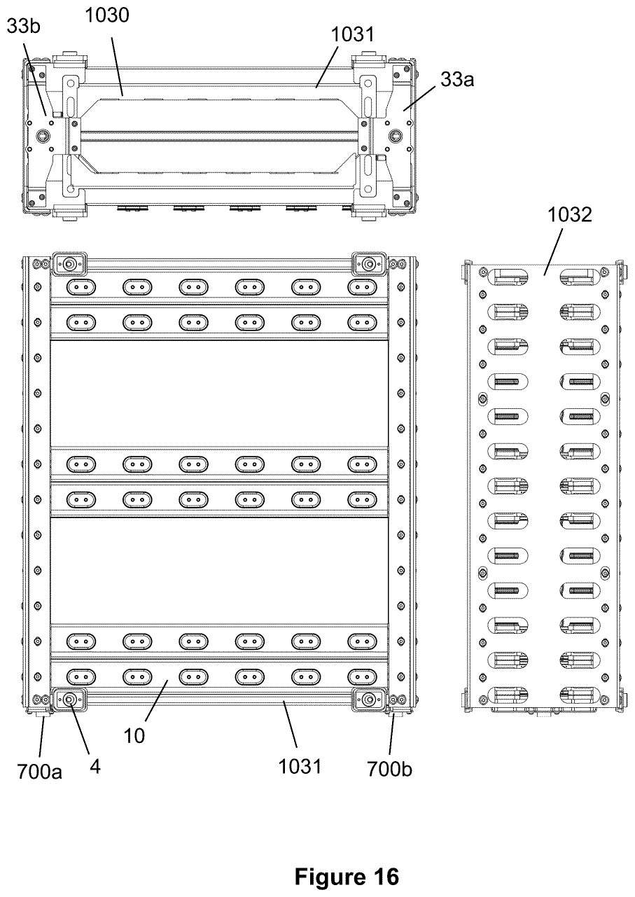

FIG. 16 shows top, side and end views of a battery module sub assembly according to an aspect of the invention.

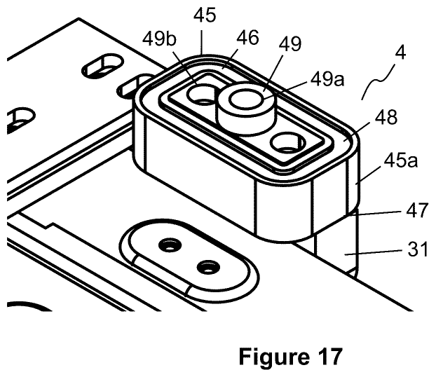

FIG. 17 is a perspective view of a mounting arrangement according to an aspect of the invention.

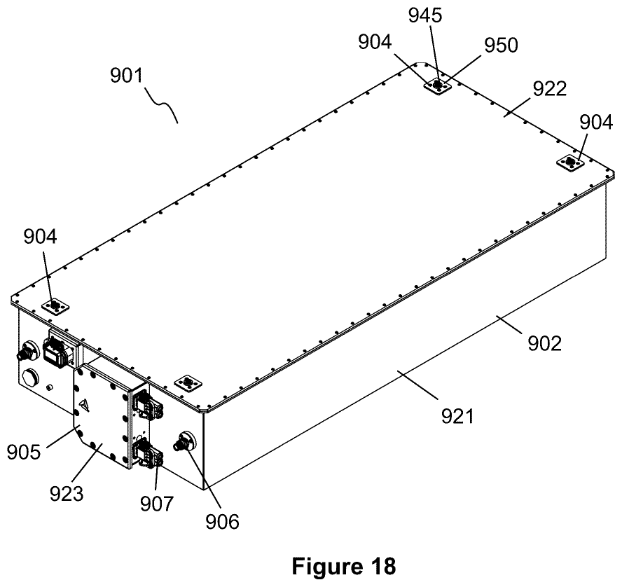

FIG. 18 is a perspective view of a battery pack according to an aspect of the invention.

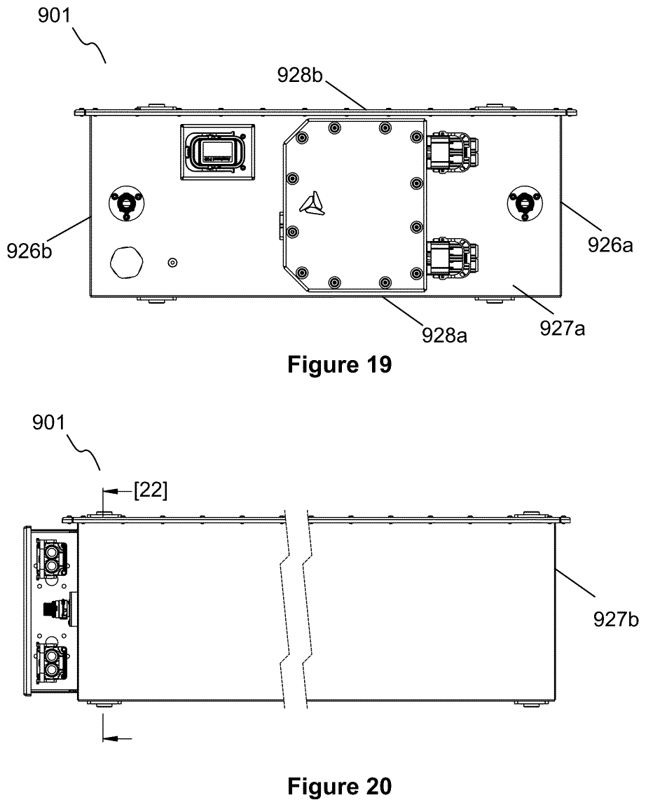

FIG. 19 is an end view of a battery pack according to an aspect of the invention.

FIG. 20 is a side view of a battery pack according to an aspect of the invention.

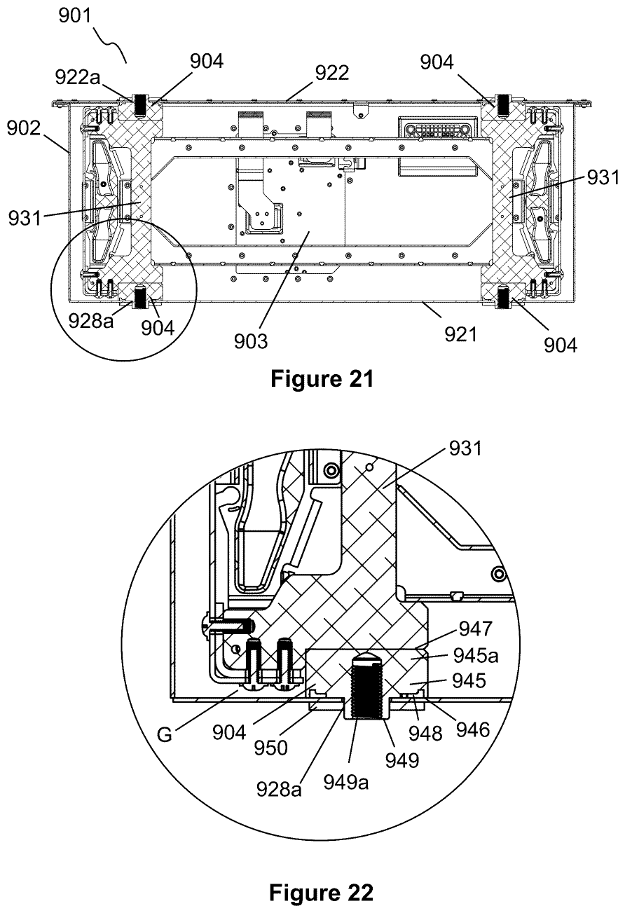

FIG. 21 is a cross-sectional view of a battery pack according to an aspect of the invention.

FIG. 22 is a cross-sectional detail view of a battery pack according to an aspect of the invention.

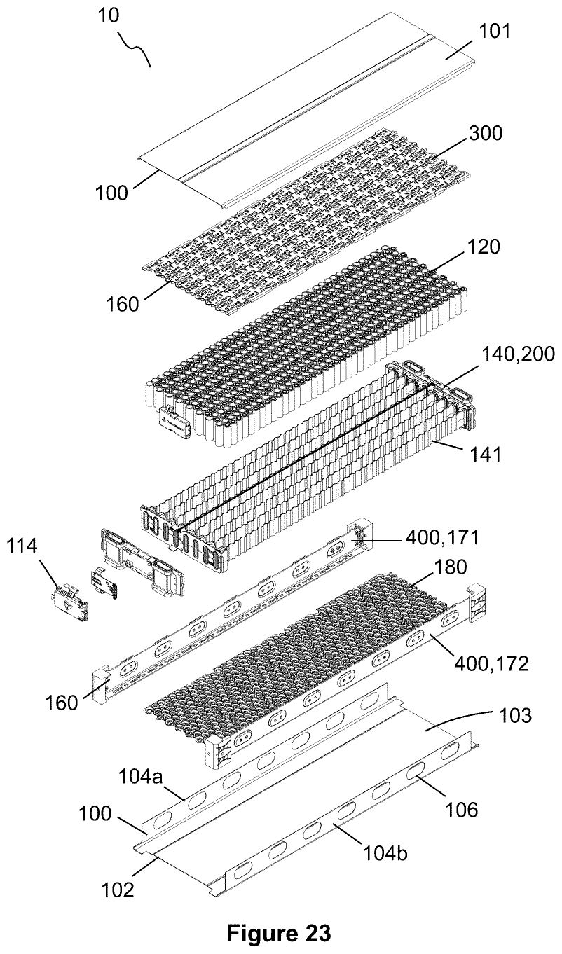

FIG. 23 is an exploded perspective view of a battery module according to an aspect of the invention.

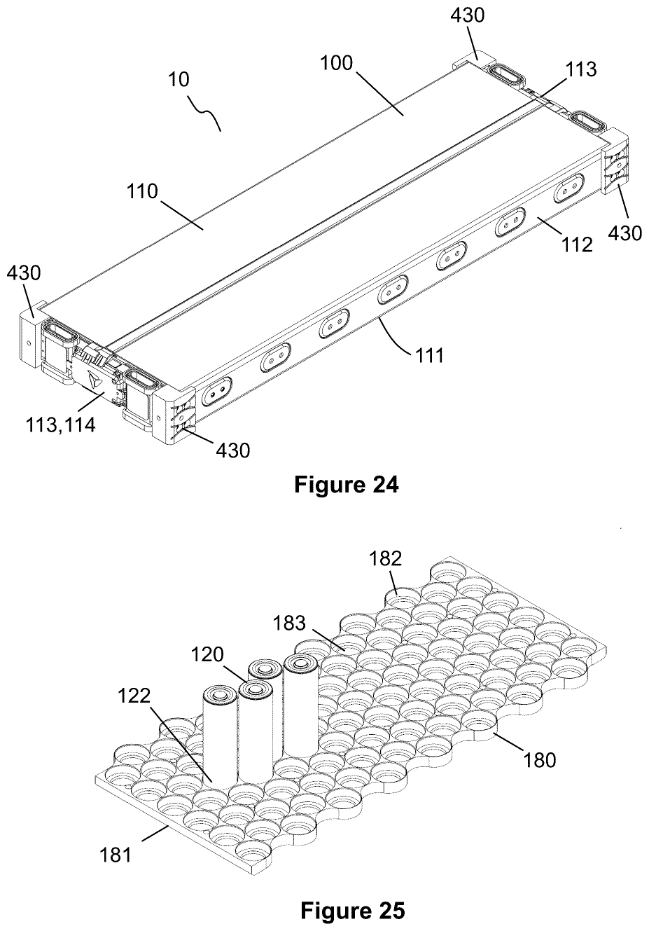

FIG. 24 is a perspective view of a battery module according to an aspect of the invention.

FIG. 25 is a perspective view of a cell arrangement member and a plurality of cells.

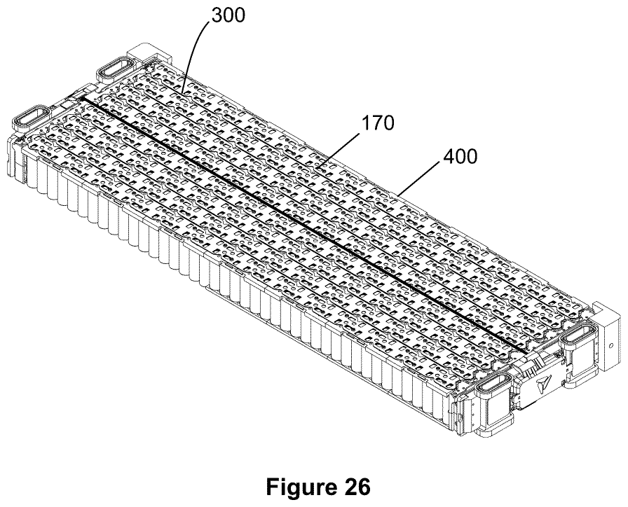

FIG. 26 is a perspective cutaway view of a battery module according to an aspect of the invention.

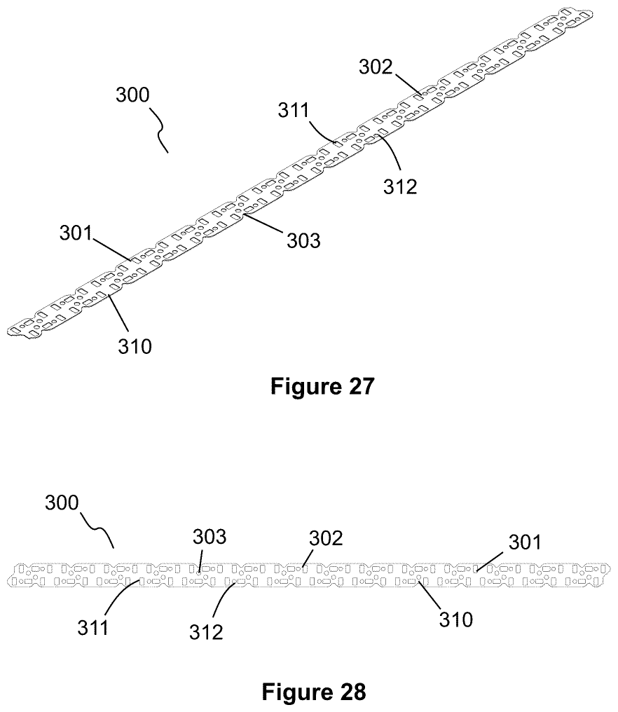

FIG. 27 is a perspective view of a busbar.

FIG. 28 is a top view of a busbar.

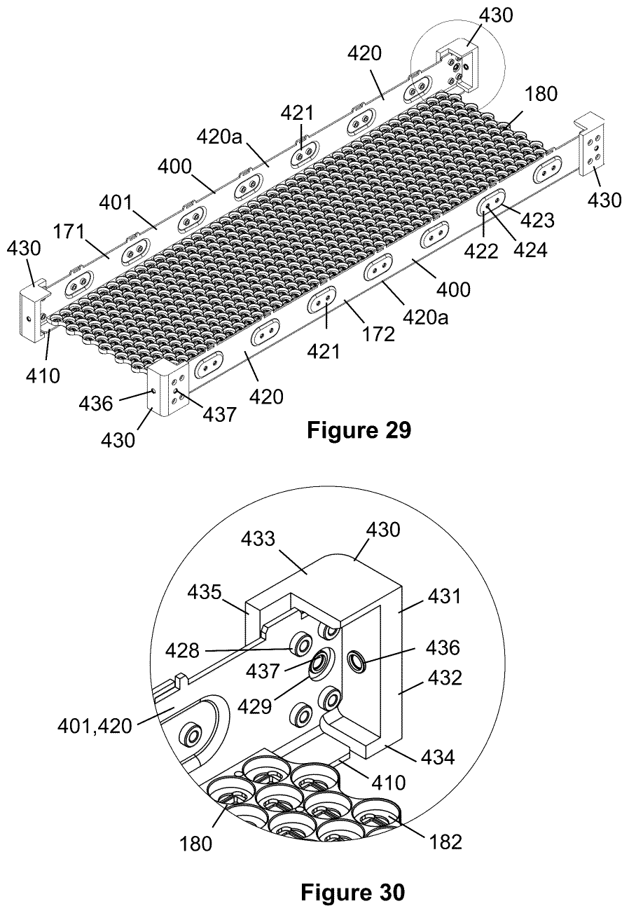

FIG. 29 is a perspective view of a cell arrangement member and two busbars according to an aspect of the invention.

FIG. 30 is a perspective detail view of a cell arrangement member and two busbars according to an aspect of the invention.

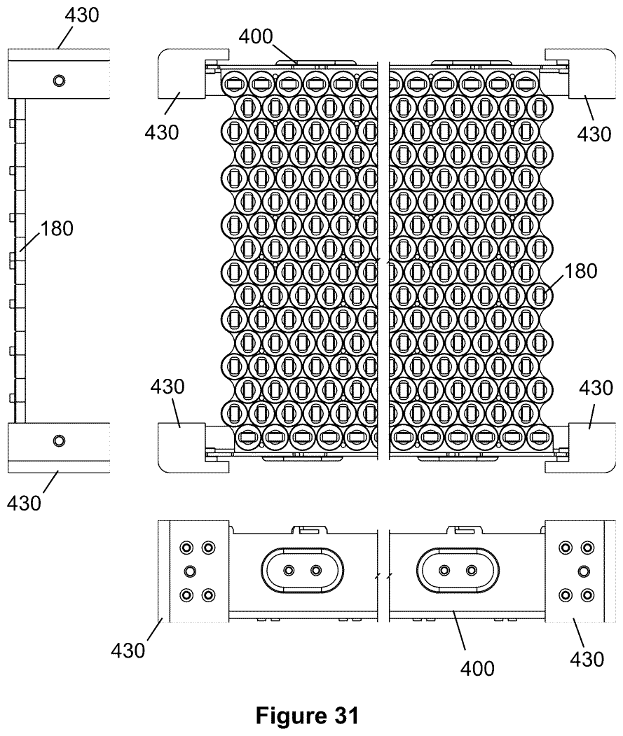

FIG. 31 shows top, side and end views of a cell arrangement member and two busbars according to an aspect of the invention.

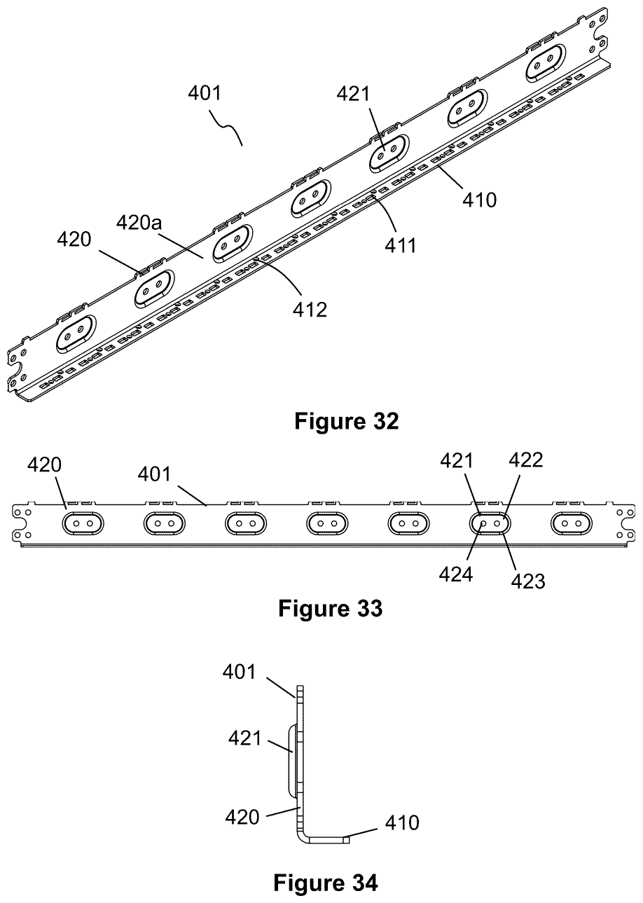

FIG. 32 is a perspective view of part of a busbar according to an aspect of the invention.

FIG. 33 is a side view of part of a busbar according to an aspect of the invention.

FIG. 34 is an end view of part of a busbar according to an aspect of the invention.

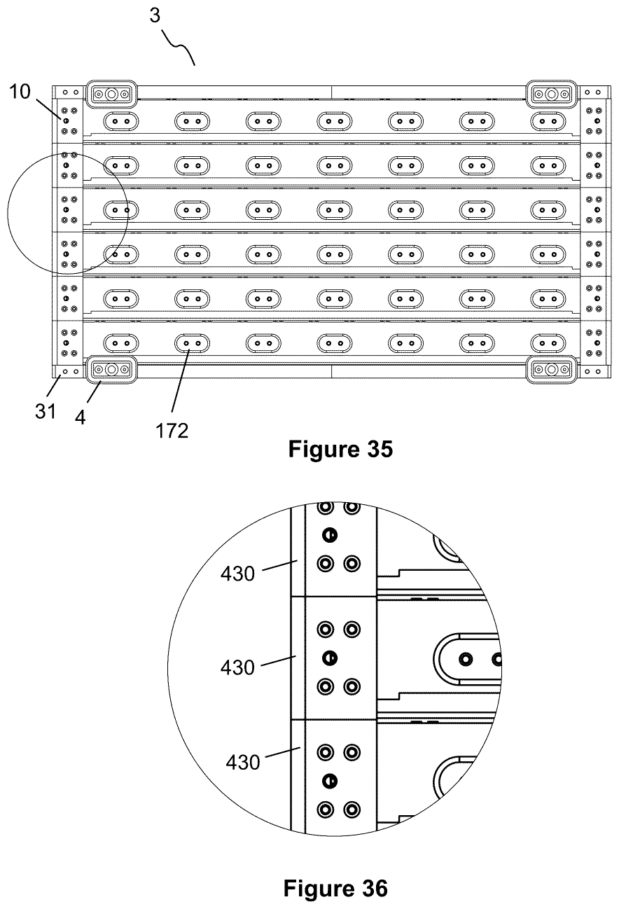

FIG. 35 is a side view of a battery module sub assembly according to an aspect of the invention.

FIG. 36 is a side detail view of a battery module sub assembly according to an aspect of the invention.

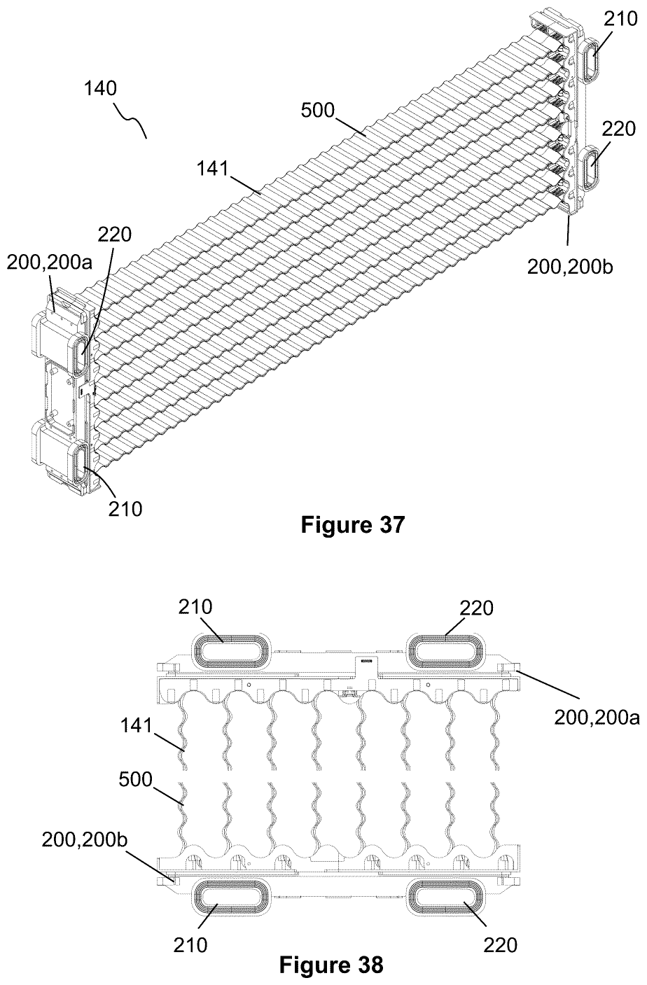

FIG. 37 is a perspective view of a thermal management arrangement according to an aspect of the invention.

FIG. 38 is a top view of a thermal management arrangement according to an aspect of the invention.

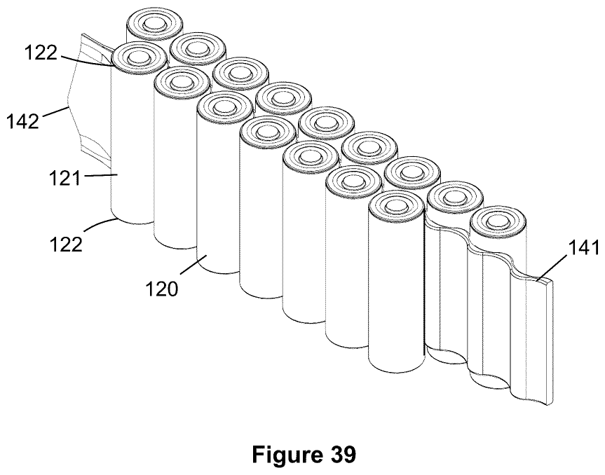

FIG. 39 is a perspective view of a duct and a plurality of cells.

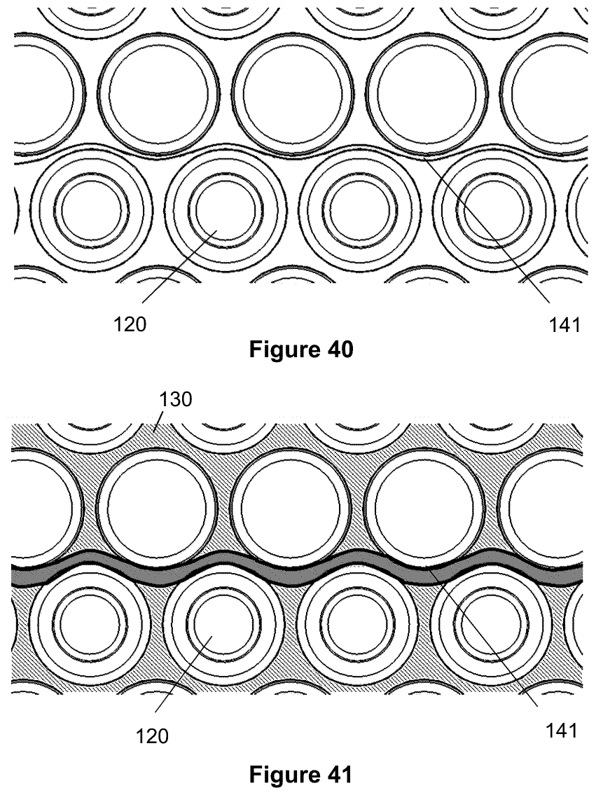

FIG. 40 is a top view of a duct and a plurality of cells.

FIG. 41 is a top view of a duct, a potting material and a plurality of cells.

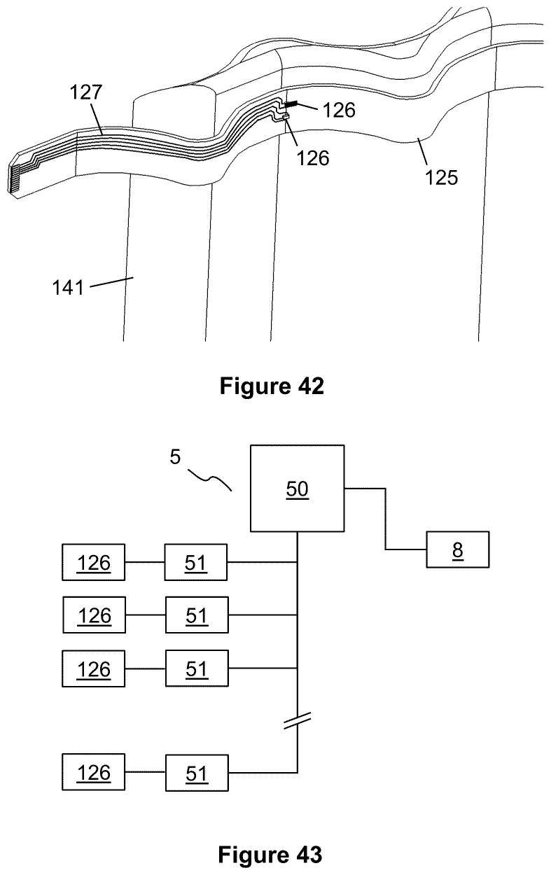

FIG. 42 is a perspective view of a duct and a flexible carrier.

FIG. 43 is a schematic view of a battery management system.

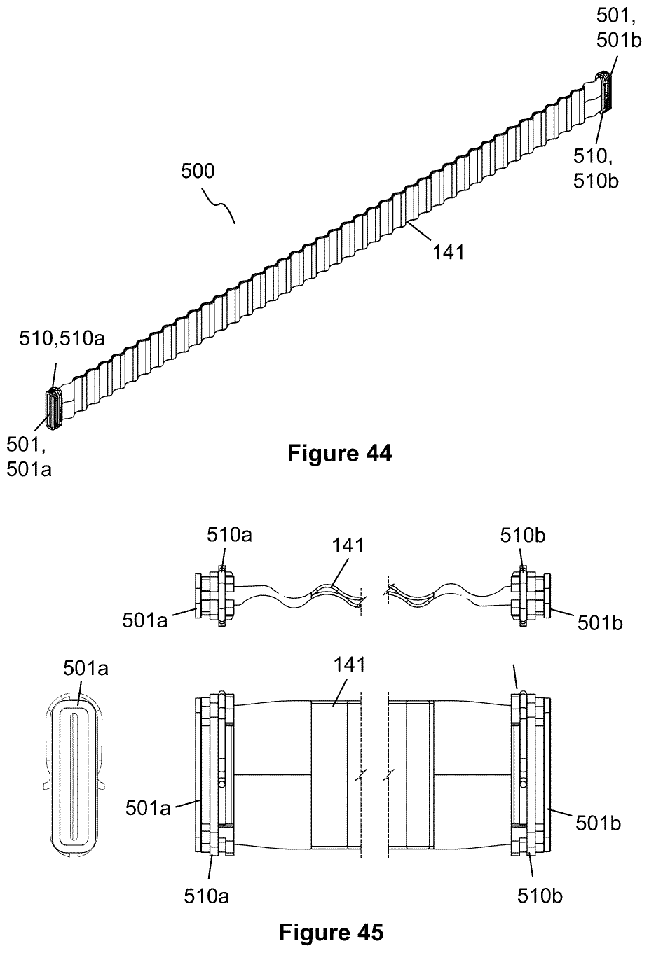

FIG. 44 is a perspective view of a duct assembly according to an aspect of the invention.

FIG. 45 shows top, side and end views of a duct assembly according to an aspect of the invention.

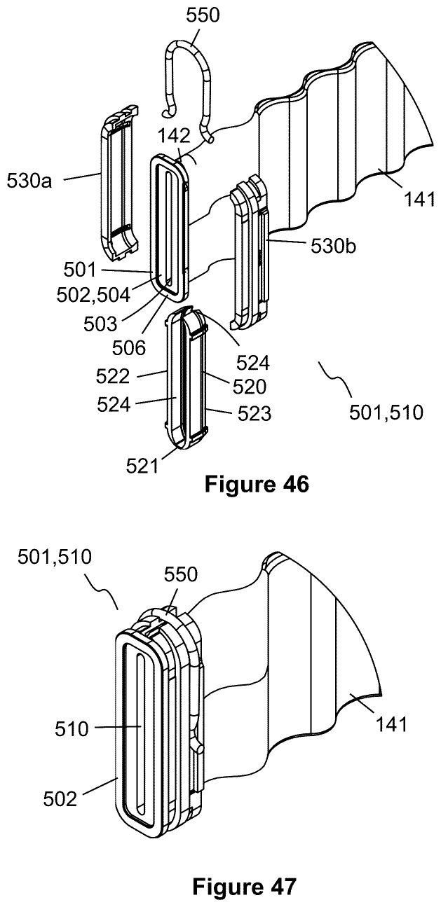

FIG. 46 is an exploded perspective view of part of a duct assembly according to an aspect of the invention.

FIG. 47 is a perspective view of part of a duct assembly according to an aspect of the invention.

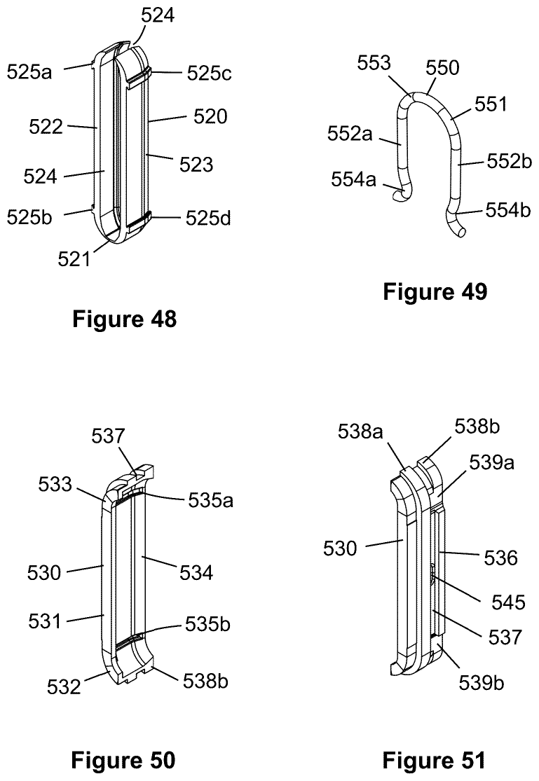

FIG. 48 is a perspective view of a bearing member.

FIG. 49 is a perspective view of a biasing member.

FIG. 50 is a perspective view of a securement member.

FIG. 51 is a perspective view of a securement member.

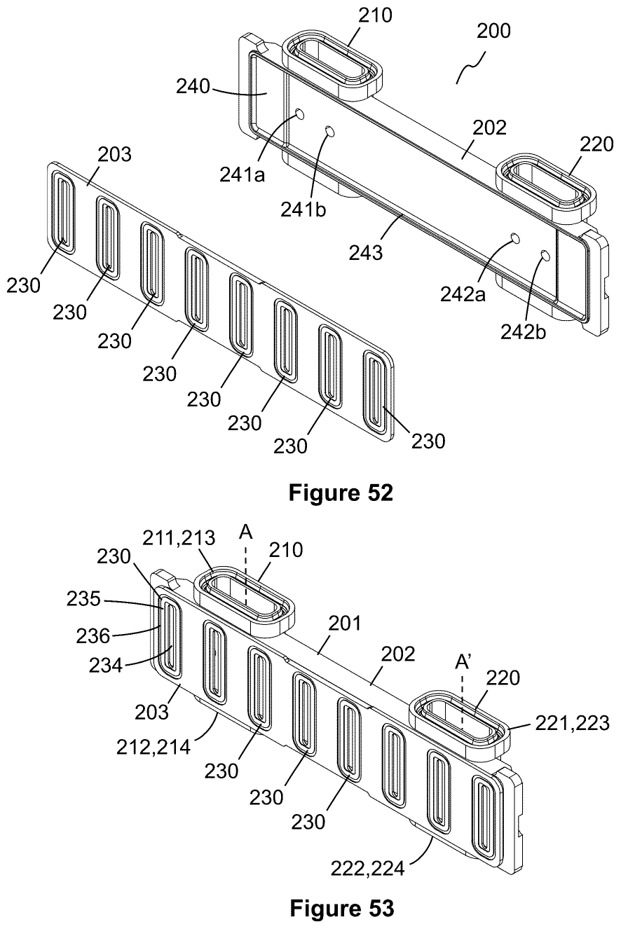

FIG. 52 is an exploded perspective view of a fluid delivery arrangement according to an aspect of the invention.

FIG. 53 is a perspective view of a fluid delivery arrangement according to an aspect of the invention.

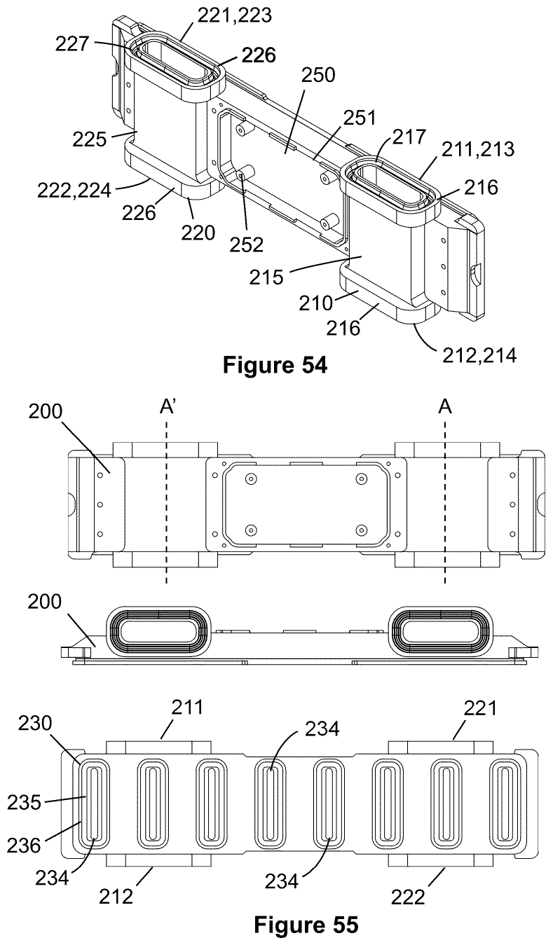

FIG. 54 is a perspective view of a fluid delivery arrangement according to an aspect of the invention.

FIG. 55 shows front, top and rear views of a fluid delivery arrangement according to an aspect of the invention.

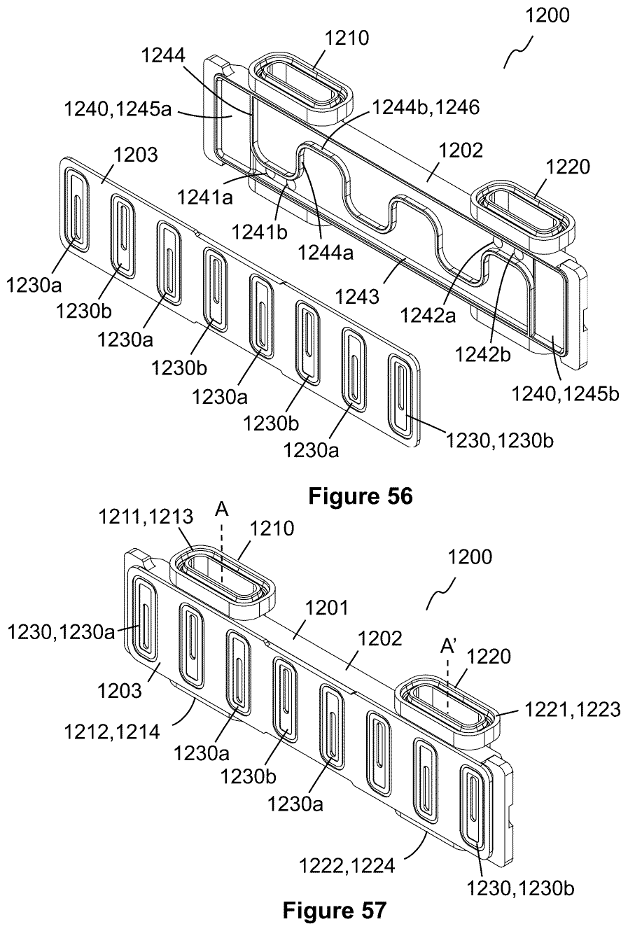

FIG. 56 is an exploded perspective view of a fluid delivery arrangement according to an aspect of the invention.

FIG. 57 is a perspective view of a fluid delivery arrangement according to an aspect of the invention.

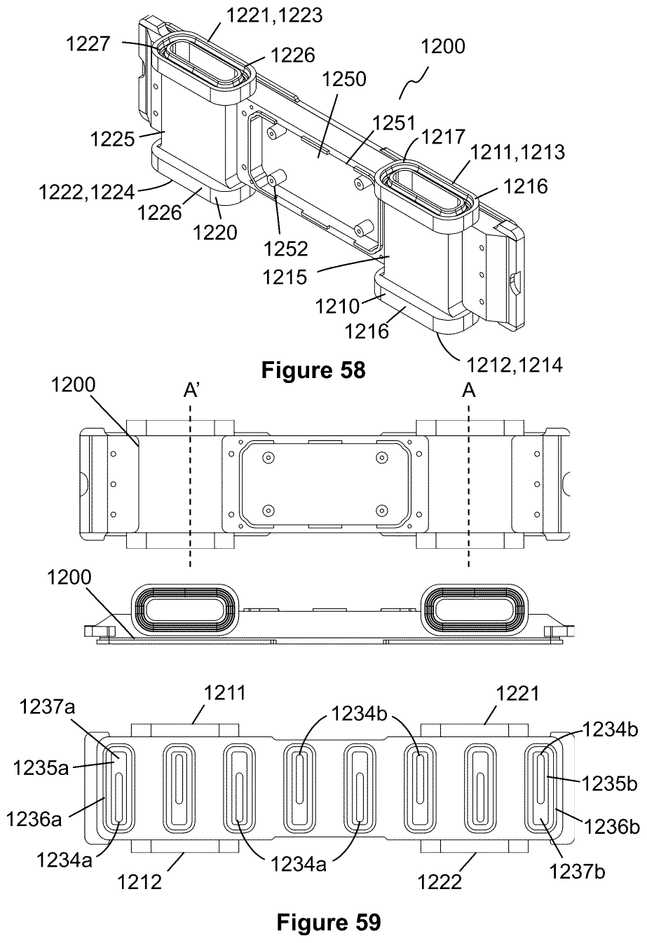

FIG. 58 is a perspective view of a fluid delivery arrangement according to an aspect of the invention.

FIG. 59 shows front, top and rear views of a fluid delivery arrangement according to an aspect of the invention.

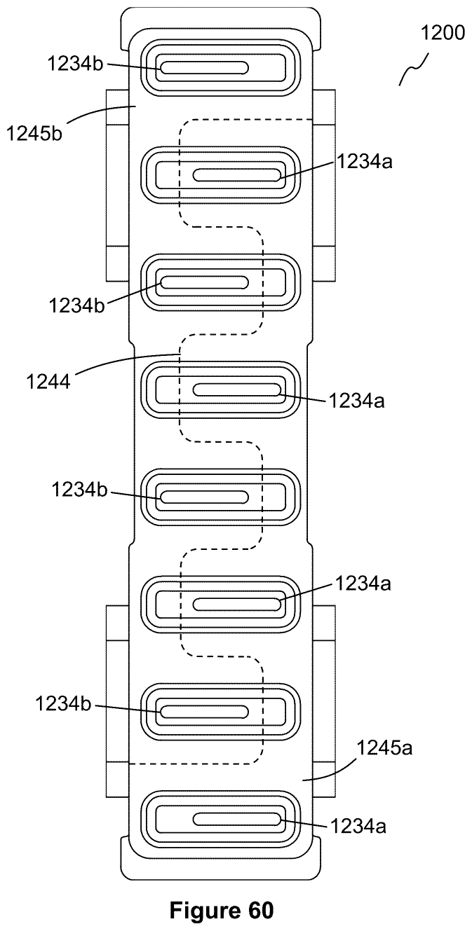

FIG. 60 is a rear view of a fluid delivery arrangement according to an aspect of the invention.

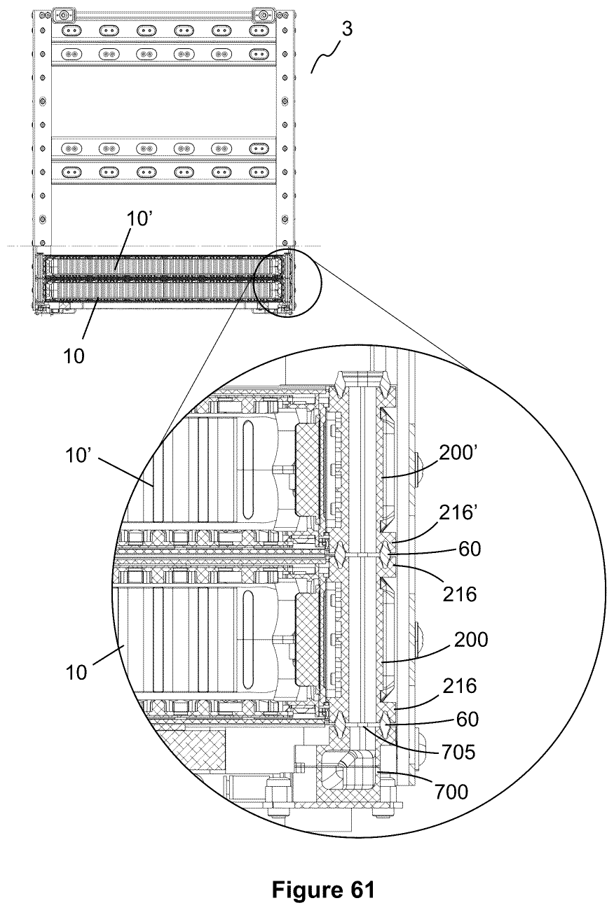

FIG. 61 is a side view and side detail cross-sectional view of a battery module sub assembly according to an aspect of the invention.

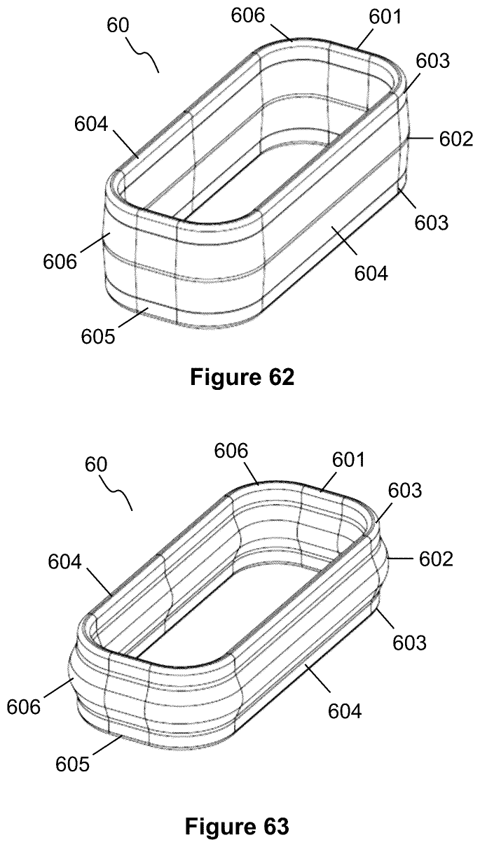

FIG. 62 is a perspective view of a seal according to an aspect of the invention.

FIG. 63 is a perspective view of a seal according to an aspect of the invention.

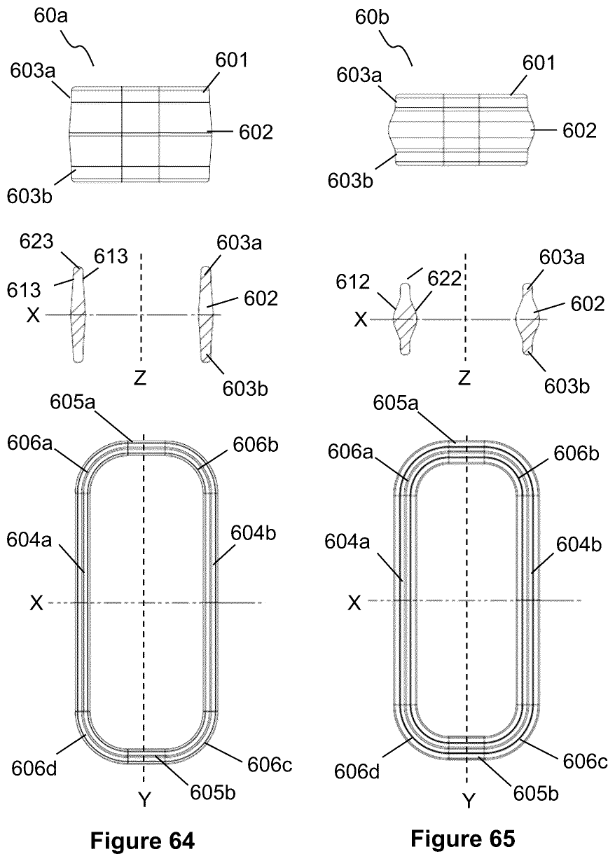

FIG. 64 shows side, cross sectional and top views of a seal according to an aspect of the invention.

FIG. 65 shows side, cross sectional and top views of a seal according to an aspect of the invention.

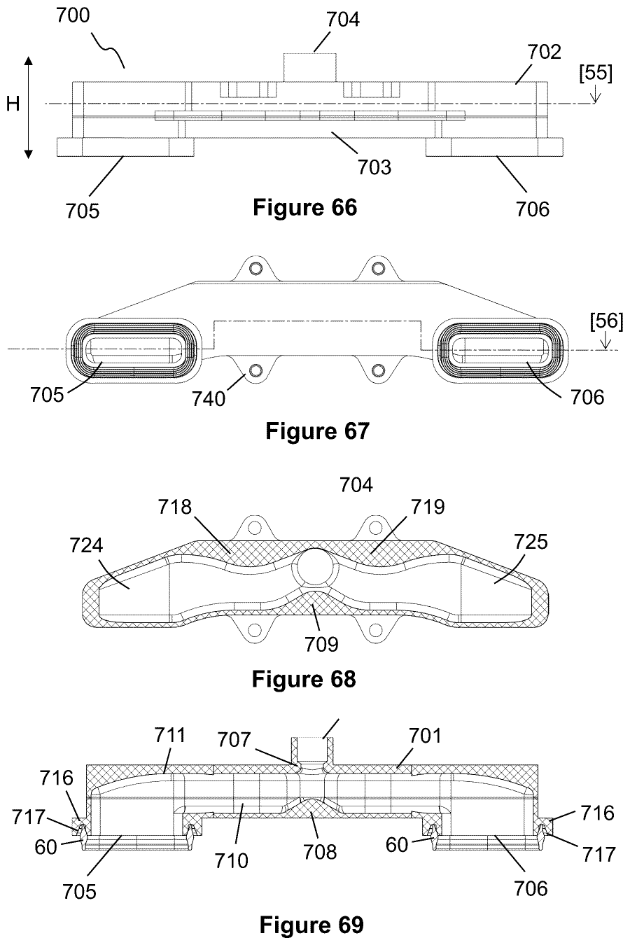

FIG. 66 is a side view of a multiport fluid connector according to an aspect of the invention.

FIG. 67 is a bottom view of a multiport fluid connector according to an aspect of the invention.

FIG. 68 is a cross sectional view of a multiport fluid connector according to an aspect of the invention.

FIG. 69 is a cross sectional view of a multiport fluid connector according to an aspect of the invention.

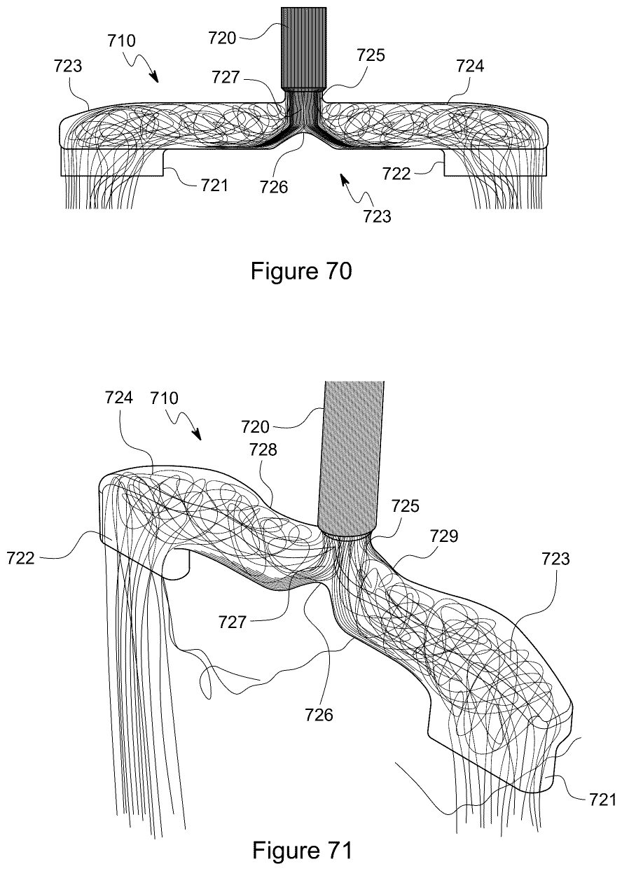

FIG. 70 is a side view of an internal chamber of a multiport fluid connector according to an aspect of the invention.

FIG. 71 is a perspective view of an internal chamber of a multiport fluid connector according to an aspect of the invention.

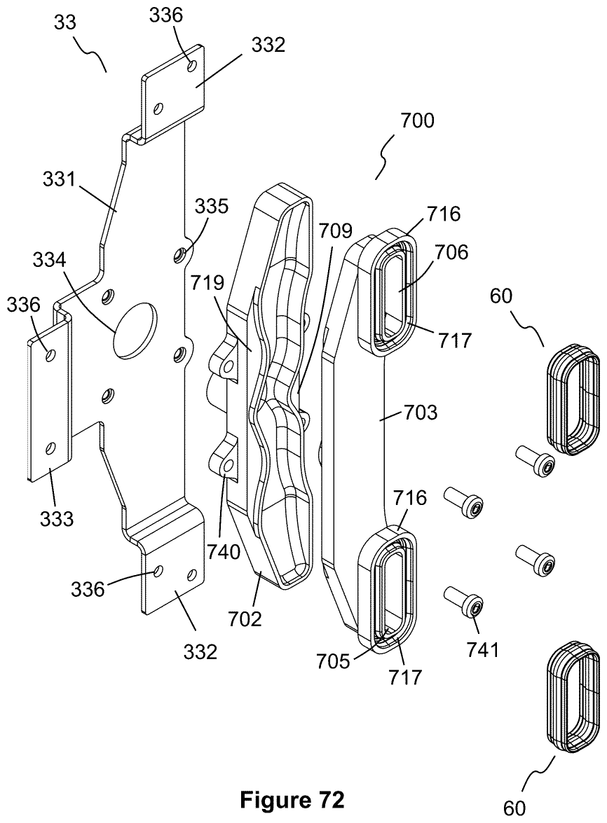

FIG. 72 is an exploded perspective view of a multiport fluid connector according to an aspect of the invention, seals according to an aspect of the invention, and a holding plate.

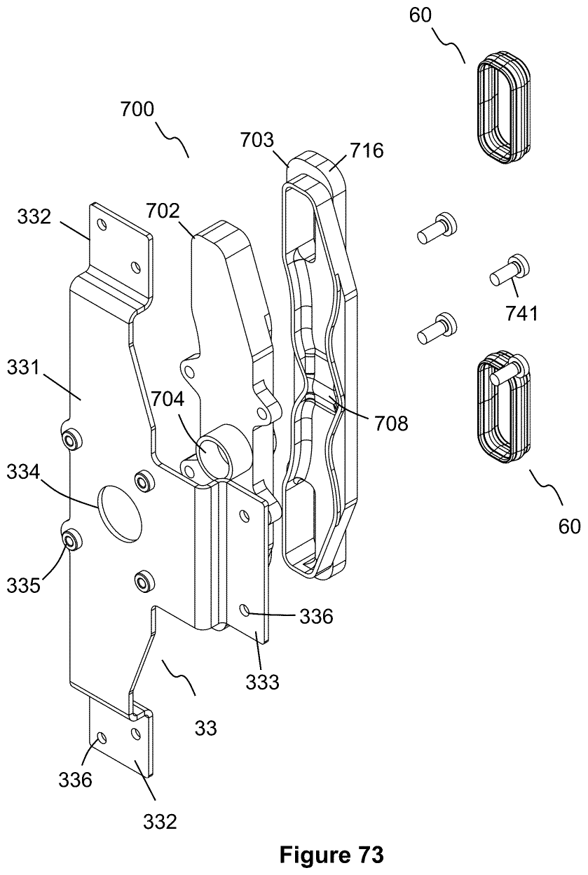

FIG. 73 is an exploded perspective view of a multiport fluid connector according to an aspect of the invention, seals according to an aspect of the invention, and a holding plate.

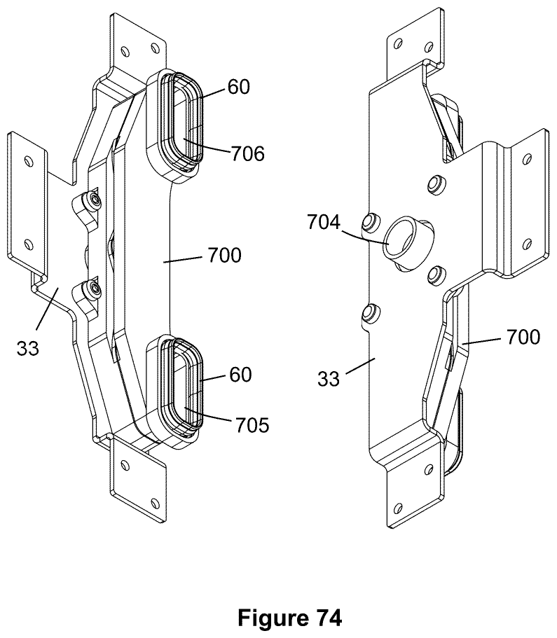

FIG. 74 shows perspective views of a multiport fluid connector according to an aspect of the invention, seals according to an aspect of the invention, and a holding plate.

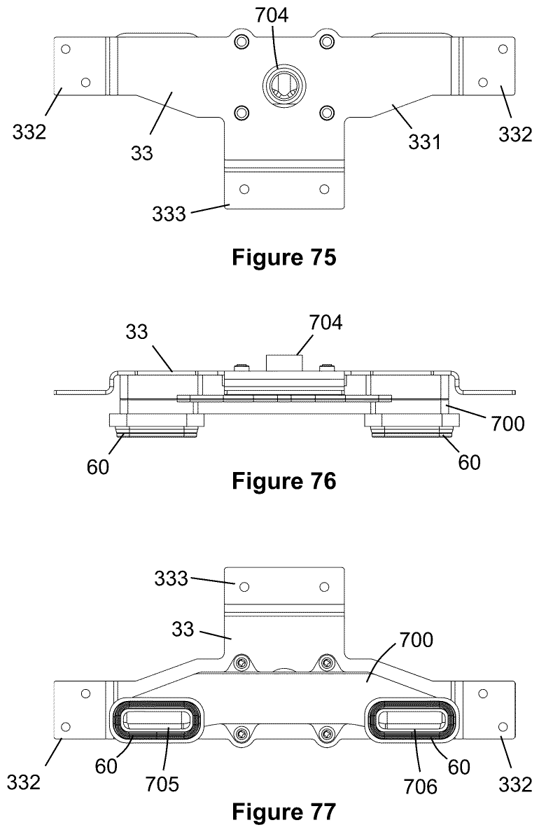

FIG. 75 is a top view of a multiport fluid connector according to an aspect of the invention, seals according to an aspect of the invention, and a holding plate.

FIG. 76 is a side view of a multiport fluid connector according to an aspect of the invention, seals according to an aspect of the invention, and a holding plate.

FIG. 77 is a bottom view of a multiport fluid connector according to an aspect of the invention, seals according to an aspect of the invention, and a holding plate.

FIG. 78 is a rear view of a fluid delivery arrangement according to an aspect of the invention.

FIG. 79 is a top view of a fluid delivery arrangement according to an aspect of the invention.

FIG. 80 is a front view of a fluid delivery arrangement according to an aspect of the invention.

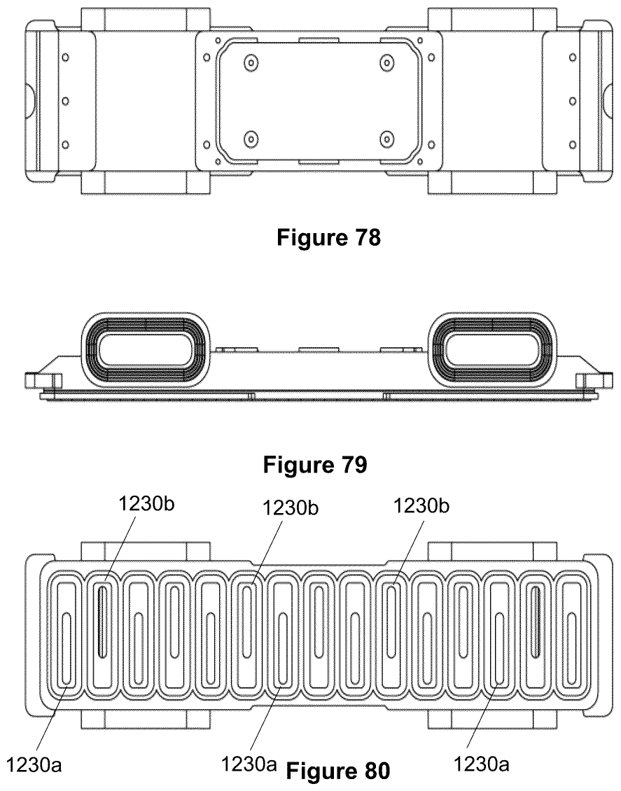

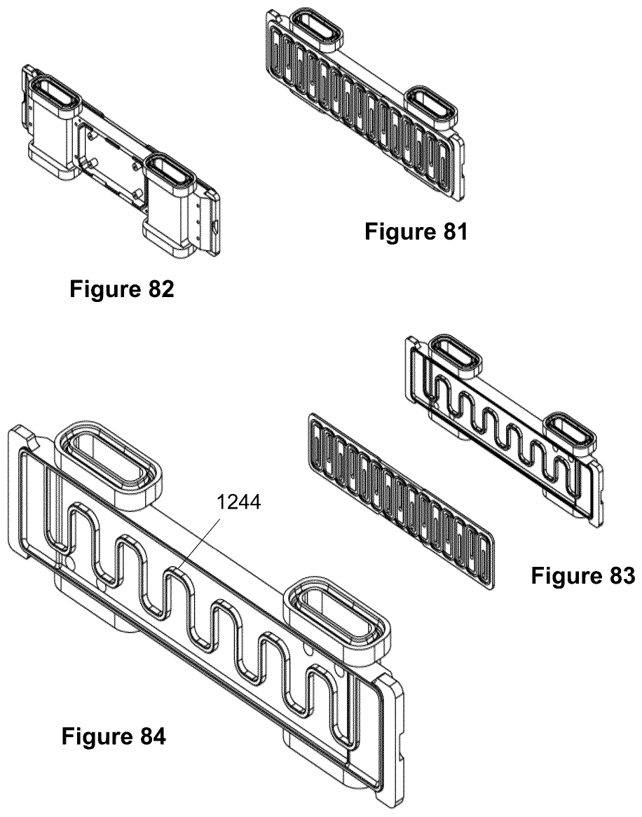

FIG. 81 front perspective view of the fluid delivery arrangement of FIGS. 78 to 80 according to an aspect of the invention.

FIG. 82 is a rear perspective view of a fluid delivery arrangement of FIGS. 78 to 81 according to an aspect of the invention.

FIG. 83 is a perspective exploded view of a fluid delivery arrangement of FIGS. 78 to 82 according to an aspect of the invention.

FIG. 84 is an enlarged perspective front view of a fluid delivery arrangement of FIGS. 78 to 83 according to an aspect of the invention.

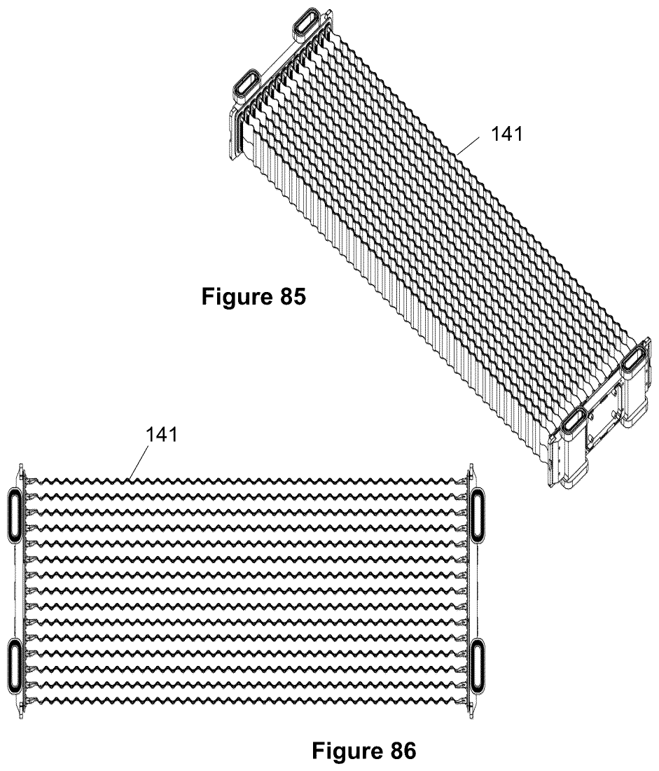

FIG. 85 is a perspective views of a fluid delivery arrangement and ducts according to an aspect of the invention.

FIG. 86 is a perspective view of a fluid delivery arrangement and ducts according to an aspect of the invention.

In FIG. 1 there is shown an exploded view of a battery pack 1 according to an aspect of the invention. The battery pack 1 comprises: a battery pack housing 2; a battery module sub assembly 3; a plurality of mounting arrangements 4; a battery pack management system 5 for monitoring and/or controlling the operation of the battery pack 1; a battery pack fluid connection arrangement 6 for connecting the battery pack to a source of thermal management fluid; and an electrical connection arrangement 7 for electrically connecting the battery pack 1 to an external load.

The battery pack 1 is locatable within a predetermined volume within an apparatus such as a mobile apparatus or an industrial apparatus. For example, the battery pack 1 is locatable within a volume in a road-going vehicle such as a car, truck, lorry, road sweeper or digger, or an industrial apparatus such as a plant, crane or other machine. Where the battery pack 1 is used to convert an existing petroleum-based design into an electrically powered design, the battery pack 1 can fit within a predetermined volume originally designed to accommodate e.g. a diesel engine.

The battery pack housing 2 comprises a lower case member 21, a cover member 22 and an end enclosure 23. The cover member 22 covers an aperture 24 in the lower case member 21. The lower case member 21 defines a cavity 25 in which the battery module sub assembly 3 is locatable. As shown in FIGS. 2 and 3 the battery pack housing 2 comprises two side walls 26a,26b, two end walls 27a,27b, a base wall 28a and a top wall 28b. The end enclosure 23, which houses the battery pack management system 5, is attached to an end wall 27a of the battery pack 1. FIGS. 4 and 5 show top and end views of battery pack 1 respectively.

The end enclosure 23, which houses the battery pack management system 5, is shown in detail in FIGS. 6-9. The end enclosure 23 comprises a housing member 23a and a lid member 23b. An indicator light 74 is visible through apertures in the lid member 23b. The indicator light 74 is adapted to display encoded signals, for example flashing and/or coloured light signals, indicative of an operating state of the battery 1. The end enclosure 23 further comprises electrical adapters 73, a communication port 75 and internal electrical connectors 76,77. The electrical adapters 73 provide the electrical terminals of the battery 1. The communication port 75 allows e.g. an external computer to be connected to the battery 1 for e.g. monitoring and/or diagnostic purposes. The internal electrical connectors 76,77 are adapted to pass through the battery pack housing 2 and connect the end enclosure 23, particularly the circuitry held within the end enclosure 23, to the terminals of the battery module sub assembly 3/battery modules 10 via one or more busbars.

The battery pack 1 comprises a manual disconnection arrangement 8. The manual disconnection arrangement 8 is a manual service disconnect. The manual disconnection arrangement 8 comprises a switch 81. The switch 81 is operably connected to battery modules in the battery pack 1. The manual disconnection arrangement 8 is configured to electrically disconnect two groups of battery modules within the battery pack 1, thereby disabling the terminals 71,72 of the battery pack 1. When the switch 81 is opened the first and second groups of battery modules 10 are disconnected from each other such that no current can flow between them. As will be appreciated the position within the battery module sub assembly 3 where the disconnect 8 operates can be varied such that alternative numbers of battery modules 10 are included in each group.

As shown in FIG. 10, the battery pack 1 comprises a battery pack electrical connection arrangement 7. The battery pack electrical connection arrangement 7 comprises positive and negative battery pack terminals 71 and 72. In this embodiment the positive and negative battery pack terminals 71,72 are provided by electrical adapters 73 which pass through a wall of the end enclosure 23. In use, the battery pack electrical connection arrangement 7 is adapted to allow the battery pack 1 to be electrically connected to an external load 1100 such as a motor or other electrical component of a vehicle or piece of industrial apparatus.

The battery pack 1 comprises a battery pack fluid connection arrangement 6. The battery pack fluid connection arrangement 6 comprises a fluid inlet arrangement 61 and a fluid outlet arrangement 62. The fluid inlet arrangement 61 provides a fluid intake i.e. a path for fluid to enter the battery pack 1. Fluid is able to enter the battery pack 1 via the inlet adapter 63 (FIG. 1) which passes through an aperture 29a in an end wall 27a of the battery pack housing 2 and is connectable to the inlet conduit 65 of the battery module sub assembly 3. The fluid outlet arrangement 62 provides a fluid exhaust i.e. a path for fluid to exit the battery pack 1. The fluid outlet arrangement 62 comprises an outlet adapter 64 which passes through an aperture 29b in the end wall 27a of the battery pack housing 2 and is connectable to the outlet conduit 66 of the battery module sub assembly 3.

The fluid inlet arrangement 61 and the fluid outlet arrangement 62 are in fluid communication with one another via the battery module sub assembly 3. As will be appreciated the fluid inlet arrangement 61 and the fluid outlet arrangement 62 are interchangeable in that fluid may pass through these arrangements, and the battery module sub assembly 3 and/or battery modules 10, in either direction as required.

In use, the battery pack fluid connection arrangement 6 is adapted to allow the battery pack 1 to be operably connected to a thermal management system 1000 which provides a source of thermal management fluid, preferably water and/or a water-glycol mixture. The thermal management system 1000 shown in FIG. 10 comprises a reservoir 1001 for containing the coolant fluid, a heat exchanger 1002 and a pump 1003 connected to the battery pack 1 in a coolant loop 1004. The reservoir 1001 provides hydrostatic pressure to coolant fluid 1006 in the coolant loop 1004 and the pump 1003 is configured to pump coolant 1006 from the reservoir 1001 to the coolant loop 1004 and to pressurise the coolant loop 1004. A pressure sensor 1005 is used to monitor the pressure of the coolant 1006 such that a target operating pressure is maintained in the coolant loop 1004.

FIG. 11 shows an exploded view of the battery module sub assembly 3. The battery module sub assembly 3 comprises a plurality of identical battery modules 10, inlet-side and outlet-side multiport fluid connectors 700a,700b and a support arrangement 30.

In the present example the battery module sub assembly 3 comprises six identical battery modules 10 but as will be appreciated the number and mutual orientation of the battery modules 10 may be varied according to particular design requirements. The battery modules 10 are fluidly- and electrically interconnected to each other to provide the required electrical and thermal management characteristics required for a particular application. The battery modules 10 are also mechanically coupled to each other via the support arrangement 30.

Electrical connections are provided between the stacked battery modules 10 in the battery module sub assembly 3 such that electrical current is operable to flow through the battery module sub assembly 3. In this example the battery modules 10 are connected in series and, in use, the battery modules 10 are discharged in series. However, it will be appreciated that in alternative embodiments one or more parallel electrical connections may be employed, as necessary. Busbars (not shown) are used to electrically interconnect the battery modules 10, and to connect the battery module sub assembly 3 to the battery pack terminals 71,72.

Fluid connections are provided between the battery modules 10 in the battery module sub assembly 3 such that a thermal management fluid is operable to flow through the battery module sub assembly 3 via the inlet-side multiport fluid connector 700a, the battery modules 10 and the outlet-side multiport fluid connector 700b. In this example the fluid connections between battery modules 10 are parallel fluid connections i.e. fluid is operable to flow through each of the battery modules 10 in parallel. However, it will be appreciated that in alternative embodiments some or all of the fluid connections may be series fluid connections i.e. fluid may be caused to flow through two or more battery modules 10 successively.

The inlet-side multiport fluid connector 700a is a main fluid inlet for allowing thermal management fluid to enter the battery module sub-assembly 3. The outlet-side multiport fluid connector 700b is a main fluid outlet for allowing thermal management fluid to exit the battery module sub-assembly 3. The inlet-side multiport fluid connector 700a is connected to, and is in fluid communication with, the inlet-side fluid delivery arrangement 200a of a battery module 10 located at the ‘top’ of the stack of modules 10. The outlet-side multiport fluid connector 700b is connected to, and is in fluid communication with, the outlet-side fluid delivery arrangement 200b of a battery module 10 located at the ‘top’ of the stack of modules 10.

As shown in FIG. 12, the battery modules 10 in the battery module sub assembly 3 are stacked such that the thermal management arrangements 140 of neighbouring battery modules 10 are interconnected. The multiport fluid connectors 700a,700b are connected to the fluid delivery arrangements 200a,200b of a ‘top-most’ battery module 10 at the ‘top’ of the stack of battery modules 10. Sealed blanking plates are provided over the open ends of the fluid delivery arrangements (e.g. 200c, FIG. 12) of the ‘bottom-most’ battery module 10 on the opposite side of the stack. The blanking plates prevent thermal management fluid from leaking out of the fluid delivery arrangements of lower-most battery module 10 in the stack, in use.

The battery modules 10 and inlet-side and outlet-side multiport fluid connectors 700a,700b in the battery module sub assembly 3 are mechanically connected and held together by a support arrangement 30. The support arrangement 30 comprises two end face support members 31 located at the peripheral ends of the battery module sub assembly 3. The battery module support arrangement 30 also comprises four elongate corner support members 32. Each corner support member 32 is an L-shaped section which accommodates the corners of a plurality of battery modules 10 and a corner of each respective end face support member 31. Each corner support member 32 is an elongate member which spans the distance between the end face support members 31. Each elongate corner support member 32 is attached to the battery modules 10 and end face support members 31 via fasteners such as screws and/or bolts. The battery module support arrangement 30 also comprises holding plates 33a,33b for attaching and securing the inlet-side and outlet-side multiport fluid connectors 700a,700b to the battery module sub-assembly 3.

FIGS. 15 and 16 show an alternative support arrangement 1030 for the battery module sub-assembly 3. The alternative support arrangement 1030 comprises two end face support members 1031 located at the peripheral ends of the battery module sub assembly 3. The battery module support arrangement 1030 also comprises two elongate end support members 1032. Each end support member 1032 is a C-shaped section which accommodates the ends of a plurality of battery modules 10. Each end support member 1032 comprises a plurality of apertures 1033 through which the seals 60 between battery modules 10 are viewable/accessible. Each end support member 1032 is an elongate member which spans the distance between the end face support members 1031. Each elongate end support member 1032 is attached to the battery modules 10 and end face support members 1031 via fasteners such as screws and/or bolts.

As shown in FIG. 16, the alternative support arrangement 1030 also comprises holding plates 33a,33b for attaching and securing the inlet-side and outlet-side multiport fluid connectors 700a,700b to the battery module sub-assembly 3.

Battery pack 1 comprises a plurality of mounting arrangements 4 which allow the battery pack 1 to be mounted to another structure such as a vehicle chassis or other supporting structure. In the present embodiment the battery pack 1 comprises eight mounting arrangements 4 which provide eight positions on the battery pack housing 2 where the battery pack 1 can be securely mounted to e.g. a vehicle, chassis or other structure. Fixing arrangements such as screws or bolts can be used to attach e.g. a chassis to each mounting arrangement 4.

Returning to FIGS. 2 and 3, the present invention provides a battery pack 1 in which the mounting arrangements 4 are mechanically connected to the battery module sub assembly 3, in particular the end face support members 31 thereof, and are accessible through the battery pack housing 2. The mounting arrangements 4 provide mechanical connection points on the exterior of the battery pack 1. In use when the battery pack 1 is mounted on a supporting structure such as a chassis via the mounting arrangements 4, the mounting arrangements 4 allow the weight of the battery module sub assembly 3 to be transferred directly to the supporting structure, rather than being transferred to the supporting structure via e.g. the battery pack housing 2 and one or more external brackets. As a result, the battery pack housing 2 can be lighter as it does not need to support the sub assembly 3.

In prior art systems battery module sub-assemblies are attached to the interior of a housing via welds. The battery pack housing will include one or more mounting brackets attached to the exterior of the battery pack housing. The mounting brackets can be used to mount the battery pack to a chassis or other support. As will be appreciated, the heaviest part of the battery pack is the battery module sub assembly. Therefore in such prior art systems the battery pack housing needs to be strong enough to support the battery module sub assembly, and strong enough to support the battery pack itself on the chassis or support structure. The strength required of the housing will necessarily add complexity to the structure and weight to the housing and pack. The present invention avoids these problems.

As shown in FIG. 2, mounting arrangements 4 are accessible through apertures 22a in the cover member 22 of the battery pack housing 2. The mounting arrangements 4 accessible through the cover member 22 are upper mounting arrangements 41. The upper mounting arrangements 41 comprise mounting members 45 which are directly accessible through the battery pack housing 2.

As shown in FIG. 3, further mounting arrangements 4 are located on the base wall 28a of the battery back housing 2. The mounting arrangements 4 located on the base wall 28a of the battery back housing 2 are lower mounting arrangements 42. The lower mounting arrangements 42 comprise mounting members 45 which are covered by feet covering members 44.

Turning to FIG. 17, each mounting arrangement 4 comprises a mounting member 45. The mounting member 45 is a mounting block having a body 45a. The mounting member 45 comprises a first interface portion 46 which, in use, is adjacent to the battery pack housing 2. The mounting member 45 comprises a second interface portion 47 which, in use, is adjacent to the battery module sub-assembly 3. The second interface portion 47 is similar to the first interface portion 46.

The first interface portion 46 comprises an annular recess 48 for receiving a seal, such as an o-ring. A seal can be used to seal the interface between the mounting member and an adjacent component such as the cover 22 of the battery pack housing 2. The first interface portion 47 comprises a receiving arrangement 49. The receiving arrangement 49 comprises a tubular member having a threaded hole 49a. The receiving arrangement 49 is adapted for receiving fixing means such as screws and/or bolts which can be used to attach the mounting member 45 to an external support or chassis etc.

The first interface portion 46 comprises further receiving arrangements 49b, in particular two further receiving arrangements 49b. The further receiving arrangements 49b comprise threaded holes. The further receiving arrangements 49b are adapted for receiving fixing means such as screws and/or bolts which can be used to attach the mounting member 45 to the battery pack housing 2.

In use, each mounting member 45 is attached to the battery module sub-assembly 3, particularly the end face support members 31 thereof, and the battery pack housing 2 via the further receiving arrangements 49b. In use, the mounting members 45 are spacers which define a gap between the battery module sub-assembly 3 and the battery pack housing 2. In use, the mounting members 45 are adapted to transfer the weight of the battery module sub assembly 3 to the outside of the battery pack housing 2, e.g. to a supporting structure or chassis. The mounting members 45 can be directly accessible on the outside of the battery pack housing 2, for example via apertures 22a. The mounting members 45 can be covered with covering members such as feet 44.

FIGS. 18-23 disclose a battery pack 901 according to an aspect of the invention. The battery pack 900 is similar to the battery pack 1, with similar numerals denoting similar features. The battery pack 900 comprises: a battery pack housing 902; a battery module sub assembly 903 comprising a plurality of battery modules; a plurality of mounting arrangements 904; a battery pack management system 905 for monitoring and/or controlling the operation of the battery pack 901; a battery pack fluid connection arrangement 906 for connecting the battery pack to a source of thermal management fluid; and an electrical connection arrangement 907 for electrically connecting the battery pack 901 to an external load. The key distinguishing features of the battery pack 901 is the size of the battery module sub assembly and housing 902, and the mounting arrangements 904.

The battery pack housing 902 comprises a lower case member 921, a cover member 922 and an end enclosure 923. The cover member 922 covers an aperture in the lower case member 921. The lower case member 921 defines a cavity in which the battery module sub assembly 903 is locatable. The battery pack housing 902 comprises two side walls 926a,926b, two end walls 927a,927b, a base wall 928a and a top wall 928b. The end enclosure 923, which houses the battery pack management system 905, is attached to an end wall 927a of the battery pack 901. FIGS. 20 and 21 show side and end views of battery pack 901 respectively.

FIG. 22 is a cross-sectional view through battery pack 901 showing the connections between the mounting arrangements 904, the battery module sub assembly 903 and the battery pack housing 902. The battery module sub assembly 903 is attached to the battery pack housing 902 on the interior of the battery pack housing 902 via the mounting arrangements 904, in this example eight mounting arrangements 904. As shown, there is no direct contact between the battery module sub assembly 903 and the battery pack housing 901. The battery module sub assembly 3 is mounted in the battery pack housing 2 of battery pack 1 in a similar way.

As shown in FIG. 22, mounting arrangements 904 pass through apertures 922a,928a in the cover member 922 and base wall 928 of the battery pack housing 902. The mounting arrangements 904 are at least partly accessible on the exterior of the battery pack housing 902. The mounting arrangements 904 comprise mounting members 945 which are similar to the mounting members 45 described above.

Each mounting arrangement 904 comprises a mounting member 945 and a mount cover 950. The mounting member 945 is a mounting block having a body 945a. The mounting member 945 comprises a first interface portion 946 which, in use, is adjacent to the battery pack housing 902. The mounting member 945 comprises a second interface portion 947 which, in use, is adjacent to the battery module sub-assembly 903. In use, the mounting member 945 is located on the interior of the battery pack 901, while the mount cover 950 is located on the outside surface of the battery pack 902. In use, the battery pack housing 902 is located between the mounting member 945 and the mount cover 950.

The first interface portion 946 comprises an annular recess 948 for receiving a seal, such as an o-ring. A seal can be used to seal the interface between the mounting member 945 and an adjacent component such as the base wall 928 of the battery pack housing 902.

The first interface portion 946 comprises a receiving arrangement 949. The receiving arrangement 949 comprises a tubular member having a threaded hole 949a. The receiving arrangement 949 is adapted for receiving fixing means such as screws and/or bolts which can be used to attach the mounting member 945 to an external support or chassis etc.

In use, each mounting member 945 is attached to the battery module sub-assembly 903, particularly the end face support members 931 thereof, and the battery pack housing 902. As shown in FIG. 23, in use the receiving arrangement 949 of the mounting member 945 passes through an aperture in the battery pack housing 902, and also passes through an aperture in the mount cover 950.

The mounting members 945 are spacers which define a gap G between the battery module sub-assembly 903 and the battery pack housing 902. The mounting members 945 are adapted to transfer the weight of the battery module sub assembly 903 to the outside of the battery pack housing 902, for example to a supporting structure or chassis bolted or screwed to the receiving arrangements 949. The mounting members 945 are directly accessible on the outside of the battery pack housing 902. The mounting members 945 can be covered with covering members such as feet.

FIG. 23 shows an exploded view of a battery module 10 for use in the battery module sub-assemblies 3,903 and battery packs 1,901. The battery module 10 comprises a battery module housing 100, one or more cells 120 and a thermal management arrangement 140 for thermally managing the one or more cells 120. The thermal management arrangement 140 comprises at least one thermal management duct 141, and two fluid delivery arrangements 200. Each battery module 10 further comprises a battery module housing 100 and the cells 120 are located within the battery module housing 100. The battery module 10 further comprises a battery module electrical connection arrangement 160 for providing electrical connections between the battery module 10 and a component such as a further battery module 10, a busbar and/or an external load 1100. Each battery module 10 is locatable within a battery pack 1 and can be connected to one or more further identical battery modules 10 also located within the battery pack 1.

The battery module housing 100 comprises an upper housing member 101 and a lower housing member 102. The lower housing member 102 comprises a substantially planar base 103 and two side walls 104a,104b. The respective side walls 104a,104b extend in a direction which is substantially perpendicular to each base 103. The side walls 104 comprise a plurality of apertures 106 through which electrical connections to the battery module terminals 171,172 can be made. The fluid delivery arrangements 200 provide end walls of the housing 100.

As shown in FIG. 25, the battery module 10 comprises an upper surface 110, a lower surface 111, two side surfaces 112 and two end surfaces 113 comprising end covers 114. The upper surface 111 is formed by the base 103 of the upper housing member 101. The lower surface 112 is formed by the base 103 of the lower housing member 102. The side surfaces 112 are formed by the side walls 104a,104b of the lower housing members and busbars 400 of the battery module 10. The end surfaces 113 are formed by the fluid delivery arrangements 200. At each corner of the battery module 10 are structural support components 430 of busbars 400.

Cell arrangement members 180 are used within battery module 10 for supporting and locating the cells 120. FIG. 25 discloses an example cell arrangement member 180 comprising a substantially planar body 181 and a plurality of receiving formations 182 formed in the body 181. Each receiving formation 182 is adapted for receiving and locating the end of a cell 120 within the battery module 10. The receiving formations 182 are arranged in a close-packed hexagonal or honeycomb pattern. The receiving formations 182 are adapted to hold cells 120 in a close-packed hexagonal or honeycomb pattern within the battery module 10. Each receiving formation 182 comprises a through hole portion 183 which provides a path through which a wire bond can pass so that said wire bond can electrically connect a busbar on one side of the member 180 with the cells 120 on the other side of the member 180.

In use each cell arrangement member 180 is located between the respective ends 122 of a plurality of cells 120 and at least part of a busbar. Each cell arrangement member 180 is electrically insulating. Each cell 120 is held within the battery module 10 between two cell arrangement members 180. An example of a plurality of cells 120 being associated with a cell arrangement member 180 is shown in FIG. 25. Each battery module 10 comprises an array of cylindrical cells 120 which may be 2170 cells and/or 18650 cells. Each battery module 10 comprises a predetermined number of cells 120 arranged in a regular array. Cells 120 are provided in a close-packed hexagonal array. The minimum separation between the cells is 2 mm. Each battery module 10 is a multiple of six cells in length. Each battery module 10 is twenty four or forty eight cells long.

Each battery module 10 comprises a battery module electrical connection arrangement 160 for providing electrical connections between the battery module 10 and a component such as a further battery module 10, a busbar, an interconnect and/or an external load. The battery module electrical connection arrangement includes a collection of battery module busbars 170 which are used to electrically interconnect the cells 120, and the battery module terminals 171,172. Each battery module busbar 170 comprises a metallic sheet, such as an aluminium or steel sheet, which has been formed into a predetermined shape. The battery module busbars 170 are themselves electrically interconnected via wire bonds and/or cells 120.

FIG. 26 shows a battery module 10 with the housing members removed and one of the non-planar busbars removed. The battery module 10 comprises a plurality of interconnection busbars 300 and two non-planar busbars 400. Each cell 120 in battery module 10 is electrically connected to the battery module busbars 170 via wire bonds which are fusible and/or frangible electrical connections. Wire bonds are made to the busbars 170/cells using ultrasonic bonding, laser welding, ultrasonic welding or resistance welding. In preferred embodiments each wire bond is an aluminium or steel wire bond and each battery module busbar 170 is made from aluminium or steel.

FIGS. 27 and 28 shows an interconnection busbar 300 for use in the battery module 10. Each interconnection busbar 300 is generally planar and cut or pressed from sheet metal. The interconnection busbar 300 comprises a body 301 having edge portions 302. Each edge portion 302 comprises one or more recesses 303. When in situ within the battery module, the recesses 303 provide gaps through which potting material 130 can be inserted into the battery module 10. The body 301 comprises a planar cell connection portion 310 adapted to be connectable to the terminals/casings of one or more cells 120 via wire bonds. The cell connection portion 310 comprises a plurality of cell connection apertures 311. The cell connection apertures 311 are generally rectangular although any suitable shape may be used. The cell connection apertures 311 are adapted to allow a wire bond to pass fully therethrough. The arrangement of the cell connection apertures 311 reflects the arrangement of cells 120 within the battery module 10. The interconnection busbar 300 also comprises fixing apertures 312 to allow the busbar 300 to be fixed in position within the battery pack 10 and/or fixed to a non-planar busbar 400. The fixing apertures 312 are located in the cell connection portion 310. Fastening arrangements such as screws can pass through the fixing apertures 312.

FIGS. 29-31 provide views of two busbars 400 according to an aspect of the invention, and a plurality of cell arrangement members 180. The busbars 400 can be used in the battery module 10 and/or battery pack 1 to provide electrical connections to the cells 120 retained in the cell arrangement members 180. Non-planar busbars 400 are used to form the elongate positive and negative terminals 171,172 of the battery module 10. The busbar 400, like other busbars employed in battery pack 1, is at least partly formed from an electrically conductive material such as aluminium or steel.

Each non-planar busbar 400 comprises an electrical connection portion 401 and two structural support components 430. The electrical connection portion 401 is adapted for electrically interconnecting one or more cells and one or more further components such as a further busbar, a terminal, an interconnect and/or an external load. The structural support components 430 are adapted for retaining the electrical connection portion 401 in position within a battery module 10, and for providing structural support to the battery module 10, allowing multiple battery modules 10 to be aligned and stacked.

Each structural support component 430 is locatable at a peripheral end of an electrical connection portion 401. FIG. 30 shows a structural support component 430 in detail. The structural support component 430 comprises a body portion 431. The body portion 431 is preferably made from a non-conductive material such as plastic but may alternatively be made from a conductive material such as aluminium or another metal. The structural support component 430 is rigidly attached to the electrical connection portion 401 and may be overmolded on the electrical connection portion 401 via e.g. injection overmolding.

The structural support component 430 comprises an end portion 432, an upper portion 433, a lower portion 434 and a side portion 435. The outer surfaces of the upper portion 433 and lower portion 434 are substantially parallel. The outer surfaces of the end portion 432 and side portion 435 are substantially perpendicular to one another, and substantially perpendicular to the outer surfaces of the upper portion 433 and the lower portion 434. By ‘outer surface’ it is meant the surface which is outermost in use.

The structural support component 430 is attached to the electrical connection portion 401 via fixing members 428 which pass through apertures at the peripheral end of the external connection portion 420. The fixing members are screws and/or bolts which are retained in threaded apertures in the side portion 435. The side portion 435 of the structural support component 430 is attached to the external connection portion 420 of the busbar 400. The peripheral end of the external connection portion 420 of the busbar 400 is received in the structural support component 430.

The structural support component 430 comprises first and second receiving arrangements 436,437 for receiving fixing means such as screws and/or bolts. The first and second receiving arrangements 436,437 comprise threaded apertures. The first receiving arrangement 436 is located in the end portion 432 and the second receiving arrangement 437 is located in the side portion 435. The receiving arrangements 436,437 are adapted to allow busbar 400 to be attached to the elongate corner support members 32 of the support arrangement 3 via fixing means such as screws and/or bolts. An aperture 429 is located in the external connection portion 420 which corresponds to the position of the first receiving arrangement 437.

FIGS. 31-33 provide views of the electrical connection portion 401 of a non-planar busbar 400. The electrical connection portion 401 is generally non-planar and is cut or pressed from sheet metal and bent into a desired final shape. The electrical connection portion 401 comprises a cell connection portion 410 and an external connection portion 420. The cell connection portion 410 is adapted for connection to the terminals of one or more cells and/or to one or more busbars 300. The external connection portion 420 is adapted for providing electrical connection to a further component such as a further busbar, a terminal, an interconnect and/or an external load, and for providing the electrical terminals of the battery module 10.

The generally planar cell connection portion 410 is adapted to be connectable to the terminals and/or casings of one or more cells 120 via wire bonds. The cell connection portion 410 comprises a plurality of cell connection apertures 411. The cell connection apertures 411 are generally rectangular although any suitable shape may be used. The cell connection apertures 411 are adapted to allow a wire bond to pass fully therethrough. The cell connection portion 410 also comprises fixing apertures 412 to allow the busbar 400 to be fixed in position within the battery pack 10 and/or fixed to one or more interconnection busbars 300. Fixing apertures can be located in the cell connection portion 410. Fastening arrangements such as screws can pass through the fixing apertures.

The external connection portion 420 is a terminal portion adapted for connection to an external load. The external connection portion 420 comprises a generally planar main plane portion 420a and a plurality of raised portions 421. The raised portions 421 are adapted for providing electrical connection to a further component such as a further busbar, a terminal, an interconnect or an external load. The raised portions 421 are generally planar and are slightly raised above the main plane 420a of the external connection portion 420. Each raised portion 421 is formed to be accessible through the housing walls of a battery module 10 i.e. through the apertures 106 in the walls of the battery module 10.

Each raised portion 421 is integrally formed in the external connection portion 420 and is formed via pressing. Each raised portion 421 comprises a planar portion 422 surrounded by a curved peripheral portion 423. Each raised portion 421 further comprises two retaining arrangements 424 in the form of two threaded holes. Each retaining arrangement 424 is adapted to retain a fixing member such as a bolt, allowing e.g. another busbar to be rigidly attached to the busbar 400.

The cell connection portion 410 is disposed at an angle to the external connection portion 420. In the present embodiment the cell connection portion 410 is substantially perpendicular to the external connection portion 420. The angle between these portions allows the busbar 400 to receive the edge of an array of cells, particularly the corners of the cell casings. In use, the busbars 400 are located at the edge of the array of cells in battery module 10.

In use, the busbars 400 are located within a battery module 10. The array of cells 120 within the battery module 10 is located within the volume between the busbars 400. The internal corner of each busbar 400 between the cell connection portion and the primary electrical connection portion 420 is angled to accommodate the corner of a cell, or an array of cells. Each electrical connection portion 420 is accessible from the exterior of the battery module 10, so that electrical connections to e.g. an external load can be made to the busbars 400 and cells 120.

The battery module 10 in which the busbars 400 are employed comprises a housing and at least the external connection portion 420 of the busbar and the external surfaces of the structural support component 430 are accessible from the exterior of the battery module 10. Particularly, the raised portions 421 of the external connection portion 420 pass through apertures in the side walls of the battery module housing, and the external surfaces of the structural support component 430 form the external corners of the battery module 10. The non-planar shape of the busbar 400 provides added structural integrity to the battery module 10. Each battery module 10 comprises two non-planar busbars 400 that are located on opposing sides of the battery module housing 100.

FIG. 35 shows a plurality of battery modules 10 in a stacked arrangement, together forming a battery module sub assembly 3. As shown in detail in FIG. 36, the structural support components 430 of neighboring battery modules 10 are located adjacent to one another. Together, the structural support components 430 at each corner of the battery modules 10 in the battery module sub assembly 3 provide added structural integrity to the battery module sub assembly 3.

In optional embodiments structural support components may be provided in the middle of the busbar 400 i.e. halfway between the structural support components 430. In such embodiments, neighboring battery modules 10 in a battery module sub assembly can be mechanically connected to one another at or near the middle of the assembly i.e. at positions halfway between the structural support components 430.

FIGS. 37 and 38 show an example of a thermal management arrangement 140 for the battery modules 10 in the battery module sub assembly 3. Each battery module 10 comprises a thermal management arrangement 140 which is adapted to thermally manage (i.e. heat and/or cool) the cells 120 in a battery module 10. The thermal management arrangement 140 comprises at least one thermal management duct 141, and at least one fluid delivery arrangement 200. Particularly, the thermal management arrangement 140 comprises eight duct assemblies 500 (each including a thermal management duct 141), an intake-side fluid delivery arrangement 200a and an outlet-side fluid delivery arrangement 200b. The inlet-side fluid delivery arrangement 200a is in fluid communication with the outlet-side fluid delivery arrangement 200b via the duct assemblies 500. Each fluid delivery arrangement 200 comprises first and second fluid connection conduits 210,220 for allowing a thermal management fluid to enter and/or exit the thermal management arrangement 140. Each fluid delivery arrangement 200 is connected to, and is in fluid communication with, the ducts 141 via nozzles 501. Each thermal management duct 141 comprises two open ends 142 for allowing a thermal management fluid to enter and/or exit the duct 141. When used in battery module 10, cells 120 are located in the spaces between neighboring ducts 141 and between the fluid delivery arrangements 200a,200b.

In the present embodiment the thermal management arrangement 140 comprises a plurality of substantially parallel ducts 141. In preferred embodiments each duct 141 is a flexible duct formed from an inflatable plastics material such as polyethylene (PE), low-density polyethylene (LDPE), linear low-density polyethylene (LLDPE) or high-density polyethylene (HDPE). Use of an inflatable plastics material is advantageous as the material is intrinsically electrically insulating, lightweight and does not corrode or chemically interact with a coolant such as a glycol water mix.

In preferred embodiments each duct 141 comprises one or more thermally conductive additives. Thermally conductive additives provide the advantage that they can improve the thermal conductivity of the duct material. Ideally, each flexible duct 141 comprises a matrix (e.g. a flexible polymer material such as LDPE) with a thermally-conductive filler (e.g. particles of a carbon-based and/or ceramic based material such as graphite, multi-walled carbon nanotubes and/or boron-nitride) dispersed throughout the matrix. The particles have a diameter of 1-10 nm, most preferably <5 μm. In the most preferred embodiments the duct material comprises up to 30% additives. The filler material can be a blend of graphite and boron nitride particles according to any suitable ratio, for example 1:1. When incorporated into a PE matrix this provides a duct material having a thermal conductivity>≈0.8 W/m.K, optionally approximately 1 W/m.K.

The walls of each flexible duct 141 are between 50 μm and 150 μm thick. This thickness allows for good thermal transfer properties between the or each duct and the cells. In the preferred embodiments each duct 141 is a single-lumen duct but as will be appreciated a multi-lumen duct may be used in e.g. large battery packs where a single lumen duct is not capable of promoting an even temperature distribution. In optional embodiments the ducts 141 may be rigid and made from e.g. aluminium or copper. In the example provided each duct 141 is a substantially straight manifold duct configured to carry a coolant fluid such as a water-glycol mixture, although each duct may follow a different path within the array of cells 120 and may be e.g. serpentine. The or each battery module 10 may include any number of ducts 141, for example one duct 141.

Each duct 141 in battery module 10 may be in direct contact with side surfaces of the adjacent cells 120 or may be in indirect contact with side surface(s) of the one or more cells 120 via an interface region or interface material such as a casing sheath surrounding the cells 120. Alternatively or additionally each duct 141 may be in indirect contact with side surfaces of the one or more cells 120 via a thermally conductive filler material such as a conductive paste or adhesive.

As illustrated by FIGS. 39-41, each flexible duct 141 in battery module 10 is positioned adjacent to and between cells 120 in the battery module 10. FIG. 39 shows a detail of two rows of cells 120 between which is a duct 141. During manufacture of the battery module 10, each duct 141 is located within the array of cells in a substantially uninflated state (FIG. 40). Once suitably arranged, each duct 141 is then inflated using a fluid which causes the duct to expand into contact with the side walls of the cells 120 (FIG. 41). Each duct 141, when in the inflated state, makes intimate physical contact with the surface of one or more cells 120. Inflating each flexible duct 141 such that its shape conforms to the shape of the cells 120 improves the duct-cell thermal contact such that the fluid may transfer thermal energy between the fluid and the cells 120 more efficiently.

Once the ducts 141 in battery module 10 are in their inflated state and at a sufficient pressure, a potting material 130 is inserted into the battery module 10. The potting material 130 is poured into the battery module 10 in a liquid state and sets, cures or hardens. In its set, cured or hardened state, the potting material 130 is substantially rigid such that it secures the cells 120 and the ducts 141 in position within the battery module 10. This is advantageous as it reduces the effects of vibrations on components within the battery module 10. Once set cured and/or hardened, the potting material 130 is adhesively attached to each duct 141, providing total external support and preventing excessive expansion and/or bursting of each duct 141. Furthermore, the potting material 130 maintains each duct 141 in an open configuration such that thermal management fluid is able to flow easily through each duct 141.

In preferred embodiments the potting material 130 is a thermally insulating potting material such as intumescent/polyurethane foam. Polyurethane foam is lighter than other potting materials and therefore provides a battery module 10 having a low overall weight. The presence of a thermally insulating potting material 130 within the battery module 10 reduces the effect of external temperature fluctuations on the battery module 10, helps to ensure that the ducts 141 are the primary controller of thermal energy within the battery module 10, and can prevent a high energy thermal event from propagating through the battery module 10. The potting material 130, when in the expanded state, substantially fills gaps within the battery module 10. In optional embodiments the potting material 130 comprises a thermosetting plastic, silicone rubber gel or epoxy resin.

In preferred embodiments each battery module 10 comprises one or more sensors 126. These sensors can be used to measure the temperature of one or more of the cells 120 in each battery module 10. Sensors 126 such as temperature sensors may be located on a flexible carrier 125, which is a flexible PCB, and the flexible carrier may be attached to a duct 141 as shown in FIG. 42. In use, sensors 126 on the carrier 125 are located between the duct 141 and the cells 120 such that the sensors are able to measure e.g. the temperature of the cells. In the inflated state the duct presses the temperature sensor against a cell to ensure good thermal contact between the duct and the cell. The carrier 125 comprises conductive traces to allow the sensors 126 to be operably connected to e.g. the slave board 51 of the battery module 10 allowing the temperature of one or more cells 120 to be transmitted to and analysed by e.g. a battery management computer 50. Communicative connections between the sensors 126, slave boards 51 and battery management computer 50 are shown in FIG. 43.

FIG. 44 discloses an example duct assembly 500. Each duct 141 in the battery module 10 forms part of a duct assembly 500. The duct assembly 500 comprises a duct 141 having two open ends 142, an inlet-side nozzle 501a, an inlet-side duct clamping assembly 510a, an outlet-side nozzle 501b and an outlet-side duct clamping assembly 510b. Each duct clamping assembly 510a,510b is used to clamp an open end 142 of the duct 141 to a respective nozzle 501a,501b. Each duct clamping assembly 510a,510b ensures that there is a fluid-tight connection between the duct 141 and a respective nozzle 501a,501b. Each duct clamping assembly 510a,510b is adapted to clamp the duct to a further component, such as a nozzle. Each duct clamping assembly 510a,510b prevents leaks from developing at the respective nozzle-duct interface. FIG. 45 shows top, side and end views of the duct assembly 500.

FIG. 46 is an exploded view of one end of the duct assembly 500, including one end of duct 141, a nozzle 501 and a duct clamping assembly 510. The end of the duct assembly 500 shown in FIG. 46 can be used at both ends of the duct assembly 500 shown in FIG. 44. In preferred embodiments the inlet-side nozzle 501a/duct clamping assembly 510a and the outlet-side nozzle 501b/duct clamping assembly 510b are substantially identical.

The nozzle 501 comprises a nozzle body 502 and an aperture 503 which passes through the body 502. Fluid is able to pass through the body 502 via the aperture 504. The body 502 comprises a flange portion 504 and an attachment portion (not shown). The attachment portion is located within the open end 142 of the duct 141. The duct 141 is heat welded at the open end thereof 142 to the attachment portion of the nozzle 501. The flange portion 504 comprises a raised portion 506. The flange portion 504, particularly the raised portion 506, provides a surface which can be attached to another component, for example a fluid delivery arrangement 200. The nozzle 501 can be attached to a fluid delivery arrangement via e.g. plastic welding.

The duct clamping assembly 510 comprises a bearing member 520, first and second securement members 530a,530b and a biasing member 550. The first and second securement members 530a,530b and bearing member 520 are preferably made from an insulating plastics material, although it is envisioned that a metal such as aluminium may be used. The biasing member 550 is preferably formed from a resilient material, such as steel wire.

In use, as shown in FIG. 47, the duct clamping assembly 510 bears and pushes against the open end 142 of the duct 141 and the nozzle 501. As previously noted, the duct 141 is joined to the attachment portion of the nozzle 501 at the open end 142 of the duct 141, for example via ultrasonic welding. The duct clamping assembly 510 reinforces the join between the open end 142 of the duct 141 and the attachment portion of the nozzle 501. The duct clamping assembly 510 acts to prevent leaks developing at the interfaces between the duct 141 and the nozzle 501.

FIG. 48 shows a perspective view of an example bearing member 520. The bearing member 520 comprises a first elongate portion 522 and a second elongate portion 523. A joining portion 521 joins the first elongate portion 522 to the second elongate portion 523. At the ends of the elongate portions 522,523 opposite the joining portion there is a gap 524. The gap 524 allows the nozzle 141 and attachment portion 505 to pass therethrough, and to move to a position between the elongate portions 522,523 such that the nozzle 141 and attachment portion 505 can be received by the bearing member 520. The bearing member 520 is a U-shaped member adapted for bearing against the duct 141 and nozzle 501. In particular, the inner surface 524 of the bearing member 520 is adapted for bearing against the duct at the position where the duct 141 is attached to the nozzle 501. The inner surface 524 of the bearing member 520 is generally smooth.

The bearing member 520 further comprises positioning elements 525 in the form of protrusions which extend from the first and second elongate portions 522,523. Two positioning elements 525a,525b extend from the first elongate portion 522. Two positioning elements 525c,525d extend from the second elongate portion 523. As will be explained in further detail below, the positioning elements 525 can be received in corresponding receiving portions 535 of the first and second securement members 530a,530b.

FIG. 49 shows a perspective view of the biasing member 550. The biasing member 550 comprises a body 551. The biasing member 550 comprises first and second arm portions 552a,552b and a bridge portion 553. The first and second arm portions 552a,552b are substantially straight and parallel. The first and second arm portions 552a,552b are each connected to the bridge portion 552 at a respective end. At the other respective end of each arm portion 552a,552b is a respective retainable portion 554a,554b. Each retainable portion 554a,554b is a curved end portion.

The biasing member 550 is a spring which is adapted to provide a force to push the first and second securement members 530a,503b towards each other, and towards the bearing member 520, attachment portion of the nozzle 501 and open end of the duct 142.

In use, the biasing member 550 bears against the first and second securement members 530a,530b. The force provided by the biasing member is transferred to the join between the duct 141 and nozzle 501 by the first and second securement members 530a,530b and the bearing member 520. The duct clamping assembly 501 reinforces the join between the duct 141 and nozzle 501 and ensures that there is a leak-tight connection between the duct 141 and nozzle 501 at the ends 142 of the duct 141.

FIGS. 50 and 51 disclose front and rear perspective views of an example securement member 530. Each of the first and second securement members 530a,530b shown in FIGS. 46 and 47 are identical to the example securement member 530. The securement member 530 comprises an elongate portion 531. The securement member 530 comprises two curved end portions 532,533 at either end of the elongate portion 531.

The securement member 530 comprises an inner surface 534. The inner surface 534 is adapted for engagement with an outer surface of the bearing member 520. The inner surface 534 of the securement member 530 comprises receiving portions 535. The receiving portions 535 are adapted to receive positioning elements 525 of the bearing member 520. The receiving portions 535 are adapted to receive and accommodate the positioning elements 525 when the securement member 530 abuts and is pressed against one side of the bearing member 520. This allows the first securement member 530 to be accurately placed against the side of the bearing member 520 at the correct position. Mating of the positioning elements 525 and receiving portions 535 also prevents displacement of the first securement member 530 with respect to the bearing member 520. As will be appreciated, the distance between the receiving portions 535a,535b is equal to the distance between the positioning elements 525a,525b and 525c,525d.

The securement member 530 further comprises an outer surface 536. The outer surface 536 of the securement member 530 comprises a channel 537 which is an elongate slot adapted to accommodate at least a part of the biasing member 550. In particular, the channel 537 is adapted to receive an arm 551 of the biasing member 550. The channel 537 is formed between first and second walls 538a,538b. The first wall 538a is continuous and extends along the securement member 530 along the entire length of the elongate portion 531 and the curved portions 532a,532b. The second wall 538b is discontinuous and comprises two discontinuities 539a,539b. Either or both of the first and second walls 538a,538b may be continuous or discontinuous.

The outer surface 536 of the securement member 530 comprises a receiving arrangement 545. The receiving arrangement 545 is a recess. The receiving arrangement 545 is adapted to receive a part of the biasing member 550, particularly one of the retainable portions 554a,554b. The receiving arrangement 545 is a recess in the body of the securement member 530. The receiving arrangement 545 is adapted for engagement with a portion of the biasing member 550, particularly one of the retainable portions 554a,554b. This allows the biasing member 550 to be accurately placed in the channel of the securement member 530 at the correct position. Mating of a retainable portion 554 of the biasing member 550 and the receiving arrangement 545 (c.f. FIG. 47) also prevents displacement of the biasing member 550 with respect to the securement member 530, in use.

FIG. 52 discloses an exploded perspective view of a fluid delivery arrangement 200 according to an aspect of the invention. Each battery module 10, and each thermal management arrangement 140 thereof, comprises two fluid delivery arrangements 200. Each duct 141/duct assembly 500 in battery module 10 is in fluid communication with each fluid delivery arrangement 200 in the battery module 10. The fluid delivery arrangement 200 is adapted for delivering a thermal management fluid 1006 to the thermal management ducts 141/duct assembly 500 locatable within the battery module 10 and battery pack 1.

The fluid delivery arrangement 200 comprises: a first connection conduit 210 adapted to provide a path for fluid into and/or out of the fluid delivery arrangement 200; a second connection conduit 220 adapted to provide a path for fluid into and/or out of the fluid delivery arrangement 200; and a plurality of distribution arrangements 230 adapted to provide a path for fluid out of and/or into the fluid delivery arrangement 200, and into and/or out of the thermal management ducts 141 and/or duct assemblies 500. Each distribution arrangement 230 is in fluid communication with the first and second connection conduits 210,220.

The fluid delivery arrangement 200 comprises a two-part body 201 which is formed of front and rear members 202,203. The first and second connection conduits 210,220 form part of the front member 202. Each distribution arrangement 230 is formed in the rear member 203. In use the front and rear members 202,203 are sealably attached to one another, for example via welding/plastic welding.

A main chamber 240 is located within the body 201 of the fluid delivery arrangement 200. The main chamber 240 enclosed by the front and rear members 202,203. The front member 202 partially encloses the main chamber 240. The rear member 203 partially encloses the main chamber 240 also. The first connection conduit 210 is in fluid communication with the main chamber 240 via two fluid connection apertures 241a,241b. Similarly, the second connection conduit 220 is in fluid communication with the main chamber 240 via two fluid connection apertures 242a,242b. The main chamber 240 of the fluid delivery arrangement 200 is adapted to contain and confine a thermal management fluid as it flows through the fluid delivery arrangement 200. The main chamber 240 is in fluid communication with the first connection conduit 210, the second connection conduit 220 and each distribution arrangement 230.

The main chamber 240 of the fluid delivery arrangement 200 is located within a space defined by a main chamber peripheral wall 243. The main chamber peripheral wall 243 is an annular wall which encloses the fluid connection apertures 241a,241b,242a,242b.

Each connection conduit 210,220 of the fluid delivery arrangement 200 provides multiple fluid paths into and/or out of the thermal management arrangement 140. In particular, the first connection conduit 210 provides two paths for fluid to pass into and/or out of the fluid delivery arrangement 200. The second connection conduit 220 provides two further paths for fluid into and/or out of the fluid delivery arrangement 200.

As shown in FIG. 53, the first connection conduit 210 comprises a first fluid connection arrangement (a fluid inlet) 211 and a second fluid connection arrangement (a fluid outlet) 212. The first fluid connection arrangement 211 of the first connection conduit 210 provides a path for fluid to enter the fluid delivery arrangement 200. The first fluid connection arrangement 211 of the first connection conduit 210 is connectable to a source of thermal management fluid 1006 e.g. the reservoir 1001 in coolant loop 1005. The second fluid connection arrangement 212 of the first connection conduit 210 provides a path for fluid to exit the fluid delivery arrangement 200. The first fluid connection arrangement 211 and the second fluid connection arrangement 212 are substantially identical. In use, fluid may enter and/or exit the fluid delivery arrangement 200 via either or both of the first fluid connection arrangement 211 and second fluid connection arrangement 212 of the first connection conduit 210.

The first fluid connection arrangement 211 is provided at a first end 213 of the first connection conduit 210. The second fluid connection arrangement 212 is provided at a second end 214 of the first connection conduit, opposite the first end 213. As will be appreciated the connection arrangement at either end of the first connection conduit 210 can be used as a fluid inlet and/or fluid outlet.

The first connection conduit 210 comprises a conduit wall 215. The conduit wall 215 has a regular cross section such that the cross section of the first connection conduit 210 is substantially constant along the main or major axis A of the first connection conduit 210. The main axis A of the first connection conduit 210 extends along the length of the first connection conduit 210 and is substantially parallel to the direction of fluid flow through the first connection conduit 210 from the first fluid connection arrangement 211 to the second fluid connection arrangement 212.

The first fluid connection arrangement 211 and second fluid connection arrangement 212 of the first connection conduit 210 both comprise flanges 216. Each flange 216 is a retaining arrangement for a seal 60. Each flange 216 is a seal-receiving body comprising a channel 217. Each channel 217 is adapted to receive and retain part of a sealing arrangement 60 i.e. an o-ring 60. Each channel 217 has a predetermined depth suitable for receiving at least a retainable portion 603 of the o-ring 60.

The second connection conduit 220 comprises a first fluid connection arrangement (a fluid inlet) 221 and a second fluid connection arrangement (a fluid outlet) 222. The first fluid connection arrangement 221 of the second connection conduit 220 provides a path for fluid to enter the fluid delivery arrangement 200. The first fluid connection arrangement 221 of the second connection conduit 220 is connectable to a source of thermal management fluid 1006 e.g. the reservoir 1001 in coolant loop 1005. The second fluid connection arrangement 222 of the second connection conduit 220 provides a path for fluid to exit the fluid delivery arrangement 200. The first fluid connection arrangement 221 and the second fluid connection arrangement 222 are substantially identical. In use, fluid may enter and/or exit the fluid delivery arrangement 200 via either or both of the first fluid connection arrangement 221 and second fluid connection arrangement 222 of the second connection conduit 220.

The first fluid connection arrangement 221 is provided at a first end 223 of the second connection conduit 220. The second fluid connection arrangement 222 is provided at a second end 224 of the second connection conduit, opposite the first end 223. As will be appreciated the connection arrangement at either end of the second connection conduit 220 can be used as a fluid inlet and/or fluid outlet.

The second connection conduit 220 comprises a conduit wall 225. The conduit wall 225 has a regular cross section i.e. the cross section of the second connection conduit 220 is substantially constant along the main or major axis A′ of the second connection conduit 220. The main axis A′ of the second connection conduit 220 extends along the length of the second connection conduit 220 and is substantially parallel to the direction of fluid flow through the second connection conduit 220 from the first fluid connection arrangement 221 to the second fluid connection arrangement 222. The main axis A′ of the second connection conduit 220 is substantially parallel to the main axis A of the first connection conduit 210.

The first fluid connection arrangement 221 and second fluid connection arrangement 222 of the second connection conduit 220 both comprise flanges 226. Each flange 226 is a retaining arrangement for a seal 60. Each flange 226 is a seal-receiving body comprising a channel 227. Each channel 227 is adapted to receive and retain part of a sealing arrangement 60 i.e. an o-ring 60. Each channel 227 has a predetermined depth suitable for receiving a retainable portion 603 of the o-ring 60. The flanges 216,226 and channels 217,227 are identical.

As shown in FIG. 54, the fluid delivery arrangement 200 comprises a storage compartment 250. The storage compartment 250 is an integral storage compartment which is integrally formed in the front member 202. The storage compartment 250 is located between the first connection conduit 210 and the second connection conduit 220. The storage compartment 250 is a sealable chamber which can store e.g. a slave board 51 of the battery management computer 50. The storage compartment 250 comprises a peripheral wall 251. The storage compartment 250 comprises a plurality of pillars 252 adapted to receive fixing means such as screws. A cover member 114 may be attached to the fluid delivery arrangement 200 to seal the storage compartment. The storage compartment 250 is sealable to prevent e.g. fluids entering the storage compartment 250.

The fluid delivery arrangement 200 comprises a plurality of distribution arrangements 230. As shown in FIG. 53, each distribution arrangement 230 comprises a distribution aperture 234 formed within a nozzle attachment portion 235. Each nozzle attachment portion 235 comprises a recess portion 236. Each recess portion 236 is an annular recess which extends around a distribution aperture 234. Each recess portion 236 is adapted to receive part of a nozzle 501, in particular the raised portion 506 on the flange portion 504 of a nozzle 501. The recess portion 236 allows the nozzle 501 to be accurately located with respect to the distribution aperture 234 and attached to the distribution arrangement 200 at the correct location.

As shown in FIG. 55, lower panel, the rear member 203 of the fluid delivery arrangement 200 comprises a plurality of distribution apertures 234 through which fluid can flow between the main chamber 240 and the distribution arrangements 230. The rear member 203 comprises eight distribution apertures 234 and eight distribution arrangements 230. Each distribution arrangement 230 is adapted to allow fluid to pass through said distribution arrangement 230 and into and or out of a respective duct 141/duct assembly 500. In use, coolant is able to flow from the main chamber 240, through each distribution aperture 234 and into a duct 141/duct assembly 500/nozzle 501.

The distribution apertures 234 of the fluid delivery arrangement 200 are aligned. Each distribution aperture 234 is of equal length. Each distribution aperture 234 extends the full height of the aperture portion 235. Each distribution aperture is in fluid communication with both the first connection conduit 210 and the second connection conduit 220 such that fluid passing into the fluid distribution arrangement 200 via either conduit 210,220 can be distributed to any distribution aperture 234. Fluid passing through the main chamber 240 is distributed to each fluid distribution arrangement 230 evenly.

When the fluid delivery arrangements 200 is used in the thermal management arrangement 140 of a battery module 10, each distribution arrangement 230 is directly attached to a nozzle 501 of a duct assembly 500. Each duct assembly 500 is connected two fluid delivery arrangements 200 via nozzles 501, each nozzle 501 being attached in a fluid-tight manner to a distribution arrangement 230. Each nozzle 501 can be welded to the rear member 203 of the fluid distribution arrangement 200. Particularly, the raised portion 506 on the flange portion 504 of a nozzle 501 is located within a recess portion 236 and the flange 504 of the nozzle is welded to the nozzle attachment portion 235. Attachment in this way provides a fluid-tight connection between the nozzle 501 and rear member 203 of the fluid distribution arrangement 200. A clamping assembly is ideally located over the join between the duct 141 and nozzle 501 to reinforce the join and to prevent leaks.

In use, the first connection conduit 210 and second connection conduit 220 are used to transport fluid to and/or from the main chamber 240. Each fluid connection arrangement 211,221,212,222 is open so that fluid can pass into and out of the main chamber 240 via the first connection conduit 210 and second connection conduit 220. Each distribution arrangement 230 has an identical aperture which is in fluid communication with the main chamber 240. Fluid is distributed equally to all distribution arrangement 230, and to each duct 141/duct assembly 500 attached to the fluid delivery arrangement 200. Fluid passing through the fluid delivery arrangement is distributed to each duct 141/duct assembly 500 evenly.

FIGS. 56-60 disclose an alternative fluid delivery arrangement 1200 according to an aspect of the invention. The further fluid delivery arrangement 1200 is generally similar to the fluid delivery arrangement 200, with similar numerals (e.g. 210/1210 and 220/1220) denoting similar features. The key distinguishing features of the alternative fluid delivery arrangement are the division of the main chamber into sub-chambers, and the distribution arrangements 1230.

FIG. 56 discloses an exploded perspective view of the fluid delivery arrangement 1200. As will be appreciated, the further fluid delivery arrangement 1200 is interchangeable with the fluid delivery arrangement 200. The battery modules 10 within battery pack 1 may use two fluid delivery arrangements 200 or two alternative fluid delivery arrangements 1200. In embodiments where redundancy is required, each battery module 10, and each thermal management arrangement 140 thereof, comprises two fluid delivery arrangements 1200. In such embodiments the fluid delivery arrangement 1200 is adapted for delivering a thermal management fluid 1006 to the thermal management ducts 141/duct assembly 500 locatable within the battery module 10 and battery pack 1.

The fluid delivery arrangement 1200 comprises: a first connection conduit 1210 adapted to provide a path for fluid into and/or out of the fluid delivery arrangement 1200; a second connection conduit 1220 adapted to provide a path for fluid into and/or out of the fluid delivery arrangement 1200; and a plurality of distribution arrangements 1230a,1230b adapted to provide a path for fluid out of and/or into the fluid delivery arrangement 1200 and into and/or out of the thermal management ducts 141 and/or duct assemblies 500.

The fluid delivery arrangement 1200 comprises a two-part body 1201 which is formed of front and rear members 1202,1203. The first and second connection conduits 1210,1220 form part of the front member 1202. Each distribution arrangement 1230a,1230b is formed in the rear member 1203. In use the front and rear members 1202,1203 are sealably attached to one another, for example via welding/plastic welding.

The main chamber 1240 is located within the body 1201 of the fluid delivery arrangement 1200. The main chamber 1240 is enclosed by the front and rear members 1202,1203. The front member 1202 partially encloses the main chamber 1240. The rear member 1203 partially encloses the main chamber 1240 also. The first connection conduit 1210 is in fluid communication with the main chamber 1240 via two fluid connection apertures 1241a,1241b. The second connection conduit 1220 is in fluid communication with the main chamber 1240 via two fluid connection apertures 1242a,1242b. The main chamber 1240 of the fluid delivery arrangement 1200 is adapted to contain and confine a thermal management fluid as it flows through the fluid delivery arrangement 1200.

The main chamber 1240 is in fluid communication with the first connection conduit 1210, the second connection conduit 1220 and each distribution arrangement 1230. However, unlike in the fluid delivery arrangement 200, the first and second connection conduits 1210,1220 and each distribution arrangement 1230 of the fluid delivery arrangement 1200 are in fluid communication with only a part of the main chamber 1240.

The main chamber 1240 is located within a space defined by a main chamber peripheral wall 1243. The main chamber peripheral wall 1243 is an annular wall which encloses the fluid connection apertures 1241a,1241b,1242a,1242b. A dividing wall 1244 is located within the main chamber 1240. The dividing wall 1244 splits the main chamber into a plurality of sub-chambers 1245a,1245b. The dividing wall 1244 follows a non-straight path. In particular, the dividing wall 1244 is crenellated. The dividing wall 1244 comprises a plurality of crenellations 1246. The main chamber peripheral wall 1243 encloses the dividing wall 1244.

The main chamber 1240 comprises a first sub-chamber 1245a and a second sub-chamber 1245b. The dividing wall 1244 splits the main chamber 1240 into the first sub-chamber 1245a and the second sub-chamber 1245b. The first sub-chamber 1245a is located between the main chamber peripheral wall 1243 and a first side 1244a of the dividing wall 1244. The second sub-chamber 1245b is located between the main chamber peripheral wall 1243 and a second side 1244b of the dividing wall 1244. The second side 1244b of the dividing wall 1244 is opposite the first side 1244a of the dividing wall 1244.

The first connection conduit 1210 is in fluid communication with the first sub-chamber 1245a via two fluid connection apertures 1241a,1241b. The second connection conduit 1220 is in fluid communication with the second sub-chamber 1245b via two fluid connection apertures 1242a,1242b. The first connection conduit 1210 is not in fluid communication with the second sub-chamber 1245b, and similarly the second connection conduit 1220 is not in fluid communication with the first sub-chamber 1245a.

Each connection conduit 1210,1220 of the fluid delivery arrangement 1200 provides multiple fluid paths into and/or out of the thermal management arrangement 140. In particular, the first connection conduit 1210 provides two paths for fluid to pass into and/or out of the fluid delivery arrangement 1200. The second connection conduit 1220 provides two further paths for fluid into and/or out of the fluid delivery arrangement 1200.

As shown in FIG. 57, the first connection conduit 1210 comprises a first fluid connection arrangement (a fluid inlet) 1211 and a second fluid connection arrangement (a fluid outlet) 1212. The first fluid connection arrangement 1211 of the first connection conduit 1210 provides a path for fluid to enter the fluid delivery arrangement 1200. The first fluid connection arrangement 1211 of the first connection conduit 1210 is connectable to a source of thermal management fluid 1006 e.g. the reservoir 1001 in coolant loop 1005. The second fluid connection arrangement 1212 of the first connection conduit 1210 provides a path for fluid to exit the fluid delivery arrangement 1200. The first fluid connection arrangement 1211 and the second fluid connection arrangement 1212 are substantially identical. In use, fluid may enter and/or exit the fluid delivery arrangement 1200 via either or both of the first fluid connection arrangement 1211 and second fluid connection arrangement 1212 of the first connection conduit 210.

The first fluid connection arrangement 1211 is provided at a first end 1213 of the first connection conduit 1210. The second fluid connection arrangement 1212 is provided at a second end 1214 of the first connection conduit, opposite the first end 1213. As will be appreciated the connection arrangement at either end of the first connection conduit 1210 can be used as a fluid inlet and/or fluid outlet.

The first connection conduit 1210 comprises a conduit wall 1215. The conduit wall 1215 has a regular cross section such that the cross section of the first connection conduit 1210 is substantially constant along the main or major axis A of the first connection conduit 1210. The main axis A of the first connection conduit 1210 extends along the length of the first connection conduit 1210 and is substantially parallel to the direction of fluid flow through the first connection conduit 1210 from the first fluid connection arrangement 1211 to the second fluid connection arrangement 1212.

The first fluid connection arrangement 1211 and second fluid connection arrangement 1212 of the first connection conduit 1210 both comprise flanges 1216. Each flange 1216 is a retaining arrangement for a seal 60. Each flange 1216 is a seal-receiving body comprising a channel 217. Each channel 217 is adapted to receive and retain part of a sealing arrangement 60 i.e. an o-ring 60. Each channel 217 has a predetermined depth suitable for receiving at least a retainable portion 603 of the o-ring 60.

As shown in FIG. 57, the second connection conduit 1220 comprises a first fluid connection arrangement (a fluid inlet) 1221 and a second fluid connection arrangement (a fluid outlet) 1222. The first fluid connection arrangement 1221 of the second connection conduit 1220 provides a path for fluid to enter the fluid delivery arrangement 1200. The first fluid connection arrangement 1221 of the second connection conduit 1220 is connectable to a source of thermal management fluid 1006 e.g. the reservoir 1001 in coolant loop 1005. The second fluid connection arrangement 1222 of the second connection conduit 1220 provides a path for fluid to exit the fluid delivery arrangement 1200. The first fluid connection arrangement 1221 and the second fluid connection arrangement 1222 are substantially identical. In use, fluid may enter and/or exit the fluid delivery arrangement 1200 via either or both of the first fluid connection arrangement 1221 and second fluid connection arrangement 1222 of the second connection conduit 1220.

The first fluid connection arrangement 1221 is provided at a first end 1223 of the second connection conduit 1220. The second fluid connection arrangement 1222 is provided at a second end 1224 of the second connection conduit, opposite the first end 1223. As will be appreciated the connection arrangement at either end of the second connection conduit 1220 can be used as a fluid inlet and/or fluid outlet.

The second connection conduit 1220 comprises a conduit wall 1225. The conduit wall 1225 has a regular cross section i.e. the cross section of the second connection conduit 1220 is substantially constant along the main or major axis A′ of the second connection conduit 1220. The main axis A′ of the second connection conduit 1220 extends along the length of the second connection conduit 1220 and is substantially parallel to the direction of fluid flow through the second connection conduit 1220 from the first fluid connection arrangement 1221 to the second fluid connection arrangement 1222. The main axis A′ of the second connection conduit 1220 is substantially parallel to the main axis A of the first connection conduit 1210.

The first fluid connection arrangement 1221 and second fluid connection arrangement 1222 of the second connection conduit 1220 both comprise flanges 1226. Each flange 1226 is a retaining arrangement for a seal 60. Each flange 1226 is a seal-receiving body comprising a channel 1227. Each channel 1227 is adapted to receive and retain part of a sealing arrangement 60 i.e. an o-ring 60. Each channel 1227 has a predetermined depth suitable for receiving a retainable portion 603 of the o-ring 60. As will be appreciated, the flanges 1216,1226 and channels 1217,1227 may be identical.

As shown in FIG. 58, the fluid delivery arrangement 1200 comprises a storage compartment 1250. The storage compartment 1250 is an integral storage compartment which is integrally formed in the front member 1202. The storage compartment 1250 is located between the first connection conduit 1210 and the second connection conduit 1220. The storage compartment 1250 is a sealable chamber which can store e.g. a slave board 51 of the battery management computer 50. The storage compartment 1250 comprises a peripheral wall 1251. The storage compartment 1250 comprises a plurality of pillars 1252 adapted to receive fixing means such as screws. A cover member 114 may be attached to the fluid delivery arrangement 1200 to seal the storage compartment. The storage compartment 1250 is sealable to prevent e.g. fluids entering the storage compartment 1250.

The fluid delivery arrangement 1200 comprises a plurality of distribution arrangements 1230a,1230b. Each distribution arrangement 1230a,1230b comprises a distribution aperture 1234a,1234b formed within a nozzle attachment portion 1235a,1235b. Each nozzle attachment portion 1235a,1235b comprises a recess portion 1236a,1236b. Each recess portion 1236a,1236b is an annular recess which extends around a distribution aperture 1234a,1234b. Each recess portion 1236a,1236b is adapted to receive part of a nozzle 501, in particular the raised portion 506 on the flange portion 504 of a nozzle 501. The recess portion 1236a,1236b allows the nozzle 501 to be accurately located with respect to the distribution aperture 1234a,1234b, and attached to the distribution arrangement 1200 at the correct location.

As shown in FIG. 59, lower panel, the rear member 1203 of the fluid delivery arrangement 1200 comprises a plurality of distribution apertures 1234a,1234b through which fluid can flow between the main chamber 1240 and the distribution arrangements 1230a,1230b. The rear member 1203 comprises eight distribution apertures 1234a,1234b and eight distribution arrangements 1230a,1230b. Each distribution arrangement 1230a,1230b is adapted to allow fluid to pass through said distribution arrangement 1230a,1230b and into and or out of a respective duct 141/duct assembly 500. In use, coolant is able to flow from the main chamber 1240, through each distribution aperture 1234a,1234b and into a duct 141/duct assembly 500/nozzle 501.

The fluid delivery arrangement 1200 comprises a plurality of first distribution arrangements 1230a, and a plurality of second distribution arrangements 1230b. As shown in FIG. 60, lower panel, the distribution apertures 1234a of the plurality of first distribution arrangements 1230a are aligned, and the distribution apertures 1234b of the plurality of second distribution arrangements 1230b are also aligned. The distribution apertures 1234a of the plurality of first distribution arrangements 1230a are not in alignment with the distribution apertures 1234b of the plurality of second distribution arrangements 1230b. The distribution apertures 1234a of the plurality of first distribution arrangements 1230a are offset with respect to the distribution apertures 1234b of the plurality of second distribution arrangements 1230b.

Each distribution aperture 1234a,1234b is of equal length. Each distribution aperture 1234a,1234b extends part of the height of the aperture portion 1235a,1235b. Each distribution aperture is in fluid communication with either the first connection conduit 1210 or the second connection conduit 1220 such that fluid passing into the fluid distribution arrangement 200 via a conduit 1210,1220 can be distributed to a subset of distribution apertures 1234a,1234b.

Each first distribution arrangement 1230a comprises a distribution aperture 1234a formed within a nozzle attachment portion 1235a and recess portion 1236a. The distribution aperture 1234a in each first distribution arrangement 1230a does not extend the full height of the respective aperture portion 1235a. Each distribution aperture 1234a in each first distribution arrangement 1230a extends along a part of the height of the respective aperture portion 1235a. The aperture portion 1235a of each first distribution arrangement 1230a comprises a blanking portion 1237a adjacent to the aperture portion 1234a. Where the aperture 1234a allows fluid to pass through the first distribution arrangement 1230a, the blanking portion 1237a is a solid area which prevents fluid passing through part of the first distribution arrangement 1230a, in particular part of the aperture portion 1235a.

Each second distribution arrangement 1230b comprises a distribution aperture 1234b formed within a nozzle attachment portion 1235b and a recess portion. The distribution aperture 1234b in each second distribution arrangement 1230b does not extend the full height of the respective aperture portion 1235b. Each distribution aperture 1234b in each second distribution arrangement 1230b extends along a part of the height of the respective aperture portion 1235b. The aperture portion 1235b of each second distribution arrangement 1230b comprises a blanking portion 1237b adjacent to the aperture portion 1234b. Where the aperture 1234b allows fluid to pass through the second distribution arrangement 1230b, the blanking portion 1237b is a solid area which prevents fluid passing through part of the second distribution arrangement 1230b, in particular part of the aperture portion 1235b.

The first distribution apertures 1234a of the fluid delivery arrangement 1200 are aligned. Each first distribution aperture 1234a is in fluid communication with the first connection conduit 1210 via the first sub-chamber 1245a. Fluid passing into the fluid distribution arrangement 1200 via the first connection conduit 1210 is distributed to the first distribution apertures 1234a evenly. Similarly, the second distribution apertures 1234b of the fluid delivery arrangement 1200 are aligned. Each second distribution aperture 1234b is in fluid communication with the second connection conduit 1220 via the second sub-chamber 1245b.

The blanking portions 1237a of each first distribution arrangement 1230a are on the opposite side of the rear member 1203 to the blanking portions 1237b of each second distribution arrangement 1230b. In the view of FIG. 59, where the blanking portions 1237a of each first distribution arrangement 1230a are on the ‘upper side’ of the rear member 1203, the blanking portions 1237b of each second distribution arrangement 1230b are on the ‘lower side’ of the rear member 1203.

As shown in FIG. 60, the distribution aperture 1234a of each first distribution arrangement 1230a is located on one side of the dividing wall 1244 and the distribution aperture 1234b of each second distribution arrangement 1230b is located on the opposite side of the dividing wall 1244. Each blanking portion 1237a,1237b coincides with the position of the dividing wall and forms a seal with the dividing wall 1244.

The distance between neighbouring distribution arrangements 1230a,1230b may correspond to the width of one or more cells, see FIG. 80. In such example embodiments ducts 141 may be provided on one side of each cell 120 in battery module 10. These embodiments are illustrated in FIGS. 85 and 86. FIGS. 78 to 84 illustrate the fluid delivery arrangement designed to allow this level of redundancy. FIG. 80 illustrates that there are eight first distribution arrangements 1230a and seven second distribution arrangements 1230b located on the opposite side of the dividing wall 1244, see FIG. 84.

The distance between neighbouring distribution arrangements 1230a,1230b may correspond to the width of a cell. In such example embodiments ducts 141 may be provided on both sides of the cell. This can provide redundancy i.e. if the duct 141 on one side of the cell bursts or fails then the duct on the other side of the cell can be used to thermally manage the cell as illustrated in FIGS. 85 and 86.

When the fluid delivery arrangement 1200 is used in the thermal management arrangement 140 of a battery module 10, each distribution arrangement 1230a,1230b is directly attached to a nozzle 501 of a duct assembly 500. Each duct assembly 500 is connected to two fluid delivery arrangements 1200 via nozzles 501, each nozzle 501 being attached in a fluid-tight manner to a distribution arrangement 1230a,1230b. Each nozzle 501 can be welded to the rear member 1203 of the fluid distribution arrangement 1200. Particularly, the raised portion 506 on the flange portion 504 of a nozzle 501 is located within a recess portion 1236a,1236b and the flange 504 of the nozzle is welded to the nozzle attachment portion 1235a,1235b. Attachment in this way provides a fluid-tight connection between the nozzle 501 and rear member 1203 of the fluid distribution arrangement 1200. A clamping assembly is ideally located over the join between the duct 141 and nozzle 501 to reinforce the join and to prevent leaks.

In use, the first connection conduit 1210 and second connection conduit 220 are used to transport fluid to and/or from the main chamber 1240. Each fluid connection arrangement 1211,1221,1212,1222 is open so that fluid can pass into and out of the main chamber 1240 via the first connection conduit 1210 and second connection conduit 1220. Each distribution arrangement 1230a,1230b has an aperture which is in fluid communication with the main chamber 1240. Fluid passing into the fluid distribution arrangement 1200 via the first connection conduit 1210 is distributed to the first distribution apertures 1234a evenly. Fluid passing into the fluid distribution arrangement 1200 via the second connection conduit 1220 is distributed to the second distribution apertures 1234b evenly.

When employed within battery pack 1, each fluid delivery arrangement 200,1200 provides a means by which a thermal management fluid 1006 can be distributed within the battery pack 1, particularly to each battery module 10, in order to thermally manage the cells 120. Each fluid delivery arrangement 200,1200 is a header tank which, in use, is operably connected to a plurality of ducts 141 within a battery module 10 and is also operably connected to one or more further fluid delivery arrangements 200 of the other battery modules 10 within the battery pack 1.

Each fluid delivery arrangement 200,1200 can be fluidly connected to one or more further fluid delivery arrangements 200,1200. FIG. 61 shows in detail a cross section of the connection between two fluid delivery arrangements 200. Two fluid delivery arrangements 1200 can be fluidly connected in a similar manner.

FIG. 61 shows a battery module sub assembly 3 comprising a battery module 10 and a further battery module 10′. The battery module 10 is fluidly connected to the further battery module 10′. Each first and second connection conduit 210,220 of the battery module 10 is connected to the corresponding first and second connection conduits of the further battery module 10′.

The detail of FIG. 61 shows the fluid connection between a fluid delivery arrangement 200 of the first battery module 10 and a fluid delivery arrangement 200′ of the second battery module 10′. The first connection conduits 210,210′ are connected via sealing members 60, and similarly the second connection conduits (not shown) are also connected via sealing members 60. When connected in this way the main chambers of the fluid delivery arrangements 200,200′ are in fluid communication with each other. Sealing members 60 are used to seal the interfaces between the fluid connection arrangements of neighboring connection conduits 210,210′. Together, the joined connection conduits 210,210′ and seals 60 provide a sealed structure for transporting a thermal management fluid within the battery pack 1.

The detail of FIG. 61 also shows the fluid connection between a fluid delivery arrangement 200 of the first battery module 10 and a multiport fluid connector 700. The first connection conduits 210 of the fluid delivery arrangement 200 is connected to a branch port 705 of the multiport fluid connector 700 via a sealing member 60. Similarly the second connection conduit 210 of the fluid delivery arrangement 200 is connected to another branch port 706 of the multiport fluid connector 700 via a sealing member 60.

FIGS. 62 and 63 show in detail a sealing member 60 for providing a seal between fluid conduits in a battery pack 1 and/or between battery modules 10. The sealing member 60 comprises a deformable annular body 601. The body 601 comprises first and second elongate side portions 604a,604b, and first and second shortened side portions 605a,605b. The cross-sectional shape of the body 601 comprises a central portion 602 located between first and second retainable portions 603a,603b. By cross-sectional shape it is meant the shape of the body 601 when viewed in cross-section, in particular the cross section when cutting through the body in the X-Z plane (see FIGS. 64 and 65, central panels). The cross-sectional shape of the body 601 is constant throughout the body, particularly along the entire length of each side portion 604a,604b,605a,605b. The cross-sectional width of the central portion 602 (corresponding to the cross-sectional width of the elongate side portions 604a,604b along the X-axis direction) is greater than the cross-sectional width of each retainable portion 603a,603b.

The sealing member 60 is an o-ring. The unitary body 601 is made from soft silicone or other suitable resilient material, such as rubber. The purpose of the sealing member 60 is to seal the interfaces between interconnected fluid-carrying conduits within the battery pack 1, and to prevent fluid leaks. The present application requires the sealing member 60 to have an appropriate hardness. Softer sealing materials, with lower shore A hardness readings, will flow more easily into gaps, grooves and imperfections between mating parts (flanges 216) and may be extruded or blown through such gaps, resulting in seal failure. While harder materials with higher shore A hardness ratings will offer greater resistance to extrusion, they will also require larger compressive forces for sealing. It has been found that the deformable body 601 should ideally have a shore A hardness of less than 50 and greater than 15. In some preferred embodiments the deformable body 601 has a shore A hardness of between 30 and 40. In the most preferred embodiments the deformable body has a shore A hardness of between 33 and 37, particularly 35.

As shown in the side views of FIGS. 64 and 65 (upper panels) body 601 comprises a central portion 602 located between two retainable portions 603a,603b. The retainable portions 603a,603b are adapted to be located and retained within a retaining member, for example the channels 217 formed in the flanges 216 of the fluid delivery arrangement 200. The central portion 602 is adapted to expand or widen under compressive force, thereby sealing a gap or space between e.g. two retaining members.

As shown in the cross-sectional views of FIGS. 64 and 65 (central panels) the cross-sectional shape of each retainable portion 603a,603b comprises two substantially straight edge portions 613 joined by a curved and/or semicircular edge portion 623. The central portion 602 comprises two curved and/or semicircular edge portions 623. When squeezed or otherwise deformed under a compressive force (acting along the Z axis), the edge portions 612,622 become bowed and move apart from each such that the width of the central portion 602 increases.

As shown in the top views of FIGS. 64 and 65 (lower panels) the sealing member body 601 is substantially rectangular comprising four substantially straight side portions 604a,604b,605a,605b that are joined by corner portions 606a-d. Opposing side portions, for example the elongate side portions 604a,604b, are substantially parallel and are of equal length. Each side portion 604a,604b,605a,605b is joined to a neighbouring side portion by a smooth corner portion 606a-d. The substantially rectangular body 601 comprises two elongate side portions 604a,604b (extending along the Y-axis direction), two short side portions 605a,605b (extending along the X-axis direction) and four corner portions 606a-d. The substantially rectangular shape of the body 601 corresponds to the shape of the retainment channels 217 in the flanges 216.

FIG. 64 shows the sealing member 60 in its undeformed state 60a. The undeformed state shown in FIG. 64 is the default state of the sealing member 60, representing the shape that the sealing member 60 adopts when no forces, such as compressive forces, are applied to the sealing member 60.

FIG. 65 shows the sealing member 60 in its in-use deformed state 60b. The deformed state shown in FIG. 65 represents the shape that the sealing member 60 adopts when a longitudinal compressive force is applied to the sealing member 60. The longitudinal compressive force is applied along a direction that is parallel to the direction between the retainable portions 603a,603b, i.e. parallel to axis Z shown in FIGS. 64 and 65 (central panels).

In use, the sealing member 60 is used as a seal and a compressive force is applied to the sealing member 60. The retainable portions 603a,603b are located and retained within retaining members, e.g. the channels 217 in the flanges 216 of the fluid delivery arrangement 200. A compressive force is applied to the sealing member 60. This force acts to push the retainable portions 603a,603b together, along a direction that is parallel to the axis Z shown in FIGS. 64 and 65 (central panels). The sealing member 60 enters the deformed state when it is located within and squeezed between first and second retaining arrangements, e.g. the channels 217 of neighbouring fluid delivery arrangements 200. In the deformed state shown in FIGS. 63 and 65, the central portion 602 has an increased cross-sectional width. The cross-sectional width of the central portion 602 in the deformed state 60b is greater than the cross-sectional width of the central portion 602 in the undeformed state 60a. The cross-sectional width of the retainable portions 603a,603b in the deformed stated is substantially the same as the cross-sectional width of the retainable portions 603a,603b in the undeformed state, due to the fact that these portions are held within the channels 217 and are prevented from expanding or widening in a similar manner. The increased width of the central portion 602 in the deformed state allows the sealing member 60 to accommodate any slight differences in size/dimensions of the respective channels/flanges of the fluid delivery arrangements 200 between which the sealing member 60 is retained.

In the most preferred embodiments, in the undeformed state the cross-sectional width of the central portion is 2.8 mm and the cross-sectional width of each retainable portion is 1.8 mm. In the undeformed state the cross-sectional height of the sealing means is 18 mm. In the deformed state the cross-sectional width of the central portion is greater than 2.8 mm, most preferably 4.4 mm, and the cross-sectional width of each retainable portion is 1.8 mm. In the deformed state the cross-sectional height of the sealing means is less than 18 mm, most preferably 14.4 mm.

FIGS. 66-69 show a multiport fluid connector 700 for connecting a fluid distribution arrangement 200,1200 to e.g. a source of thermal management fluid. The multiport fluid connector 700 is a fluid connector adapted to fit within a predetermined volume. The multiport fluid connector 700 is a low-profile fluid connector having a limited height H. The multiport fluid connector 700 is adapted to split/combine the flow of fluid therethrough while minimising the creation of swirl components and pressure drop over a limited distance.

The multiport fluid connector 700 comprises a body 701, a primary port 704 and two branch ports 705,706. The multiport fluid connector 700 further comprises an internal chamber 710. The primary port 704 is in fluid communication with the branch ports 705,706 via the internal chamber 710.

The body 701 is a two-part body comprising a first body member 702 and a second body member 703. The first body member 702 and second body member 703 are preferably made from a plastic material and may be formed via injection moulding techniques. The first body member 702 and second body member 703 may be joined using plastic welding or other suitable techniques.

The first body member 702 comprises the primary port 704 and part of the wall 711 of the internal chamber 710. The primary port 704 comprises a tubular member which is fluidly connected to the internal chamber 710 at or near the centre of the internal chamber 710. The first body member 702 comprises a neck portion 707. As shown in the cross sectional view of FIG. 69, the neck portion 707 is located at the end of the tubular primary port 704 adjacent to the internal chamber 710.

As shown in FIG. 68, the first body member 702 comprises a principal raised portion 709 and two secondary raised portions 718,719. Each raised portion 709,718,719 is a protrusion which extends into the internal chamber 710. The principal raised portion 709 is adjacent to the primary port 704. The principal raised portion 709 is located between the branch ports 705,706. The two secondary raised portions 718,719 are located on either side of the primary port 704. The principal raised portion 709 is located on the opposite side of the internal chamber 710 to the two secondary raised portions 718,719. The shaping of the walls, particularly the raised portions 709,718,719, are adapted to guide the flow of fluid through the internal chamber 710. The raised portions 709,718,719 is adapted to reduce the pressure drop and swirl components in the internal chamber 710.

The second body member 703 comprises the two branch ports 705,706 and part of the wall 711 of the internal chamber 710. Each branch port 705,706 comprises a tubular member which is fluidly connected to the internal chamber 710 at or near an edge of the internal chamber 710.

As shown in FIG. 69, the second body member 703 comprises a further raised portion 708. The further raised portion 708 is a protrusion which extends into the internal chamber 710. The further raised portion 708 is located between the branch ports 705,706 and opposite the tubular primary port 704. The shaped wall, particularly the raised portion 708 opposite the T-junction, guides the flow split to reduce the pressure drop in this region of the internal chamber 710. The further raised portion 710 is adapted to reduce the pressure drop and swirl components in the internal chamber 710

Each branch port 705,706 comprises a flange 716. Each flange 716 is a retaining arrangement for a seal 60. Each flange 716 is a seal-receiving body comprising a channel 717. Each channel 717 is adapted to receive and retain part of a sealing arrangement 60 i.e. an o-ring 60. Each channel 717 has a predetermined depth suitable for receiving at least a retainable portion 603 of the o-ring 60. The flanges 716 and channels 717 are similar to the flanges 216 and channels 217 of the fluid delivery arrangement 200,1200 described above.

The distance between the branch ports 705,706 corresponds to the distance between the first connection conduit 210,1210 and second connection conduit 220,1220 of the fluid delivery arrangements 200,1200. The branch ports 705,706 are symmetrically located on either side of the primary port 704 i.e. the branch ports 705,706 are equidistant from the primary port 704.

The shape of the internal chamber 710 is shown in FIGS. 70 and 71. The internal chamber 710 comprises a main conduit portion 720 and two branch conduit portions 721,722. The internal chamber 710 further comprises a flow partition portion 723 and two corner connection portions 723,724. The flow partition portion 723 provides a fluid communication path between the main conduit portion 720 and each corner connection portion 723,724. Each cornering portion 723,724 provides a fluid communication path between the flow partition portion 723 and a branch conduit portion 721,722. In the flow partition portion 723 the fluid flow is able to pass between the main conduit portion 720 and the two corner connection portions 723,724, in use.

The main conduit portion 720 comprises a narrowed portion 725. The position of the narrowed portion 725 corresponds the position of the neck portion 707 of the first body member 702.

The flow partition portion 723 connects the main conduit portion 720/narrowed portion 725 and the cornering portions 723,724/branch conduit portions 721,722. The flow partition portion 723 allows the splitting and/or recombining of fluid flow while minimising the pressure drop and swirl components in this region. The position of the flow partition portion 723 corresponds to the position of the raised portion 708 of the second body member 703 and the principal raised portion 709 of the first body member 702. The geometrically-induced secondary rotational flow aids in reducing the recirculation at the bend ideally the 90 Deg bend; thereby, resulting in a more even flow distribution. Also, the shaped wall opposite the generally T-junction guides the flow split to reduce the pressure drop in this region.

In use, the multiport fluid connector 700 is adapted to connect the fluid distribution arrangement 200,1200 to e.g. a source of thermal management fluid. Fluid can flow in either direction through the multiport fluid connector 700. For example, fluid may flow into the multiport fluid connector 700 via the primary port 704, into the main conduit portion 720, through the flow partition portion 723, each corner connection portion 723,724 and each branch conduit portion 721,722, and out of the multiport fluid connector 700 via the branch ports 705,706. Alternatively, fluid may flow into the multiport fluid connector 700 via one or both branch ports 705,706, through each branch conduit portion 721,722, through each corner connection portion 723,724 and the flow partition portion 723 and the main conduit portion 720, and out of the multiport fluid connector 700 via the primary port 704.

FIGS. 72 and 73 disclose exploded views of a multiport fluid connector 700 and a holding plate 33. The holding plate 33 can be used to retain and hold the multiport fluid connector 700 in a battery module sub assembly 3 such that the branch ports 705,706 are in fluid communication with the first and second fluid connection conduits 210,220,1210,1220 of a peripheral fluid delivery arrangement 200,1200 (c.f. FIGS. 13 and 14).

The holding plate 33 comprises a main planar portion 331 and three attachment portions 332,333. The main planar portion 331 is adapted to engage with and press against the multiport fluid connector 700, in particular the first body member 702, in use. The first body member 702 can be attached to the holding plate 33 via fixing arrangements such as screws 741. The screws 741 are screwed into threaded holes 335 in the main planar portion 331 of the holding plate 33 to attach the body member 702 to the holding plate 33. The screws 741 pass through retainment portions 740 which protrude from the first body member 702. The primary port 704 passes through a port aperture 334 in the main planar portion 331. Each attachment portion 332,333 extends from the main planar portion 331. Each attachment portion 332,333 comprises a plurality of apertures 336 for receiving a fixing arrangement such as a screw or bolt for fixing the holding plate to another component such as a fluid delivery arrangement 200,1200.

Manufacture of the battery pack 1 comprises forming the battery modules 10, forming the battery module sub-assembly 3, installing the battery module sub-assembly 3 in the battery pack housing 2 and sealing the battery pack housing 2.

When forming the battery modules 10, an appropriate number of cells 120 are chosen and are located within the receiving formations 182 in the cell arrangement members 180. The cells 120 form an array. A thermal management system 140 comprising two fluid delivery arrangements 200,1200 and one or more ducts 141/duct assemblies 500 attached thereto is provided. The thermal management system 140 is located such that the ducts 141 are located between adjacent rows of cells 120 in the array. Non-planar busbars 400 are located on either side of the array of cells. One or more planar busbars are located over the array of cells. The busbars are electrically connected to the cells via wires. Housing members are provided to cover the internal components of the battery pack, such as the busbars and cells. The or each duct 141 is inflated with a fluid and a potting material is poured into the pack. The potting material is allowed to set, cure or harden.

When forming the battery module sub-assembly 3, an appropriate number of battery modules 10 are provided. The battery modules are interconnected, for example by being stacked and mechanically coupled to one another using the battery module support arrangement 30. The respective fluid delivery arrangements 200 and multiport fluid connectors 700a,700b are aligned and interconnected. Holding plates 33 are located over the multiport fluid connectors 700a,700b to hold them in place. Electrical busbars (not shown) are connected between each battery module.

Once the battery module sub assembly 3 is ready to be inserted into the housing 2, the battery module sub assembly 3 is moved into the housing 2 through the aperture 24 and towards the base wall 28a until the inlet and outlet conduits 65,66 are in alignment with apertures 29a,29b in the end wall 27a. Once the conduits 65,66 and apertures 29 are suitably aligned, the inlet and outlet adapters 63,64 are secured to the conduits 65,66 and end wall 27a. The adapters 63,64 may be threaded and are tightened until the junction between the components is fluid tight. Suitable electrical connections are made between the battery module sub assembly and the battery pack management system 5/end enclosure 23. The cover member is placed over the aperture 24 and sealed.

The battery pack 1 can be mounted to e.g. a chassis or other support structure. Fastening arrangements such as screws, nuts and/or bolts are used to attach the battery pack to a support structure via the mounting arrangements 4.

As will be understood by the skilled person, the example embodiments presented above can be modified in a number of ways without departing from the scope of the invention. For example, the battery modules 10 can have any suitable length, width, height and/or number of cells 120. The battery module sub assembly 3 can include any appropriate number of specifically designed battery modules 10 for the particular application required. The or each busbar may be made from any suitable material such as aluminium or steel.

When adjusting the size of the battery modules 10 only a subset of the components need to be specifically engineered to allow packs having different lengths and number of cells. A battery module 10 can be constructed having arbitrary length by adjusting the sizes of the housing members, busbars and ducts while keeping a fixed width and height.

The battery pack housing 2 may include a potting material 130 which holds e.g. the battery module sub-assembly 3 in place and/or supports and locates components within the battery housing 2. The battery modules 10 can be connected in a plurality of configurations in order to satisfy a particular set of design requirements. For example, some or all of the battery modules 10 can be electrically connected in series or parallel and/or the fluid connections can be made in series or parallel.

Each battery module may include any suitable number of sensors, such as any combination of temperature sensors, strain sensors, pressure sensors, volatile organic compound (VOC) sensors, carbon monoxide (CO) sensors, carbon dioxide (CO2) sensors, smoke sensors, leak detectors, acceleration sensors, microelectromechanical systems (MEMS) sensors, voltage, heat and moisture detection sensors.

In the preceding discussion of the invention, unless stated to the contrary, the disclosure of alternative values for the upper or lower limit of the permitted range of a parameter, coupled with an indication that one of the values is more highly preferred than the other, is to be construed as an implied statement that each intermediate value of the parameter, lying between the more preferred and the less preferred of the alternatives, is itself preferred to the less preferred value and also to each value lying between the less preferred value and the intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

1. A battery pack comprising: a battery module sub assembly comprising one or more battery modules, wherein two or more of the battery modules in the battery module sub assembly are electrically interconnected and wherein two or more of the battery modules in the battery module sub assembly are fluidly interconnected so that a fluid is able to flow through the battery module sub assembly; a thermal management means for thermally managing one or more cells within the battery pack, battery module sub assembly or battery module, the thermal management means comprising one or more thermal management ducts; a battery pack management means for monitoring and/or controlling the operation of the battery pack; a battery pack fluid connection means for connecting the one or more thermal management ducts to a source of thermal management fluid, wherein the or each thermal management duct is flexible and/or inflatable; and a battery pack electrical connection means for electrically connecting the battery pack to an external load, the battery pack being modular.

2. A battery pack as claimed in claim 1, wherein the battery pack comprises a battery pack housing, the battery pack housing comprises a lower case member and a cover member, the lower case member comprises one or more apertures and the lower case member comprises a cavity for receiving one or more battery modules and/or for receiving a battery module sub assembly.

3. A battery pack as claimed in claim 1, wherein the battery pack comprises the battery pack fluid connection means comprising a battery pack fluid inlet and a battery pack fluid outlet and a thermal management means of the or each battery module in the battery pack being in fluid communication with the battery pack fluid connection means.

4. A battery pack as claimed in claim 1, wherein the battery pack has an inlet-side fluid delivery means of each battery module being in fluid communication with an inlet-side fluid delivery means of at least one other battery module, an outlet-side fluid delivery means of each battery module being in fluid communication with an outlet-side fluid delivery means of at least one other battery module.

5. A battery pack as claimed in claim 1, wherein the battery pack fluid connection means is adapted to allow the battery pack to be operably connected to a thermal management system, the thermal management system comprises a source of thermal management fluid, a reservoir for containing the thermal management fluid, a heat exchanger and a pump, the thermal management system further comprising a coolant loop and a pressure sensor, the pressure sensor being adapted to monitor the pressure in the thermal management system, particularly the coolant loop.

6. A battery pack as claimed in claim 1, wherein the battery pack fluid connection means comprises a battery pack fluid inlet comprising an inlet adapter and an inlet conduit so that fluid is able to enter the battery pack via the inlet adapter and inlet conduit, the battery pack fluid connection means further comprising a battery pack fluid outlet comprising an outlet adapter and an outlet conduit so that fluid is able to exit the battery pack via the outlet adapter and outlet conduit, the battery pack fluid inlet and the battery pack fluid outlet are in fluid communication with one another via the or each battery module.

7. A battery pack as claimed in claim 6, wherein the inlet conduit and the outlet conduit comprises a first end and a second end, the first end of the inlet conduit and/or the first end of the outlet conduit is connectable to one or more battery modules, the second end of the inlet conduit and/or the second end of the outlet conduit is substantially flat and comprises a generally square locating member, the locating member being locatable in a retaining means, the retaining means being located on the inside of a battery pack housing so that the locating means can be reliably and accurately located during manufacture of the battery pack, the inlet conduit being operably connected to a main fluid inlet of one or more battery modules and the outlet conduit being operably connected to a main fluid outlet of one or more battery modules.

8. A battery pack as claimed in claim 1, wherein the battery pack comprises an electrical connection means for electrically connecting the battery pack to an external load such as a motor or other electrical component of a vehicle, machine or piece of industrial apparatus, the electrical connection means comprising positive and negative battery pack terminals provided by electrical adapters.

9. A battery pack as claimed in claim 8, wherein the battery pack comprises an end enclosure, the end enclosure comprises a status indication means, the end enclosure further comprises one or more communication ports, the end enclosure further comprises one or more internal electrical connectors, the internal electrical connectors are adapted to pass through a battery pack housing and connect the end enclosure, particularly the circuitry held within the end enclosure, to the terminals of the battery module sub assembly/battery modules.

10. A battery pack as claimed in claim 1, wherein the battery module sub assembly comprises a main fluid inlet and a main fluid outlet, the battery module sub assembly comprises an inlet-side multiport fluid connector and an outlet-side multiport fluid connector so that a fluid is able to flow through the battery module sub assembly via the main fluid inlet, the battery modules and the main fluid outlet wherein at least some or all of the fluid connections between battery modules are parallel or series fluid connections.

11. A battery pack as claimed in claim 1, wherein the two or more of the battery modules in the battery module sub assembly are electrically interconnected in parallel or series, the battery module sub assembly comprises one or more intermodule busbars wherein two or more battery modules are connected via intermodule busbars, the positive side of at least one battery module is connectable to a negative side of a neighboring battery module via one or more intermodule busbars, the or each intermodule busbar is a planar electrically-conductive member.

12. A battery pack as claimed in claim 1, wherein the battery module sub assembly comprises two peripheral battery modules, each peripheral battery module is located at an outer peripheral edge of the battery module sub assembly, the battery module sub assembly comprises positive and negative terminal busbars and the peripheral battery modules are connectable to positive and negative battery pack terminals, the positive terminal of the battery pack is electrically connected to a first peripheral battery module a via a positive terminal busbar and the negative terminal of the battery pack is electrically connected to a peripheral battery module via a negative terminal busbar.

13. A battery pack as claimed in claim 1, wherein the battery pack comprises a manual disconnection means operable as a manual service disconnect comprising a switch, the manual disconnection means is configured to electrically disconnect two groups of battery modules within the battery pack and/or the manual disconnection means is configured to disable terminals of the battery pack.

14. A battery pack as claimed in claim 1, wherein the battery pack comprises a support means and wherein the battery module sub assembly comprises a support means wherein the battery modules in the battery module sub assembly are mechanically coupled to each other via the support means, the support means comprises two end face support members located at the peripheral ends of the battery module sub assembly and the support means comprises four elongate corner support members adapted to receive the corners of a plurality of battery modules, each end face support member being connected to the corresponding corner support members.

15. A battery pack as claimed in claim 14, wherein the support means comprises one or more holding means for attaching and securing the multiport fluid connectors to the battery module sub-assembly, the holding means comprises a main planar portion, the main planar portion is adapted to engage with and press against the multiport fluid connector, in use, the main planar portion comprising a port aperture wherein a primary port of the multiport fluid connector passes through the port aperture in the main planar portion.

16. A battery pack as claimed in claim 2, wherein the battery pack comprises a housing and a battery module sub-assembly, wherein the battery module sub assembly is at least partly located inside the housing and wherein the battery module sub assembly is mechanically connected to at least one mounting means so that the mounting means is able to transfer the weight of the battery module sub assembly to a further component such as an external chassis or supporting structure.

17. A battery pack as claimed in claim 16, wherein the or each mounting means is accessible through the battery pack housing, wherein the or each mounting means provide mechanical connection points on the exterior of the battery pack, the mounting means being accessible from the exterior of the battery pack housing, the mounting means being adapted to transfer the weight of the battery module sub assembly directly to a component outside the housing.

18. A battery pack as claimed in claim 1, wherein the battery module is connectable to one or more further identical battery modules, the battery module comprising a battery module housing wherein electrical and/or fluid connections can be made to the battery module through a recess or aperture in the housing, the battery module comprises at least one cell a plurality of cells arranged in a regular array, each cell being electrically connected to a busbar.

19. A battery pack as claimed in claim 1, wherein each battery module comprises at least one cell arrangement means for supporting and locating a plurality of cells, the cell arrangement means being a plate, the cell arrangement means comprises a plurality of receiving formations, the receiving formation being adapted for receiving and locating an end of a cell, the receiving formations being arranged in a close-packed hexagonal or honeycomb pattern so that a minimum separation between the cells is predetermined.

20. A battery pack as claimed in claim 1, wherein the battery module comprises one or more sensing means being used to measure parameters of the cells, the sensing means being located on a flexible carrier being a flexible PCB attachable to a duct, the sensing means being located between a thermal management duct and one or more cells comprising one or more sensors comprising pressure sensors, temperature sensors, voltage sensors and/or liquid/moisture sensors mounted in arrays on the flexible carrier so as to allow the performance and physical characteristics of the battery pack to be mapped, as well as determining the differentials of quantities throughout the pack so that fluid flow rates and temperature change rates can be inferred/predicted.

21. A battery pack as claimed in claim 1, wherein the battery module comprises a battery module electrical connection means for providing electrical connections between the battery module and a component such as a further battery module, a busbar, an interconnect and/or an external load, the battery module electrical connection means comprises one or more busbars, the battery module electrical connection means comprising positive and negative terminals located on the opposing side walls of a battery pack housing.

22. A battery pack as claimed in claim 1, wherein a busbar for a battery module and/or a battery pack comprises an electrical connection portion and at least one structural support means, the busbar being dual-purpose in that it provides a means by which electrical connections can be made within a battery module and/or a battery pack, as well as providing additional structural support and mechanical strength to the battery module and/or a battery pack.

23. A battery pack as claimed in claim 22, wherein the busbar for a battery module and/or a battery pack comprises a cell connection portion and an external connection portion, wherein the cell connection portion is disposed at an angle to the external connection portion, wherein the construction of the busbar allows electrical contact to be made between one or more cells within a battery pack or module and an external component, the busbar further comprising an electrical connection portion being adapted for electrically interconnecting one or more cells and one or more further components such as a further busbar, a terminal, an interconnect and/or an external load.

24. A battery pack as claimed in claim 22, wherein the busbar comprises at least one structural support means, the or each structural support means is adapted for retaining the electrical connection portion in position within a battery module, and/or for providing structural support to the battery module, the structural support means allowing multiple battery modules to be aligned and stacked, the or each structural support means is locatable at a peripheral end of an electrical connection portion comprising a body portion made from a non-conductive material such as plastic, the or each structural support means being over moulded on the electrical connection portion.

25. A battery pack as claimed in claim 1, wherein the or each battery module comprises a thermal management means for thermally managing the one or more cells, the thermal management means being configured to allow fluid connections to be made to the battery module in a plurality of locations and/or orientations, the thermal management means comprises an inlet-side fluid delivery means and an outlet-side fluid delivery means, the thermal management means comprising one or more substantially parallel, flexible and/or inflatable thermal management ducts.

26. A battery pack as claimed in claim 25, wherein the or each thermal management duct comprises one or more thermally conductive additives for improving the thermal conductivity of the duct material, the thermally conductive additives comprising particles of a thermally conductive filler material.

27. A battery pack as claimed in claim 25, the or each thermal management duct comprises a matrix material and a thermally conductive filler material, the matrix material comprises the inflatable plastics material such as polyethylene (PE), low-density polyethylene (LDPE), linear low-density polyethylene (LLDPE) or high-density polyethylene (HDPE) and wherein the thermally conductive filler comprises any one of or any combination of a carbon-based filler material such as carbon, carbon black, graphite, graphene, multi-walled carbon nanotubes or single-wall carbon nanotubes or the thermally conductive filler comprises an inorganic filler material or a ceramic filler material or the thermally conductive filler comprises aluminium oxide, silicon carbide, boron nitride, silicon nitrate, alumina, aluminium nitride or zinc oxide.

28. A battery pack as claimed in claim 1, wherein the or each battery module comprises a potting means, the potting means being substantially rigid such that it secures the cells and the thermal management ducts in position within the battery module wherein the potting means is adhesively attached to the or each duct providing total external support to the or each duct, the potting means preventing excessive expansion and/or bursting of the or each duct, the potting means maintaining each duct in an open configuration such that fluid is able to flow easily through the or each duct, the potting means being a thermally insulating potting material such as intumescent polyurethane foam.

29. A battery pack as claimed in claim 1, wherein there is provided a duct assembly comprising a duct, at least one nozzle and at least one duct clamping means, wherein the nozzle is attached to the duct and wherein the duct clamping means is adapted to clamp the duct to the nozzle, the duct assembly being provided in a battery module to enable the thermal management of one or more cells, the or each duct clamping assembly ensures that there is a fluid-tight connection between the duct and a respective nozzle thereby preventing leaks from developing at the respective nozzle-duct interface.

30. A battery pack as claimed in claim 29, wherein the nozzle comprises a nozzle body with an aperture passing through the nozzle body so that fluid is able to pass through the nozzle body via the aperture, the nozzle body comprises a flange portion and an attachment portion, the attachment portion being located within the open end of the duct wherein the duct is heat welded at the open end thereof to the attachment portion of the nozzle.

31. A battery pack as claimed in claim 29, wherein the duct clamping assembly comprises a bearing member and first and second securement members, the duct clamping assembly further comprising a biasing member, wherein the securement members and the bearing member are made from an insulating plastics material, or a metal such as aluminium, the biasing member being formed from a resilient material, such as steel wire whereby in use the duct clamping assembly bears and pushes against the open end of the duct and the nozzle, the duct also being joined to the attachment portion of the nozzle at the open end of the duct via welding, wherein the duct clamping assembly reinforces the join between the open end of the duct and the attachment portion of the nozzle acting to prevent leaks developing at the interfaces between the duct and the nozzle.

32. A battery pack as claimed in claim 1, wherein there is provided a fluid delivery means for delivering a thermal management fluid to the one or more thermal management ducts, wherein the fluid delivery means comprises a plurality of paths for fluid to pass into and/or out of the fluid delivery means, the fluid delivery means providing a means by which fluid can be distributed within a battery pack to thermally manage multiple cells.

33. A battery pack as claimed in claim 32, wherein the fluid delivery means comprises a first and a second connection conduit adapted to provide a path for fluid into and/or out of the fluid delivery means, the fluid delivery means comprising a body formed of front and rear members, the first connection conduit and second connection conduit forming part of the front member, the fluid delivery means comprising a main chamber enclosed by the front and rear member, the rear member of the body comprising one or more distribution means, the front and rear members being sealably attached to one another, the fluid delivery means being a header tank.

34. A battery pack as claimed in claim 32, wherein the or each fluid delivery means is operably connected to a plurality of ducts and/or duct assemblies, wherein the or each fluid delivery means, in use, is operably connected to one or more further fluid delivery means, wherein the first and/or second connection conduit provides a fluid path into and/or out of a main chamber, wherein the first and/or second connection conduit is in fluid communication with the main chamber via one or more fluid connection apertures.

35. A battery pack as claimed in claim 33, wherein a first fluid connection means and a second fluid connection means of the first and second connection conduit is connectable to a first and second fluid connection means of a further fluid delivery means, the first fluid connection means and the second fluid connection means comprise attachment means, each attachment means comprises a channel for receiving a seal for preventing leaks between adjacent fluid delivery means.

36. A battery pack as claimed in claim 33, wherein the fluid delivery means comprises a plurality of distribution means, each distribution means comprising a distribution aperture formed within a nozzle attachment portion, each nozzle attachment portion comprising a recess portion wherein each recess portion is an annular recess which extends around a distribution aperture, each recess portion being adapted to receive part of a nozzle, in particular the raised portion on the flange portion of a nozzle, the recess portion allowing the nozzle to be accurately located with respect to the distribution aperture, and attached to the distribution means at the correct location, the rear member of the fluid delivery means comprises a plurality of distribution apertures through which fluid can flow between the main chamber and the distribution means so that in use, fluid is able to flow from the main chamber, through each distribution aperture and into a duct/duct assembly/nozzle.

37. A battery pack as claimed in claim 33, wherein the fluid delivery means comprises a storage compartment being an integral storage compartment comprising a sealable chamber for preventing fluids entering the camber, the storage compartment being adaptable to store a slave board of the battery management computer.

38. A battery pack as claimed in claim 33, wherein the main chamber is divided into at least two sub chambers and wherein the distribution means are divided into at least two sets of distribution means, each set of distribution means being associated with each sub chamber for providing the battery back with built in redundancy wherein if the duct on one side of the cell bursts or fails then the duct on the other side of the cell can be used to thermally manage the cell.

39. A battery pack as claimed in claim 38, wherein the main chamber has a dividing wall for dividing the main chamber into the at least two sub-chambers, the first and second connection conduits and each set of distribution means of the fluid delivery means are in fluid communication with only a part of the main chamber, the first connection conduit being in fluid communication with the first sub-chamber via at least one fluid connection apertures, the second connection conduit being in fluid communication with the second sub-chamber via at least one fluid connection apertures.

40. A battery pack as claimed in claim 38, wherein the distance between adjacent distribution means corresponds to the width of a cell so that the ducts are provided on both sides of the cell wherein if the duct on one side of the cell bursts or fails then the duct on the other side of the cell can be used to thermally manage the cell.

41. A battery pack as claimed in claim 1, wherein there is provided a multiport fluid connector comprising a primary port and two branch ports, wherein the multiport fluid connector is a low-profile multiport fluid connector for connecting a fluid distribution arrangement to a source of thermal management fluid.

42. A battery pack as claimed in claim 38, wherein the multiport fluid connector is adapted to split/combine the flow of fluid therethrough, the multiport fluid connector being adapted to minimise the creation of swirl components and pressure drop over a limited distance.

43. A battery pack as claimed in claim 35, wherein the battery pack has a sealing means for providing a seal between fluid conduits in a battery pack or battery module, the sealing means comprising a deformable body, the deformable body comprising a central portion located between two retainable portions, wherein in use the retainable portions are locatable in retainment channels and wherein in the deformed state the central portion has an increased width, the sealing means is able to accommodate position tolerances between the respective ends of the conduits of first and/or second connection conduits/header tanks within the battery pack.
